(19) United States
(12) Patent Application Publication
(10) Pub. No.: US 2025/0261168 A1
(43) Pub. Date: Aug. 14, 2025

(54) COMMUNICATION METHOD AND APPARATUS

(71) Applicant: HUAWEI TECHNOLOGIES CO., LTD., Shenzhen (CN)

(72) Inventors: Dongdong WEI, Shenzhen (CN); Fan WANG, Shanghai (CN); Zhang ZHANG, Shanghai (CN); Qi FENG, Shanghai (CN)

(73) Assignee: HUAWEI TECHNOLOGIES CO., LTD., Shenzhen (CN)

(21) Appl. No.: 19/197,492

(22) Filed: May 2, 2025

Related U.S. Application Data
(63) Continuation of application No. PCT/CN2022/130080, filed on Nov. 4, 2022.

(51) Int. Cl. H04W 68/02

(52) U.S. Cl. CPC H04W 68/02

(57) ABSTRACT

Communication methods and apparatuses are provided. An exemplary method includes a first communication apparatus receives a paging-related configuration sent by a second communication apparatus, where the paging-related configuration indicates paging-related configuration information of a carrier group including a plurality of carriers; and the first communication apparatus receives, on one or more carriers in the carrier group based on the paging-related configuration, a paging-related message sent by the second communication apparatus. This serves to implement coordinated reception on the plurality of carriers in the carrier group as well as to reduce the energy consumption of a network device.

### CROSS-REFERENCE TO RELATED APPLICATIONS

This application is a continuation of International Application No. PCT/CN2022/130080, filed on Nov. 4, 2022, the disclosure of which is hereby incorporated by reference in its entirety.

### TECHNICAL FIELD

This application relates to the field of communication technologies, and in particular, to a communication method and apparatus.

### BACKGROUND

Wireless networks are being rapidly constructed to satisfy increasing traffic requirements. As a network scale increases, network energy consumption continuously increases. Compared with a 3rd generation (3G) communication system and a 4th generation (4G) communication system (for example, a long term evolution (LTE) system), a 5th generation (5G) communication system, and a communication system evolved after 5G, for example, a 6th generation (6G) communication system, support the usage of more active antenna units (AUUs), more transceiver antenna arrays, a higher data rate, increased traffic, a larger transmission bandwidth, usage of higher-frequencies (for example, millimeter wave or terahertz) carriers, and a more flexible and smaller-granularity scheduling mechanism. Although the foregoing features provide more applications, and applications of greater complexities, denser network devices need to be deployed, and the energy consumption of these network devices also increases.

Therefore, how to reduce the energy consumption of the network devices is a focus of ongoing research.

### SUMMARY

This application provides a communication method and apparatus, to reduce the energy consumption of a network device.

According to a first aspect, this application provides a communication method. The method includes: A first communication apparatus receives a paging-related configuration sent by a second communication apparatus, where the paging-related configuration indicates paging-related configuration information of a carrier group, and the carrier group includes a plurality of carriers; and the first communication apparatus receives, on one or more carriers in the carrier group based on the paging-related configuration, a paging-related message sent by the second communication apparatus.

According to the method provided in the first aspect, the second communication apparatus sends the paging-related configuration to the first communication apparatus, so that the first communication apparatus learns, based on the paging-related configuration, of the plurality of carriers that are in the carrier group and that are used to receive the paging-related message. The second communication apparatus sends the paging-related message on the plurality of carriers in the carrier group in a coordinated manner. Correspondingly, the first communication apparatus receives the paging-related message on the one or more carriers in the carrier group based on the paging-related configuration. In this application, coordinated sending on the plurality of carriers in the carrier group is implemented. From a perspective of the second communication apparatus, a sending duration of the second communication apparatus in the time domain is reduced, and a muting duration of the second communication apparatus is increased. This helps reduce energy consumption of the second communication apparatus.

In a possible design, the paging-related configuration includes a carrier group paging control channel configuration and a carrier group paging search space configuration, where the carrier group paging control channel configuration includes a configuration that is of M carriers for paging reception in the carrier group and that is used for determining a paging frame and a paging occasion, the carrier group paging search space configuration includes a search space configuration of a physical downlink control channel, for paging reception, of N carriers for paging reception in the carrier group, M and N are integers greater than 1 and less than or equal to a total quantity of all carriers for paging reception in the carrier group; and
that the first communication apparatus receives, on one or more carriers in the carrier group based on the paging-related configuration, a paging-related message sent by the second communication apparatus includes:

The first communication apparatus receives an SMS message or a paging message on one or more same carriers in the M carriers and the N carriers based on the carrier group paging control channel configuration and the carrier group paging search space configuration.

Therefore, when the paging-related message is an SMS message or a paging message, the first communication apparatus may select one or more carriers from an intersection set of the M carriers indicated by the carrier group paging control channel configuration and the N carriers indicated by the carrier group paging search space configuration. Therefore, the first communication apparatus may receive the SMS message or the paging message on the selected one or more carriers.

In a possible design, that the first communication apparatus receives, on one or more carriers in the carrier group based on the paging-related configuration, a paging-related message sent by the second communication apparatus includes: The first communication apparatus determines, based on the paging-related configuration, a quantity of paging slots and beam information of the paging slot that are of each of the one or more carriers in the carrier group on each paging occasion; and the first communication apparatus receives the paging-related message on the one or more carriers in the carrier group based on the quantity of paging slots and the beam information of the paging slot that are of each of the one or more carriers in the carrier group on each paging occasion.

The quantity of paging slots of each carrier on each paging occasion indicates a quantity of consecutive downlink control channel monitoring occasions of each carrier on each paging occasion, and the beam information of the paging slot of each carrier on each paging occasion indicates a synchronization signal and physical broadcast channel block (SSB) that is associated and in quasi-co-location with a physical downlink shared channel of the paging slot of each carrier on each paging occasion.

Therefore, when the paging-related message is an SMS message or a paging message, the first communication apparatus may determine the quantity of paging slots and the beam information of the paging slot that are of each of the one or more carriers in the carrier group on each paging occasion. Therefore, the first communication apparatus can be woken and will accurately receive the SMS message or the paging message on each carrier based on the foregoing content.

In a possible design, the quantity of paging slots and the beam information of the paging slot that are of each of the one or more carriers in the carrier group on each paging occasion are determined based on a quantity of paging slots and beam information of the paging slot that are of each carrier for paging reception in the carrier group on each paging occasion and that are predefined in a protocol; or
the paging-related configuration further includes association indication information, where the association indication information is used to determine a quantity of paging slots and beam information of the paging slot that are of each carrier for paging reception in the carrier group on each paging occasion, and the quantity of paging slots and the beam information of the paging slot that are of each of the one or more carriers in the carrier group are determined based on the association indication information.

Therefore, the first communication apparatus may determine, based on the predefinition in the protocol or the indication of the second communication apparatus, the quantity of paging slots and the beam information of the paging slot that are of each of the one or more carriers in the carrier group.

In a possible design, the carrier group paging search space configuration includes the association indication information. Therefore, the second communication apparatus sends the association indication information to the first communication apparatus without using signaling.

In a possible design, the paging-related configuration includes a carrier group paging early indication configuration and a carrier group paging early indication search space configuration, where the carrier group paging early indication configuration includes a paging early indication-related configuration of P carriers for a paging early indication in the carrier group, and the carrier group paging early indication search space configuration includes a search space configuration of a physical downlink control channel, for a paging early indication, of Q carriers for a paging early indication in the carrier group, and P and Q are integers greater than 1 and less than or equal to a total quantity of all carriers for a paging early indication in the carrier group; and that the first communication apparatus receives, on one or more carriers in the carrier group based on the paging-related configuration, a paging-related message sent by the second communication apparatus includes: The first communication apparatus receives, based on the carrier group paging early indication configuration and the carrier group paging early indication search space configuration, a paging early indication message on one or more same carriers in the P carriers and the Q carriers.

Therefore, when the paging-related message is a paging early indication message, the first communication apparatus may select one or more carriers from an intersection set of the P carriers indicated by the carrier group paging early indication configuration and the Q carriers indicated by the carrier group paging early indication search space configuration. Therefore, the first communication apparatus may receive the paging early indication message on the selected one or more carriers.

In a possible design, that the first communication apparatus receives, on one or more carriers in the carrier group based on the paging-related configuration, a paging-related message sent by the second communication apparatus includes: The first communication apparatus determines, based on the paging-related configuration, a quantity of paging early indication monitoring slots and beam information of the paging early indication monitoring slot that are of each of the one or more carriers in the carrier group on each paging early indication occasion; and the first communication apparatus receives the paging-related message on the one or more carriers in the carrier group based on the quantity of paging early indication monitoring slots and the beam information of the paging early indication monitoring slot that are of each of the one or more carriers in the carrier group on each paging early indication occasion. The quantity of paging early indication monitoring slots of each carrier on each paging early indication occasion indicates a quantity of consecutive downlink control channel monitoring occasions of each carrier on each paging early indication occasion, and the beam information of the paging early indication monitoring slot of each carrier on each paging early indication occasion indicates an SSB that is associated and in quasi-co-location with a physical downlink control channel of the paging early indication monitoring slot of each carrier on each paging early indication occasion.

Therefore, when the paging-related message is a paging early indication message, the first communication apparatus may determine the quantity of paging early indication monitoring slots and the beam information of the paging early indication monitoring slot that are of each of the one or more carriers in the carrier group on each paging early indication occasion. Therefore, the first communication apparatus can be woken and will accurately receive the paging early indication message on each carrier based on the foregoing content.

In a possible design, the quantity of paging early indication monitoring slots and the beam information of the paging early indication monitoring slot that are of each of the one or more carriers in the carrier group on each paging early indication occasion are determined based on a quantity of paging early indication monitoring slots and beam information of the paging early indication monitoring slot that are of each carrier for the paging early indication in the carrier group on each paging early indication occasion and that are predefined in a protocol; or the paging-related configuration further includes association indication information, where the association indication information is used to determine a quantity of paging early indication monitoring slots and beam information of the paging early indication monitoring slot that are of each carrier for the paging early indication in the carrier group on each paging early indication occasion, and the quantity of paging early indication monitoring slots and the beam information of the paging early indication monitoring slot that are of each of the one or more carriers in the carrier group on each paging early indication occasion are determined based on the association indication information.

In a possible design, the carrier group paging early indication search space configuration includes the association indication information. Therefore, the second communication apparatus sends the association indication information to the first communication apparatus without using signaling, so that signaling overheads are reduced.

In a possible design, the method further includes: The first communication apparatus receives paging mode information sent by the second communication apparatus, where the paging mode information indicates a paging mode of the first communication apparatus; and when the paging mode information indicates that the first communication apparatus uses a multi-carrier coordinated paging mode, the first communication apparatus receives the paging-related message on the one or more carriers in the carrier group; or when the paging mode information indicates that the first communication apparatus uses a single-carrier paging mode, the first communication apparatus receives the paging-related message on a carrier on which a cell, on which the first communication apparatus camps, is located.

Therefore, the first communication apparatus can notify, by using the paging mode information, the second communication apparatus of the paging mode to be used, so that the second communication apparatus can successfully receive the paging-related message.

In a possible design, that the first communication apparatus receives paging mode information sent by the second communication apparatus includes: The first communication apparatus receives a system information sent by the second communication apparatus, where the system information includes the paging mode information. Therefore, the second communication apparatus may broadcast the paging mode information to the first communication apparatus.

In a possible design, that a first communication apparatus receives a paging-related configuration sent by a second communication apparatus includes: The first communication apparatus receives the system information sent by the second communication apparatus, where the system information includes the paging-related configuration. Therefore, the second communication apparatus may broadcast the paging-related configuration to the first communication apparatus.

In a possible design, the paging-related configuration further includes a carrier group configuration, and the carrier group configuration indicates that the carrier group includes the plurality of carriers.

Therefore, based on the carrier group configuration, the second communication apparatus may notify the first communication apparatus of the carrier group for sending the paging-related message and the plurality of carriers in the carrier group.

In a possible design, the method further includes: The first communication apparatus receives, on each carrier in the carrier group, the system information sent by the second communication apparatus, where the system information includes the carrier group configuration, and the carrier group configuration includes an identification of the carrier group to which each carrier belongs; the first communication apparatus receives, on the one or more carriers in the carrier group, the system information sent by the second communication apparatus, where the system information includes the carrier group configuration, and the carrier group configuration includes related configuration information of each carrier in the carrier group to which the carrier corresponding to the system information belongs; or the first communication apparatus receives, on the one or more carriers in the carrier group, a system information set sent by the second communication apparatus, where the system information set includes a system information of each carrier in the carrier group to which the carrier for receiving the system information set belongs.

Therefore, the second communication apparatus may send the carrier group configuration to the first communication apparatus in a plurality of ways, so that the second communication apparatus flexibly selects a proper way.

According to a second aspect, this application provides a communication method. The method includes: A second communication apparatus sends a paging-related configuration to a first communication apparatus, where the paging-related configuration indicates paging-related configuration information of a carrier group, and the carrier group includes a plurality of carriers; and the second communication apparatus sends a paging-related message to the first communication apparatus on the carriers in the carrier group.

In a possible design, the paging-related configuration includes a carrier group paging control channel configuration and a carrier group paging search space configuration, where the carrier group paging control channel configuration includes a configuration that is of M carriers for paging reception in the carrier group and that is used for determining a paging frame and a paging occasion, the carrier group paging search space configuration includes a search space configuration of a physical downlink control channel, for paging reception, of N carriers for paging reception in the carrier group, M and N are integers greater than 1 and less than or equal to a total quantity of all carriers for paging reception in the carrier group; and
that the second communication apparatus sends a paging-related message to the first communication apparatus on the carriers in the carrier group includes:
the second communication apparatus sends an SMS message or a paging message on a same carrier in the M carriers and the N carriers in the carrier group.

In a possible design, the paging-related configuration further includes association indication information, and the association indication information is used to determine a quantity of paging slots and beam information of the paging slot that are of each carrier for paging reception in the carrier group on each paging occasion.

In a possible design, the carrier group paging search space configuration includes the association indication information.

In a possible design, the paging-related configuration includes a carrier group paging early indication configuration and a carrier group paging early indication search space configuration, where the carrier group paging early indication configuration includes a paging early indication-related configuration of P carriers for a paging early indication in the carrier group, and the carrier group paging early indication search space configuration includes a search space configuration of a physical downlink control channel, for a paging early indication, of Q carriers for a paging early indication in the carrier group, and P and Q are integers greater than 1 and less than or equal to a total quantity of all carriers for a paging early indication in the carrier group; and that the second communication apparatus sends a paging-related message to the first communication apparatus on the carrier in the carrier group includes:

The second communication apparatus sends a paging early indication message on a same carrier in the P carriers and the Q carriers in the carrier group.

In a possible design, the paging-related configuration further includes association indication information, and the association indication information is used to determine a quantity of paging early indication monitoring slots and beam information of the paging early indication monitoring slot that are of each carrier for the paging early indication in the carrier group on each paging early indication occasion.

In a possible design, the carrier group paging early indication search space configuration includes the association indication information.

In a possible design, the method further includes: The second communication apparatus sends paging mode information to the first communication apparatus, where the paging mode information indicates a paging mode of the first communication apparatus; and when the paging mode information indicates that the first communication apparatus uses a multi-carrier coordinated paging mode, the second communication apparatus sends the paging-related message on the plurality of carriers in the carrier group; or when the paging mode information indicates that the first communication apparatus uses a single-carrier paging mode, the second communication apparatus sends the paging-related message on one carrier on which a cell, on which the first communication apparatus camps, is located.

In a possible design, that the second communication apparatus sends paging mode information to the first communication apparatus includes: The second communication apparatus sends a system information to the first communication apparatus, where the system information includes the paging mode information.

In a possible design, that a second communication apparatus sends a paging-related configuration to a first communication apparatus includes: The second communication apparatus sends the system information to the first communication apparatus, where the system information includes the paging-related configuration.

In a possible design, the paging-related configuration further includes a carrier group configuration, and the carrier group configuration indicates that the carrier group includes the plurality of carriers.

In a possible design, the method further includes: The second communication apparatus sends the system information to the first communication apparatus on each carrier in the carrier group, where the system information includes the carrier group configuration, and the carrier group configuration includes an identification of the carrier group to which each carrier belongs; the second communication apparatus sends the system information to the first communication apparatus on one or more carriers in the carrier group, where the system information includes the carrier group configuration, and the carrier group configuration includes related configuration information of each carrier in the carrier group to which the carrier corresponding to the system information belongs; or the second communication apparatus sends a system information set to the first communication apparatus on one or more carriers in the carrier group, where the system information set includes a system information of each carrier in the carrier group to which a carrier for receiving the system information set belongs.

For beneficial effects of the communication method provided in the second aspect and the possible designs of the second aspect, refer to the beneficial effects brought by the first aspect and the possible implementations of the first aspect. Details are not described herein again.

According to a third aspect, this application provides a communication apparatus. The apparatus includes:
a transceiver unit, configured to receive a paging-related configuration sent by a second communication apparatus, where the paging-related configuration indicates paging-related configuration information of a carrier group, and the carrier group includes a plurality of carriers, where
the transceiver unit is further configured to receive, on one or more carriers in the carrier group based on the paging-related configuration, a paging-related message sent by the second communication apparatus.

In a possible design, the paging-related configuration includes a carrier group paging control channel configuration and a carrier group paging search space configuration, where the carrier group paging control channel configuration includes a configuration that is of M carriers for paging reception in the carrier group and that is used for determining a paging frame and a paging occasion, the carrier group paging search space configuration includes a search space configuration of a physical downlink control channel, for paging reception, of N carriers for paging reception in the carrier group, M and N are integers greater than 1 and less than or equal to a total quantity of all carriers for paging reception in the carrier group; and
the transceiver unit is specifically configured to receive an SMS message or a paging message on one or more same carriers in the M carriers and the N carriers based on the carrier group paging control channel configuration and the carrier group paging search space configuration.

In a possible design, the transceiver unit is specifically configured to: determine, based on the paging-related configuration, a quantity of paging slots and beam information of the paging slot that are of each of the one or more carriers in the carrier group on each paging occasion; and receive the paging-related message on the one or more carriers in the carrier group based on the quantity of paging slots and the beam information of the paging slot that are of each of the one or more carriers in the carrier group on each paging occasion.

In a possible design, the quantity of paging slots and the beam information of the paging slot that are of each of the one or more carriers in the carrier group on each paging occasion are determined based on a quantity of paging slots and beam information of the paging slot that are of each carrier for paging reception in the carrier group on each paging occasion and that are predefined in a protocol; or
the paging-related configuration further includes association indication information, where the association indication information is used to determine a quantity of paging slots and beam information of the paging slot that are of each carrier for paging reception in the carrier group on each paging occasion, and the quantity of paging slots and the beam information of the paging slot that are of each of the one or more carriers in the carrier group are determined based on the association indication information.

In a possible design, the carrier group paging search space configuration includes the association indication information.

In a possible design, the paging-related configuration includes a carrier group paging early indication configuration and a carrier group paging early indication search space configuration, where the carrier group paging early indication configuration includes a paging early indication-related configuration of P carriers for a paging early indication in the carrier group, and the carrier group paging early indication search space configuration includes a search space configuration of a physical downlink control channel, for a paging early indication, of Q carriers for a paging early indication in the carrier group, and P and Q are integers greater than 1 and less than or equal to a total quantity of all carriers for a paging early indication in the carrier group; and
the transceiver unit is specifically configured to receive, based on the carrier group paging early indication configuration and the carrier group paging early indication search space configuration, a paging early indication message on one or more same carriers in the P carriers and the Q carriers.

In a possible design, the transceiver unit is specifically configured to: determine, based on the paging-related configuration, a quantity of paging early indication monitoring slots and beam information of the paging early indication monitoring slot that are of each of the one or more carriers in the carrier group on each paging early indication occasion; and receive the paging-related message on the one or more carriers in the carrier group based on the quantity of paging early indication monitoring slots and the beam information of the paging early indication monitoring slot that are of each of the one or more carriers in the carrier group on each paging early indication occasion.

In a possible design, the quantity of paging early indication monitoring slots and the beam information of the paging early indication monitoring slot that are of each of the one or more carriers in the carrier group on each paging early indication occasion are determined based on a quantity of paging early indication monitoring slots and beam information of the paging early indication monitoring slot that are of each carrier for the paging early indication in the carrier group on each paging early indication occasion and that are predefined in a protocol; or
the paging-related configuration further includes association indication information, where the association indication information is used to determine a quantity of paging early indication monitoring slots and beam information of the paging early indication monitoring slot that are of each carrier for the paging early indication in the carrier group on each paging early indication occasion, and the quantity of paging early indication monitoring slots and the beam information of the paging early indication monitoring slot that are of each of the one or more carriers in the carrier group on each paging early indication occasion are determined based on the association indication information.

In a possible design, the carrier group paging early indication search space configuration includes the association indication information.

In a possible design, the transceiver unit is further configured to receive paging mode information sent by the second communication apparatus, where the paging mode information indicates a paging mode of the first communication apparatus; and
the transceiver unit is further configured to: when the paging mode information indicates that the first communication apparatus uses a multi-carrier coordinated paging mode, receive the paging-related message on the one or more carriers in the carrier group; or when the paging mode information indicates that the first communication apparatus uses a single-carrier paging mode, receive the paging-related message on a carrier on which a cell, on which the first communication apparatus camps, is located.

In a possible design, the transceiver unit is specifically configured to receive a system information sent by the second communication apparatus, where the system information includes the paging mode information.

In a possible design, the transceiver unit is specifically configured to receive the system information sent by the second communication apparatus, where the system information includes the paging-related configuration.

In a possible design, the paging-related configuration further includes a carrier group configuration, and the carrier group configuration indicates that the carrier group includes the plurality of carriers.

In a possible design, the transceiver unit is specifically configured to receive, on each carrier in the carrier group, the system information sent by the second communication apparatus, where the system information includes the carrier group configuration, and the carrier group configuration includes an identification of the carrier group to which each carrier belongs; receive, on the one or more carriers in the carrier group, the system information sent by the second communication apparatus, where the system information includes the carrier group configuration, and the carrier group configuration includes related configuration information of each carrier in the carrier group to which the carrier corresponding to the system information belongs; or receive, on the one or more carriers in the carrier group, a system information set sent by the second communication apparatus, where the system information set includes a system information of each carrier in the carrier group to which the carrier for receiving the system information set belongs.

For beneficial effects of the communication apparatus provided in the third aspect and the possible designs of the third aspect, refer to the beneficial effects brought by the first aspect and the possible implementations of the first aspect. Details are not described herein again.

According to a fourth aspect, this application provides a communication apparatus. The apparatus includes:
a transceiver unit, configured to send a paging-related configuration to a first communication apparatus, where the paging-related configuration indicates paging-related configuration information of a carrier group, and the carrier group includes a plurality of carriers, where the transceiver unit is further configured to send a paging-related message to the first communication apparatus on the carriers in the carrier group.

In a possible design, the paging-related configuration includes a carrier group paging control channel configuration and a carrier group paging search space configuration, where the carrier group paging control channel configuration includes a configuration that is of M carriers for paging reception in the carrier group and that is used for determining a paging frame and a paging occasion, the carrier group paging search space configuration includes a search space configuration of a physical downlink control channel, for paging reception, of N carriers for paging reception in the carrier group, M and N are integers greater than 1 and less than or equal to a total quantity of all carriers for paging reception in the carrier group; and the transceiver unit is specifically configured to send an SMS message or a paging message on a same carrier in the M carriers and the N carriers in the carrier group.

In a possible design, the paging-related configuration further includes association indication information, and the association indication information is used to determine a quantity of paging slots and beam information of the paging slot that are of each carrier for paging reception in the carrier group on each paging occasion.

In a possible design, the carrier group paging search space configuration includes the association indication information.

In a possible design, the paging-related configuration includes a carrier group paging early indication configuration and a carrier group paging early indication search space configuration, where the carrier group paging early indication configuration includes a paging early indication-related configuration of P carriers for a paging early indication in the carrier group, and the carrier group paging early indication search space configuration includes a search space configuration of a physical downlink control channel, for a paging early indication, of Q carriers for a paging early indication in the carrier group, and P and Q are integers greater than 1 and less than or equal to a total quantity of all carriers for a paging early indication in the carrier group; and the transceiver unit is specifically configured to send a paging early indication message on a same carrier in the P carriers and the Q carriers in the carrier group.

In a possible design, the paging-related configuration further includes association indication information, and the association indication information is used to determine a quantity of paging early indication monitoring slots and beam information of the paging early indication monitoring slot that are of each carrier for the paging early indication in the carrier group on each paging early indication occasion.

In a possible design, the carrier group paging early indication search space configuration includes the association indication information.

In a possible design, the transceiver unit is further configured to send paging mode information to the first communication apparatus, where the paging mode information indicates a paging mode of the first communication apparatus; and the transceiver unit is further configured to: when the paging mode information indicates that the first communication apparatus uses a multi-carrier coordinated paging mode, send the paging-related message on the plurality of carriers in the carrier group; or when the paging mode information indicates that the first communication apparatus uses a single-carrier paging mode, send the paging-related message on one carrier on which a cell, on which the first communication apparatus camps, is located.

In a possible design, the transceiver unit is specifically configured to send a system information to the first communication apparatus, where the system information includes the paging mode information.

In a possible design, the transceiver unit is specifically configured to send the system information to the first communication apparatus, where the system information includes the paging-related configuration.

In a possible design, the paging-related configuration further includes a carrier group configuration, and the carrier group configuration indicates that the carrier group includes the plurality of carriers.

In a possible design, the transceiver unit is specifically configured to send the system information to the first communication apparatus on each carrier in the carrier group, where the system information includes the carrier group configuration, and the carrier group configuration includes an identification of the carrier group to which each carrier belongs; send the system information to the first communication apparatus on one or more carriers in the carrier group, where the system information includes the carrier group configuration, and the carrier group configuration includes related configuration information of each carrier in the carrier group to which the carrier corresponding to the system information belongs; or send a system information set to the first communication apparatus on one or more carriers in the carrier group, where the system information set includes a system information of each carrier in the carrier group to which a carrier for receiving the system information set belongs.

For beneficial effects of the communication apparatus provided in the fourth aspect and the possible designs of the fourth aspect, refer to the beneficial effects brought by the second aspect and the possible implementations of the second aspect. Details are not described herein again.

In any one of the first aspect to the fourth aspect and any one of the possible designs of the aspects, a total quantity of paging slots of all carriers for paging reception in the carrier group on each paging occasion is equal to a quantity of SSBs in a synchronization broadcast resource block set of the cell on which the first communication apparatus camps; or a total quantity of paging early indication monitoring slots of all carriers for the paging early indication in the carrier group on each paging early indication occasion is equal to a quantity of SSBs in a synchronization broadcast resource block set of the cell on which the first communication apparatus camps.

Therefore, a total quantity of paging slots of all the carriers for sending the paging-related message in the carrier group on each paging occasion is equal to the quantity of SSBs in the synchronization broadcast resource block set of the cell on which the first communication apparatus camps. A quantity of paging slots of any one of all the carriers for sending the paging-related message in the carrier group on each paging occasion is less than the quantity of SSBs in the synchronization broadcast resource block set of the cell on which the first communication apparatus camps. Therefore, the second communication apparatus sends the paging-related message on the plurality of carriers for sending the paging-related message in the carrier group in a coordinated manner, so that a sending duration of the second communication apparatus in the time domain is reduced.

In any one of the first aspect to the fourth aspect and any one of the possible designs of the aspects, the quantity of paging slots and the beam information of the paging slot that are of each carrier for paging reception in the carrier group on each paging occasion indicate any one of the following solutions: a physical downlink shared channel of the paging slot of each carrier on each paging occasion is associated and in quasi-co-location with the SSB based on a sending sequence of the SSBs in the synchronization broadcast resource block set and an association method of the time domain first and then the frequency domain; or a physical downlink shared channel of the paging slot of each carrier on each paging occasion is associated and in quasi-co-location with the SSB based on a sending sequence of the SSBs in the synchronization broadcast resource block set and an association method of the frequency domain first and then the time domain.

Therefore, the plurality of SSBs may be sequentially allocated, in the time-domain-first manner or the frequency-domain-first manner, to the plurality of carriers for paging reception in the carrier group.

In any one of the first aspect to the fourth aspect and any one of the possible designs of the aspects, the quantity of paging early indication monitoring slots and the beam information of the paging early indication monitoring slot that are of each carrier for the paging early indication in the carrier group on each paging early indication occasion indicate any one of the following solutions: a physical downlink control channel of the paging early indication monitoring slot of each carrier on each paging early indication occasion is associated and in quasi-co-location with the SSB based on a sending sequence of the SSBs in the synchronization broadcast resource block set and an association method of the time domain first and then the frequency domain; or a physical downlink control channel of the paging early indication monitoring slot of each carrier on each paging early indication occasion is associated and in quasi-co-location with the SSB based on a sending sequence of the SSBs in the synchronization broadcast resource block set and an association method of the frequency domain first and then the time domain.

Therefore, the plurality of SSBs may be sequentially allocated, in the time-domain-first manner or the frequency-domain-first manner, to the plurality of carriers for the paging early indication in the carrier group.

In any one of the first aspect to the fourth aspect and any one of the possible designs of the aspects, the quantity of paging slots and the beam information of the paging slot that are of each carrier for paging reception in the carrier group on each paging occasion include an SSB sequence number range of each carrier, where the SSB sequence number range of each carrier is a sequence number of an SSB that is associated and in quasi-co-location with a physical downlink shared channel of one or more paging slots of each carrier on each paging occasion and that is in the sending sequence of the SSBs in the synchronization broadcast resource block set; or the quantity of paging early indication monitoring slots and the beam information of the paging early indication monitoring slot that are of each carrier for the paging early indication in the carrier group on each paging early indication occasion include an SSB sequence number range of each carrier, where the SSB sequence number range of each carrier is a sequence number of a SSB that is associated and in quasi-co-location with a physical downlink control channel of one or more paging early indication monitoring slots of each carrier on each paging early indication occasion and that is in the sending sequence of the SSBs in the synchronization broadcast resource block set.

Therefore, based on the SSB sequence number range, the quantity of paging slots and the beam information of the paging slot that are of each carrier for paging reception or the paging early indication on each paging occasion may be explicitly indicated.

In any one of the first aspect to the fourth aspect and any one of the possible designs of the aspects, an SSB sequence number range of an i^{th} carrier in the carrier group is greater than or equal to 1+(i−1)*ceil(S/m) and less than or equal to i*ceil(S/m), where i is an integer greater than or equal to 1 and less than or equal to the total quantity of all the carriers for paging reception or the paging early indication in the carrier group, S is the quantity of SSBs in the synchronization broadcast resource block set, m is a quantity of SSBs sent in each paging slot or paging early indication monitoring slot, and ceil represents rounding up.

In any one of the first aspect to the fourth aspect and any one of the possible designs of the aspects, the quantity of paging slots and the beam information of the paging slot that are of each carrier for paging reception in the carrier group on each paging occasion include an SSB index set of each carrier, where the SSB index set of each carrier is an index of the SSB that is associated and in quasi-co-location with the physical downlink shared channel of the one or more paging slots of each carrier on each paging occasion; or the quantity of paging early indication monitoring slots and the beam information of the paging early indication monitoring slot that are of each carrier for the paging early indication in the carrier group on each paging early indication occasion include an SSB index set, where the SSB index set of each carrier is an index of the SSB that is associated and in quasi-co-location with the physical downlink control channel of the one or more paging early indication monitoring slots of each carrier on each paging early indication occasion.

Therefore, based on the SSB index set, the quantity of paging slots and the beam information of the paging slot that are of each carrier for paging reception or the paging early indication on each paging occasion may be explicitly indicated.

According to a fifth aspect, this application provides a communication method. The method includes:

A first communication apparatus receives time-domain muting information sent by a second communication apparatus, where the time-domain muting information indicates to stop sending and/or receiving on all carriers in a carrier group, and the carrier group includes a plurality of carriers; and the first communication apparatus stops the receiving and/or sending on all the carriers in the carrier group based on the time-domain muting information.

According to the method provided in the fifth aspect, the second communication apparatus determines the time-domain muting information, where the time-domain muting information indicates to stop sending and/or receiving on all the carriers in the carrier group, and the carrier group includes the plurality of carriers. The second communication apparatus sends the time-domain muting information to the first communication apparatus. Correspondingly, the first communication apparatus stops the receiving and/or sending on all the carriers in the carrier group based on the time-domain muting information. In this application, when no data is carried on all the carriers in the carrier group in a specific duration, all the carriers in the carrier group are simultaneously muted in the time domain. From a perspective of the second communication apparatus, indication signaling overheads are reduced. This helps reduce energy consumption of the second communication apparatus.

In a possible design, that a first communication apparatus receives time-domain muting information sent by a second communication apparatus includes:

The first communication apparatus receives, on one carrier in the carrier group, the time-domain muting information sent by the second communication apparatus. The carrier in the carrier group may be any carrier, for example, an anchor carrier, in the carrier group. In this way, transmission of the time-domain muting information is implemented.

In a possible design, when different radio access technologies are used for a plurality of carriers in the carrier group, that a first communication apparatus receives time-domain muting information sent by a second communication apparatus includes:

The first communication apparatus receives, on one of the carriers that are in the carrier group and for which each radio access technology is used, the time-domain muting information sent by the second communication apparatus.

In this way, transmission of the time-domain muting information is implemented. The time-domain muting information is applicable to the plurality of carriers that are in the carrier group and for which the different radio access technologies are used, and the time-domain muting information is independent of the radio access technology of the carrier.

In a possible design, that a first communication apparatus receives time-domain muting information sent by a second communication apparatus includes:

When a same subcarrier spacing is used for a plurality of carriers in the carrier group, the first communication apparatus receives the time-domain muting information on a first carrier whose subcarrier spacing is the same as that of the carrier in the carrier group, where the time-domain muting information indicates to stop sending and/or receiving in a slot that is of each carrier in the carrier group and that is at a same position as a first time-domain unit of the first carrier, and the first time-domain unit is one or more time-domain units in which sending and/or receiving are/is stopped; or when different subcarrier spacings are used for a plurality of carriers in the carrier group, the first communication apparatus receives the time-domain muting information on a first carrier whose subcarrier spacing is the same as that of any carrier in the carrier group, where the time-domain muting information indicates to stop sending and/or receiving in a slot that is of each carrier in the carrier group and that overlaps a position of a first time-domain unit of the first carrier, and the first time-domain unit is one or more time-domain units in which sending and/or receiving are/is stopped.

In this way, transmission of the time-domain muting information is implemented. The time-domain muting information is applicable to the plurality of carriers whose subcarrier spacings are the same or different in a carrier group, and the time-domain muting information is independent of the subcarrier spacing of the carrier.

According to a sixth aspect, this application provides a communication method. The method includes: A second communication apparatus determines time-domain muting information, where the time-domain muting information indicates to stop sending and/or receiving on all carriers in a carrier group, and the carrier group includes a plurality of carriers; and the second communication apparatus sends the time-domain muting information to a first communication apparatus.

In a possible design, that the second communication apparatus sends the time-domain muting information to a first communication apparatus includes: The second communication apparatus sends the time-domain muting information on one carrier in the carrier group.

In a possible design, when different radio access technologies are used for a plurality of carriers in the carrier group, that the second communication apparatus sends the time-domain muting information to a first communication apparatus includes: The second communication apparatus sends the time-domain muting information on one of the carriers that are in the carrier group and for which each radio access technology is used.

In a possible design, that the second communication apparatus sends the time-domain muting information to a first communication apparatus includes: When a same subcarrier spacing is used for a plurality of carriers in the carrier group, the second communication apparatus sends the time-domain muting information on a first carrier whose subcarrier spacing is the same as that of the carrier in the carrier group, where the time-domain muting information indicates to stop sending and/or receiving in a slot that is of each carrier in the carrier group and that is at a same position as a first time-domain unit of the first carrier, and the first time-domain unit is one or more time-domain units in which sending and/or receiving are/is stopped; or
when different subcarrier spacings are used for a plurality of carriers in the carrier group, the second communication apparatus sends the time-domain muting information on a first carrier whose subcarrier spacing is the same as that of any carrier in the carrier group, where the time-domain muting information indicates to stop sending and/or receiving in a slot that is of each carrier in the carrier group and that overlaps a position of a first time-domain unit of the first carrier, and the first time-domain unit is one or more time-domain units in which sending and/or receiving are/is stopped.

For beneficial effects of the communication method provided in the sixth aspect and the possible designs of the sixth aspect, refer to the beneficial effects brought by the fifth aspect and the possible implementations of the fifth aspect. Details are not described herein again.

According to a seventh aspect, this application provides a communication apparatus. The apparatus includes:
a transceiver unit, configured to receive time-domain muting information sent by a second communication apparatus, where the time-domain muting information indicates to stop sending and/or receiving on all carriers in a carrier group, and the carrier group includes a plurality of carriers, where the transceiver unit is further configured to stop the receiving and/or sending on all the carriers in the carrier group based on the time-domain muting information.

In a possible design, the transceiver unit is specifically configured to receive, on one carrier in the carrier group, the time-domain muting information sent by the second communication apparatus.

In a possible design, the transceiver unit is specifically configured to: when different radio access technologies are used for a plurality of carriers in the carrier group, receive, on one of the carriers that are in the carrier group and for which each radio access technology is used, the time-domain muting information sent by the second communication apparatus.

In a possible design, the transceiver unit is specifically configured to: when a same subcarrier spacing is used for a plurality of carriers in the carrier group, receive the time-domain muting information on a first carrier whose subcarrier spacing is the same as that of the carrier in the carrier group, where the time-domain muting information indicates to stop sending and/or receiving in a slot that is of each carrier in the carrier group and that is at a same position as a first time-domain unit of the first carrier, and the first time-domain unit is one or more time-domain units in which sending and/or receiving are/is stopped; or
when different subcarrier spacings are used for a plurality of carriers in the carrier group, the first communication apparatus receives the time-domain muting information on a first carrier whose subcarrier spacing is the same as that of any carrier in the carrier group, where the time-domain muting information indicates to stop sending and/or receiving in a slot that is of each carrier in the carrier group and that overlaps a position of a first time-domain unit of the first carrier, and the first time-domain unit is one or more time-domain units in which sending and/or receiving are/is stopped.

For beneficial effects of the communication apparatus provided in the seventh aspect and the possible designs of the seventh aspect, refer to the beneficial effects brought by the fifth aspect and the possible implementations of the fifth aspect. Details are not described herein again.

According to an eighth aspect, this application provides a communication apparatus. The apparatus includes:
a processing unit, configured to determine time-domain muting information, where the time-domain muting information indicates to stop sending and/or receiving on all carriers in a carrier group, and the carrier group includes a plurality of carriers; and
a transceiver unit, configured to send the time-domain muting information to a first communication apparatus.

In a possible design, the transceiver unit is specifically configured to send the time-domain muting information on one carrier in the carrier group.

In a possible design, the transceiver unit is specifically configured to: when different radio access technologies are used for a plurality of carriers in the carrier group, send the time-domain muting information on one of the carriers that are in the carrier group and for which each radio access technology is used.

In a possible design, the transceiver unit is specifically configured to: when a same subcarrier spacing is used for a plurality of carriers in the carrier group, send the time-domain muting information on a first carrier whose subcarrier spacing is the same as that of the carrier in the carrier group, where the time-domain muting information indicates to stop sending and/or receiving in a slot that is of each carrier in the carrier group and that is at a same position as a first time-domain unit of the first carrier, and the first time-domain unit is one or more time-domain units in which sending and/or receiving are/is stopped; or
when different subcarrier spacings are used for a plurality of carriers in the carrier group, send the time-domain muting information on a first carrier whose subcarrier spacing is the same as that of any carrier in the carrier group, where the time-domain muting information indicates to stop sending and/or receiving in a slot that is of each carrier in the carrier group and that overlaps a position of a first time-domain unit of the first carrier, and the first time-domain unit is one or more time-domain units in which sending and/or receiving are/is stopped.

For beneficial effects of the communication apparatus provided in the eighth aspect and the possible designs of the eighth aspect, refer to the beneficial effects brought by the sixth aspect and the possible implementations of the sixth aspect. Details are not described herein again.

In any one of the fifth aspect to the eighth aspect and any one of the possible designs of the aspects, an indication level of the time-domain muting information is any one of the following: a symbol level, a slot level, a subframe level, or a level of a plurality of consecutive slots.

In any one of the fifth aspect to the eighth aspect and any one of the possible designs of the aspects, the time-domain muting information is independent of whether time division multiplexing configurations of the plurality of carriers in the carrier group are the same.

In any one of the first aspect to the eighth aspect and any one of the possible designs of the aspects, a same hardware apparatus is used for all of the carriers in the carrier group.

Therefore, the second communication apparatus may simultaneously start and shut down one hardware apparatus, and send information and/or a signal on a plurality of carriers in one carrier group supported by the hardware apparatus, so that overheads of the second communication apparatus can be reduced.

According to a ninth aspect, this application provides a communication system, including a first communication apparatus configured to perform the method according to any one of the first aspect and the possible designs of the first aspect, and a second communication apparatus configured to perform the method according to any one of the second aspect and the possible designs of the second aspect; and/or a first communication apparatus configured to perform the method according to any one of the fifth aspect and the possible designs of the fifth aspect, and a second communication apparatus configured to perform the method according to any one of the sixth aspect and the possible designs of the sixth aspect.

According to a tenth aspect, this application provides a communication apparatus, and the communication apparatus includes a transceiver, a processor, and a memory. The memory stores a computer program or instructions. The processor is configured to control the transceiver to send and receive a signal, and the processor is configured to invoke and run the computer program or the instructions stored in the memory, so that the processor implements the method according to any one of the foregoing aspects and the possible designs of the aspects.

According to an eleventh aspect, this application provides a communication apparatus, including a processor, where the processor is configured to invoke a computer program or instructions in a memory, so that the communication apparatus performs the method according to any one of the foregoing aspects and the possible designs of the aspects.

Optionally, the communication apparatus further includes the memory, and the memory is configured to store program instructions. The processor is coupled to the memory through an interface.

According to a twelfth aspect, this application provides a chip apparatus, including a processor, configured to invoke a computer program or instructions in a memory, so that the processor performs the method according to any one of the foregoing aspects and the possible designs of the aspects.

Optionally, the processor is coupled to the memory through an interface.

According to a thirteenth aspect, this application provides a chip, including an interface circuit and a logic circuit, where the interface circuit is configured to receive a signal from another chip different from the chip and transmit the signal to the logic circuit, or send a signal from the logic circuit to another chip different from the chip; and the logic circuit is configured to implement the method according to any one of the foregoing aspects and the possible designs of the aspects.

According to a fourteenth aspect, this application provides a computer-readable storage medium. The computer-readable storage medium stores a computer program or instructions, and the computer program or the instructions are set to perform the method according to any one of the foregoing aspects and the possible designs of the aspects.

According to a fifteenth aspect, this application provides a computer program product. When the computer program product runs on a computer, the computer is enabled to perform the method according to any one of the foregoing aspects and the possible designs of the aspects.

### BRIEF DESCRIPTION OF DRAWINGS

FIG. 1 is a diagram of a paging control channel configuration (PCCH-config) for paging;

FIG. 2 is a diagram of a paging early indication (PEI);

FIG. 3 is a diagram of an architecture of a communication system according to an embodiment of this application;

FIG. 4 is an interaction flowchart of a communication method according to an embodiment of this application;

FIG. 5 is a diagram of coordinated reception on a plurality of carriers in a carrier group according to an embodiment of this application;

FIG. 6 is a diagram of coordinated reception on a plurality of carriers in a carrier group according to an embodiment of this application;

FIG. 7 is a diagram of coordinated reception on a plurality of carriers in a carrier group according to an embodiment of this application;

FIG. 8 is a diagram of coordinated reception on a plurality of carriers in a carrier group according to an embodiment of this application;

FIG. 9 is a diagram of coordinated reception on a plurality of carriers in a carrier group according to an embodiment of this application;

FIG. 10 is a diagram of coordinated reception on a plurality of carriers in a carrier group according to an embodiment of this application;

FIG. 11 is a diagram of coordinated reception on a plurality of carriers in a carrier group according to an embodiment of this application;

FIG. 12 is an interaction flowchart of a communication method according to an embodiment of this application;

FIG. 13 is an interaction flowchart of a communication method according to an embodiment of this application;

FIG. 14 is a diagram of coordinated reception on a plurality of carriers in a carrier group according to an embodiment of this application;

FIG. 15 is a diagram of coordinated reception on a plurality of carriers in a carrier group according to an embodiment of this application;

FIG. 16 is a diagram of coordinated reception on a plurality of carriers in a carrier group according to an embodiment of this application;

FIG. 17 is a diagram of coordinated reception on a plurality of carriers in a carrier group according to an embodiment of this application;

FIG. 18 is a diagram of coordinated reception on a plurality of carriers in a carrier group according to an embodiment of this application;

FIG. 19 is a diagram of a structure of a communication apparatus according to an embodiment of this application;

FIG. 20 is a diagram of a structure of a communication apparatus according to an embodiment of this application;

FIG. 21 is a diagram of a structure of a communication apparatus according to an embodiment of this application;

FIG. 22 is a diagram of a structure of a communication apparatus according to an embodiment of this application;

FIG. 23 is a diagram of a hardware structure of a communication apparatus according to an embodiment of this application; and

FIG. 24 is a diagram of a hardware structure of a communication apparatus according to an embodiment of this application.

### DESCRIPTION OF EMBODIMENTS

In this application, “at least one” means one or more, and “a plurality of” means two or more. The term “and/or” describes an association relationship between associated objects, and represents that three relationships may exist. For example, A and/or B may represent the following cases: Only A exists, both A and B exist, and only B exists, where A and B may be singular or plural. The character “/” generally indicates an “or” relationship between the associated objects. At least one of the following items (pieces) or a similar expression thereof indicates any combination of these items, including a single item (piece) or any combination of a plurality of items (pieces). For example, at least one item (piece) of a, b, or c may represent: a, b, c, a combination of a and b, a combination of a and c, a combination of b and c, or a combination of a, b and c, where each of a, b, and c may be in a singular form or a plural form. In addition, terms “first” and “second” are merely used for a purpose of description, and shall not be understood as an indication or implication of relative importance.

Some terms in this application are first described below, to help persons skilled in the art have a better understanding.

### 1. Beam

The beam is a communication resource. The beam may be a wide beam, a narrow beam, or another type of beam. A technology for forming a beam may be a beamforming technology or another technical means. The beamforming technology may be specifically a digital beamforming technology, an analog beamforming technology, and a hybrid digital/analog beamforming technology. Different beams may be considered as different resources. The same or different information may be sent by using different beams. Optionally, a plurality of beams having a same communication feature or similar communication features may be considered as one beam. One beam may be formed by using one or more antenna ports, and is used to transmit a data channel, a control channel, a sounding signal, and the like. For example, a transmit beam may be a distribution of signal strength formed in different directions in space after a signal is transmitted through an antenna, and a receive beam may be a distribution of signal strength, in different directions in space, of a radio signal received from an antenna. It may be understood that one or more antenna ports forming one beam may also be considered as one antenna port set.

Beams may be classified into a transmit beam and a receive beam of a network device and a transmit beam and a receive beam of a terminal device.

When a low band or an intermediate band is used, a signal may be sent omnidirectionally or at a wide angle. When a high band is used, because of a small carrier wavelength of a high-frequency communication system, antenna arrays including a plurality of antenna elements may be disposed at a transmitting end and a receiving end. The transmitting end sends a signal by using a specific beamforming weight, to enable the sent signal to form a spatially directional beam, and the receiving end receives the signal through the antenna array by using a specific beamforming weight, so that a receive power of the signal at the receiving end can be increased, and a path loss can be avoided. The foregoing process may be referred to as a beamforming technology.

The beamforming technology mentioned above may be applied to a network device, or may be applied to a terminal device (in other words, an antenna array may also be configured on the terminal device), or may be applied to both a network device and a terminal device. This is not limited in this application. For example, a large-scale antenna (massive multiple-input multiple-output, massive MIMO) array, for example, 64, 128, 256, 1024, or another quantity of antennas, may be configured on the network device. Therefore, communication is implemented by using the antenna array, and radio signal transmission quality can be improved.

When the network device is used as a transmitting end and the terminal device is used as a receiving end, the network device may transmit radio signals in different directions by using a plurality of beams (Tx beams) with different orientations, to cover a service area. Correspondingly, the terminal device may receive, by using a plurality of beams (Rx beams) with different orientations, radio signals that are transmitted by the network device in different directions.

In addition, the network device may alternatively send a radio signal by using a beam with one orientation. A quantity of beams used by the network device to send a radio signal is not limited in this application. The terminal device may alternatively receive a radio signal by using a beam with one orientation. A quantity of beams used by the terminal device to receive a radio signal is not limited in this application.

In new radio (NR), on a synchronization and broadcast channel, a plurality of beams are usually used to send a plurality of SSBs, and there is one sending periodicity. In each sending periodicity, a transmitting end sends SSBs of a plurality of different beams in a time division manner. SSBs of all different beams in one sending periodicity form a synchronization broadcast resource block set (SS burst set).

An SSBx represents an SSB in a beam direction, a digit x represents an index of the SSB, and x is an integer greater than or equal to 0. Each SSB occupies four orthogonal frequency division multiplexing (OFDM) symbols in the time domain. The transmitting end may choose to send an SSB of one, two, four, or eight beams.

In addition, the beamforming technology mentioned above may focus energy of a radio signal, to form a directional beam, so that the energy of the radio signal is concentrated in a direction in which a receiving end is located. In other words, if an orientation of a beam used by the transmitting end slightly deviates from the receiving end or is aligned with the receiving end, the receiving end can receive a high-quality radio signal. If an orientation of a beam used by the transmitting end deviates from the receiving end, the receiving end may not receive a high-quality radio signal.

When the transmitting end and/or the receiving end use beams with different orientations, there is a pair of beams (to be specific, including one beam used by the transmitting end and one beam used by the receiving end). Compared with a combination of other beams, directions of the pair of beams are aligned or have a small deviation, so that the pair of beams have a good degree of alignment. In this way, the receiving end can receive a high-quality radio signal.

The pair of beams may be referred to as a beam pair, and the beam pair may include one beam (namely, a transmit beam) used by the transmitting end and one beam (namely, a receive beam) used by the receiving end. In other words, orientations of the transmit beam and the receive beam are aligned or have a small deviation, so that the beam pair has a good degree of alignment. For example, when a reference signal received power (RSRP) of a reference signal received by the terminal device is greater than or equal to a preset threshold, it may be considered that a beam pair formed by a transmit beam used by the network device to send the reference signal and a receive beam used by the terminal device to receive the reference signal has a good degree of alignment. Alternatively, when the transmit beam and the receive beam satisfy a specific communication requirement, it may be considered that the beam pair has a good degree of alignment.

In other words, the network device may transmit a radio signal by using the transmit beam in the beam pair, to implement radio signal transmission between the network device and the terminal device; and/or the terminal device may receive a radio signal by using the receive beam in the beam pair, to implement radio signal transmission between the network device and the terminal device. In this way, the terminal device can receive a high-quality radio signal. This helps improve communication quality.

In addition, in NR, each channel has its own demodulation reference signal (DM-RS) and another measurement reference signal, for example, an SSB, a channel state information-reference signal (CSI RS), or a sounding reference signal (SRS). The channels and/or signals are separately transmitted through a narrowband in a beamforming manner, and the transmitted channels and/or signals covers only a part of a cell. Even if the channels and/or signals are sent from a same network device or terminal device, it cannot be considered that the channels and/or signals are associated and in quasi-co-location (QCL).

The QCL indicates that a plurality of resources have one or more same or similar communication features. For a plurality of resources that are in QCL, a same communication configuration or similar communication configurations may be used. For example, if two antenna ports have a co-location relationship, a large-scale channel property of transmitting one symbol through one port may be inferred from a large-scale channel property of transmitting one symbol through the other port. The large-scale property may include a delay spread, an average delay, a Doppler spread, a Doppler frequency shift, an average gain, and a spatial receive parameter. Specifically, the spatial receive parameter may include a receive angle of arrival, spatial correlation of a receiver antenna, a dominant angle of arrival (AoA), an average angle of arrival, an AoA spread, and the like. In a specific implementation, the QCL indicates whether at least two groups of antenna ports are in the QCL, the QCL indicates whether channel state information-reference signals sent through the at least two groups of antenna ports are from a same transmission point, or the QCL indicates whether channel state information-reference signals sent by the at least two groups of antenna ports are from a same beam group.

Therefore, a network device and a terminal device need to consider QCL of a channel and/or a signal, for example, a specific SSB or CSI-RS that is associated and in quasi-co-location with a physical downlink shared channel (PDSCH) or a physical downlink control channel (PDCCH). Therefore, the terminal device can receive an associated and quasi-co-located channel and/or signal.

For example, if an SSB and a PDSCH are associated and in quasi-co-location, directions of a beam for the SSB and a beam for the PDSCH need to be consistent as much as possible, so that the terminal device can receive the SSB and the PDSCH that are associated and in quasi-co-location.

For another example, if an SSB and a PDCCH are associated and in quasi-co-location, directions of a beam for the SSB and a beam for the PDCCH need to be consistent as much as possible, so that the terminal device can receive the SSB and the PDCCH that are associated and in quasi-co-location.

In conclusion, the PDSCH and the SSB are associated and in QCL or the PDCCH and the SSB are associated and in QCL. Correspondingly, the beam for the PDSCH is the same as the beam for the SSB or the beam for the PDCCH is the same as the beam for the SSB.

### 2. Paging Mechanism

In NR, paging triggered by a core network (CN) is supported, and paging triggered by a network device, which is referred to as radio access network (RAN) paging, is further supported.

Currently, the network device may initiate paging on a single carrier. The paging initiated by the network device is used to trigger a terminal device to establish a radio resource control (RRC) connection, and is further used to: notify the terminal device to update a system information, send an alert message of an earthquake and tsunami warning system (ETWS) or a commercial mobile alert system (CMAS), notify the terminal device to stop paging detection, and the like.

### 2.1 Paging Message

A process in which a network device sends a paging message is as follows: The paging message is sent to a terminal device through a PDSCH, and the PDSCH is scheduled by using a PDCCH scrambled by using a paging radio network temporary identifier (P-RNTI).

In other words, a process in which the terminal device obtains the paging message is as follows: Before receiving paging, the terminal device does not know whether the network device actually has sent the paging message to the terminal device. Therefore, the terminal device in an idle state or an inactive state is woken on each paging occasion (PO).

It should be understood that, in addition to being referred to as a paging occasion, the PO may also be referred to as a paging opportunity.

The idle state is a state of the terminal device that has camped in a cell but has not performed a random access process. The terminal device usually enters the idle state after the terminal device is powered on or after RRC connection release.

The idle state corresponds to a connected state. The connected state is a state the terminal device is in after completing the random access process but has not performed the RRC connection release. The terminal device may perform data transmission with the network device when the terminal device is in the connected state. When the terminal device is in the idle state, after completing the random access process, the terminal device switches to the connected state. When the terminal device is in the connected state, after completing the RRC connection release, the terminal device switches to the idle state.

The inactive state is a state between the connected state and the idle state. For the terminal device in the inactive state, a user plane bearer of an air interface has been suspended, while a user plane bearer and a control plane bearer between a RAN and a CN are still maintained. When the terminal device initiates a call or service request, the user plane bearer of the air interface needs to be activated, and the existing user plane bearer and the existing control plane bearer between the RAN and the CN need to be reused.

After being woken, the terminal device monitors the PDCCH scrambled by using the P-RNTI, parses downlink control information (DCI) of the PDCCH, and determines demodulation information (for example, a time-frequency position) of the PDSCH by using the DCI. The terminal device receives the PDSCH based on the demodulation information of the PDSCH, and obtains the paging message on the PDSCH. The paging message carries a terminal device identification list, and the terminal device identification list includes an identification (for example, an identifier (ID)) of one or more terminal devices that can access a network. The terminal device determines whether an identification of the terminal device exists in the terminal device identification list. If yes, the terminal device performs a corresponding operation, for example, establishes an RRC connection. Therefore, the terminal device can access the network.

### 2.2 SMS Message (Short Message)

The SMS message is further defined in NR. A process in which a network device sends an SMS message is as follows: The network device may perform indication only by using DCI of a PDCCH scrambled by using a P-RNTI, and there is no corresponding PDSCH. Indication information included in the SMS message includes a system information update, an ETWS or CMAS alert message, a notification notifying a terminal device to stop paging detection, and the like.

In other words, a process in which the terminal device obtains the SMS message is as follows: Before receiving paging, the terminal device does not know whether the network device actually has sent the SMS message to the terminal device. Therefore, the terminal device in an idle state or an inactive state is woken on each PO.

After being woken, the terminal device monitors the PDCCH scrambled by using the P-RNTI, and obtains the SMS message from the DCI of the PDCCH. The terminal device may perform a corresponding operation based on a type of the SMS message. For example, when the type of the SMS message indicates a system information update, the terminal device may re-receive a system information in a next period.

### 2.3 PCCH-Config

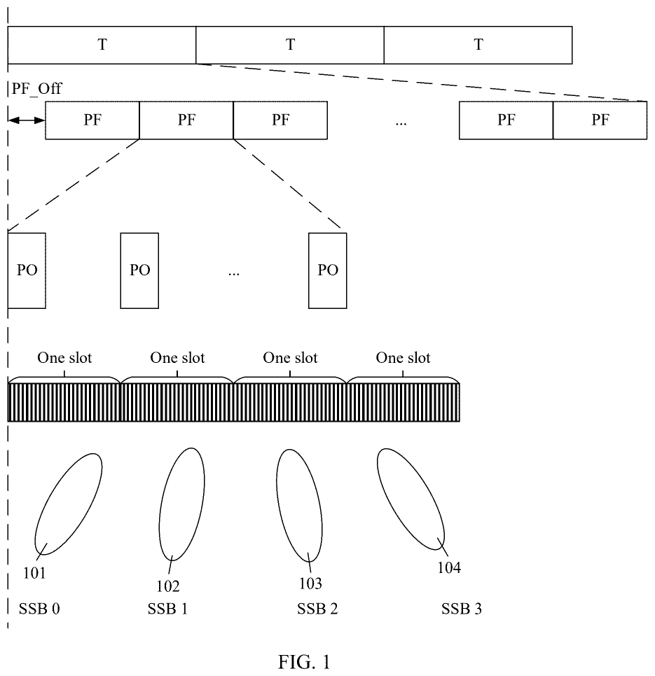

Regardless of reception of a paging message or an SMS message, a terminal device needs to be woken periodically. To reduce energy consumption and unnecessary monitoring of the terminal device, a network device may broadcast PCCH-config information, shown in FIG. 1, in a system information to the terminal device.

A PCCH-config is a single-carrier configuration related to reception of a paging message or an SMS message. The PCCH-config may include a paging cycle, a frame offset of a paging frame (PF), a start position of a PO, and the like.

In other words, the terminal device may determine a PO of a paging message or an SMS message in each paging cycle based on information such as the PCCH-config and the identification of the terminal device. Usually, a specific time of the PO of the paging message or the SMS message in each paging cycle may be defined by using the PF and the PO.

The PF indicates a frame for sending the paging message or the SMS message, in other words, the terminal device in an idle state and an inactive state only attempts to receive the paging message or the SMS message in the PF.

The PF may be defined by using the following formula:

(SFN+PF_offset)mod T=(T div N)×(UE_ID mod N).

SFN is a system frame number. PF_offset is a frame offset of the PF. T is a discontinuous reception (DRX) cycle, is a time unit, and may be understood as one duration T in which the terminal device has one or more opportunities to attempt to receive a paging message or an SMS message. N is a quantity of PFs included in each DRX cycle. UE_ID is the identification of the terminal device, div represents obtaining an integer part of a quotient through division, and mod represents obtaining a remainder through division. When one SFN satisfies the foregoing formula, the SFN may be considered as one PF. Therefore, the terminal device attempts to receive a paging message or an SMS message in the PF.

Each PF may correspond to a plurality of POs. In NR, a parameter Ns represents a quantity of POs corresponding to one PF. In other words, each PF may include Ns POs.

The PO indicates an occasion for attempting to receive a paging message or an SMS message in one PF.

The paging message or the SMS message is actually scheduled by using a PDCCH scrambled by using a P-RNTI. Therefore, one PO may be a group of S×X consecutive PDCCH monitoring occasions (MOs).

In addition to being referred to as a monitoring occasion, the MO may also be referred to as a monitoring opportunity.

S is a quantity of actually transmitted SSBs in a synchronization broadcast resource block set that is indicated by a system information (for example, a SIB 1). Usually, S is an integer greater than or equal to 1. In this application, S is greater than 1.

X is a PDCCH MO of each SSB on the PO. If X has been configured in a protocol, X is of a configured value, for example, 1, 2, 3, or 4. If X has not been configured in a protocol, X is 1 by default. Usually, X is an integer.

For ease of description, in this application, an example in which X is 1 is used for description. Based on this, each PO may include S consecutive PDCCH MOs. S is the quantity of SSBs in the synchronization broadcast resource block set.

The network device supports a plurality of beams. Therefore, a paging message or an SMS message needs to be sent by using a plurality of beams in turn. Correspondingly, the network device also needs to send, in a polling mode, a paging message or an SMS message in S consecutive paging slots by using different transmit beams.

In other words, each PO includes S consecutive paging slots, namely, the S consecutive PDCCH MOs.

With reference to FIG. 1, assuming that there are four transmit beams with different directions for SSBs, a transmit beam 101 is used to send an SSB 0, a transmit beam 102 is used to send an SSB 1, a transmit beam 103 is used to send an SSB 2, and a transmit beam 104 is used to send an SSB 3, one PO may include four consecutive paging slots (the slot is used for illustration in FIG. 1).

In addition, one or more transmit beams for a paging message or an SMS message is the same as one or more transmit beams for an SSB. A sequence of the one or more transmit beams for a paging message or an SMS message is the same as a sequence of the one or more transmit beams for an SSB.

Transmit beams for a paging message or an SMS message in the S consecutive paging slots are the same as transmit beams for the SSBs, and a sequence of the transmit beams for the paging message or SMS message in the S consecutive paging slots is also the same as a sequence of the transmit beams for the SSBs.

The network device needs to send a paging message or an SMS message in the S consecutive paging slots of each PO in the time domain. However, a quantity of transmit beams used by the network device increases, and correspondingly, the quantity S of SSBs increases. Consequently, a sending duration of the network device in the time domain is prolonged, and energy consumption of the network device is increased.

It should be noted that in NR, two SSBs may be sent in each slot. The two SSBs may be sent by using different beams. In another network system, one or more SSBs may be sent in each slot.

In addition, the paging slot mentioned in this application means that a slot is used as a scheduling unit during paging reception, and there is only one PDCCH MO in each slot. In addition to using a slot as a scheduling unit, the paging slot may also support using a non-slot for scheduling. When a non-slot is used as a scheduling unit, there may be more than one PDCCH MO in each non-slot.

Persons skilled in the art may learn that, in NR, a normal slot may include 14 (normal (cyclic prefix (cyclic prefix, CP))) or 12 (extended CP) OFDM symbols. A non-slot may occupy two, four, seven, or eight OFDM symbols.

### 2.4 PEI

For a terminal device in an idle state, to reduce energy consumption of the terminal device, the 3rd generation partnership project (3GPP) introduced a PEI. The PEI may be sent before a PO. If the PEI indicates that there is no paging message or SMS message, the terminal device may enter a sleep mode after receiving an SSB and the PEI, and does not need to receive paging DCI and a PDSCH on the PO. Therefore, the energy consumption of the terminal device is reduced. In addition, the PEI may simultaneously indicate one or more POs. In addition, the PEI may further carry subgroup information, and the subgroup information indicates a subgroup in which a terminal device can skip the PO. In this way, for terminal devices sharing a same PO, the terminal devices are grouped, and a terminal device that is not paged may not need to be woken, so that unnecessary energy consumption of the terminal device is reduced.

To enable PEI notification, a new DCI format is defined in a protocol, for a terminal device in an idle state and a terminal device in an inactive state to receive a PEI message. A network device broadcasts information such as a PEI configuration (PEI-config) in a system information. The PEI-config is a single-carrier configuration related to reception of a PEI message.

For each PEI occasion (PEI-O), one PEI-O may include S consecutive PDCCH MOs. S is a quantity of SSBs in a synchronization broadcast resource block set.

In other words, a PEI needs to be sent by using a plurality of beams in turn, the same as sending a paging message or an SMS message. Correspondingly, the network device also needs to send, in a polling manner, a PEI message in S consecutive PEI monitoring slots by using different transmit beams.

In other words, each PEI-O includes S consecutive PEI monitoring slots, namely, S consecutive PDCCH MOs.

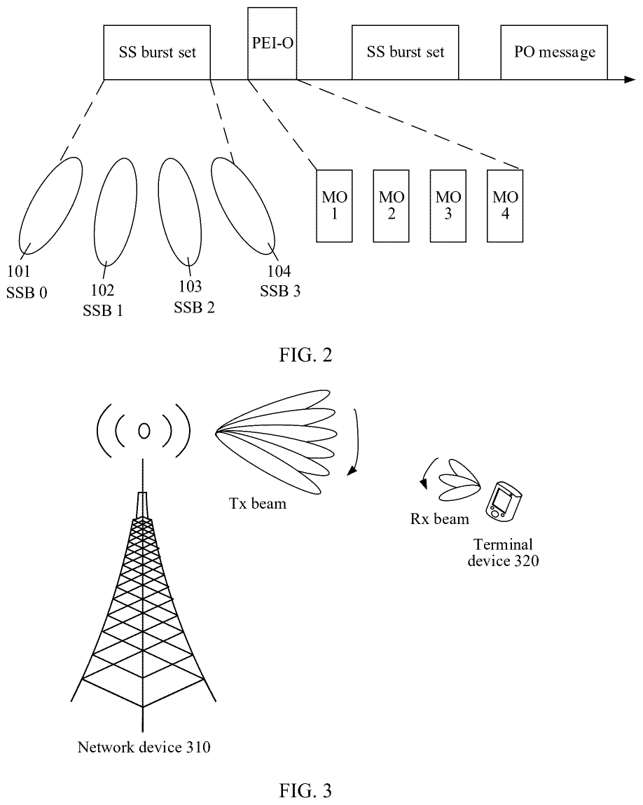

As shown in FIG. 2, assuming that there are four transmit beams with different directions for SSBs, a transmit beam 101 is used to send an SSB 0, a transmit beam 102 is used to send an SSB 1, a transmit beam 103 is used to send an SSB 2, and a transmit beam 104 is used to send an SSB 3, one PEI-O may include four consecutive PEI monitoring slots (an MO 1, an MO 2, an MO 3, and an MO 4 are used for illustration in FIG. 2).

In addition, a transmit beam for a PEI message is the same as a transmit beam for an SSB. A sequence of transmit beams for a PEI message is the same as a sequence of transmit beams for an SSB.

Transmit beams for the PEI message in the S consecutive PEI monitoring slots are the same as transmit beams for the SSBs, and a sequence of the transmit beams for the PEI message in the S consecutive PEI monitoring slots is also the same as a sequence of the transmit beams for the SSBs.

It can be learned that the network device needs to send a PEI message in the S consecutive PEI monitoring slots of each PEI-O in the time domain. However, a quantity of transmit beams used by the network device increases, and correspondingly, the quantity S of SSBs increases. Consequently, a sending duration of the network device in the time domain is prolonged, and energy consumption of the network device is increased.

It should be noted that in NR, two SSBs may be sent in each PEI monitoring slot. The two SSBs may be sent by using different beams. In another network system, one or more SSBs may be sent in each PEI monitoring slot.

In addition, the PEI monitoring slot mentioned in this application means that a slot is used as a scheduling unit during paging reception, and there is only one PDCCH MO in each slot. In addition to using a slot as a scheduling unit, the PEI monitoring slot may also support using a non-slot for scheduling. When a non-slot is used as a scheduling unit, there may be more than one PDCCH MO in each non-slot.

### 3. Carrier

For a terminal device in a connected state, in 3GPP, a plurality of non-anchor carriers can be configured for data transmission. However, a random access channel (RACH) and a paging message or an SMS message are still on an anchor carrier. To increase capacities of the RACH and the paging message or the SMS message, the 3GPP standardizes paging and random access initiation on a non-anchor carrier. Paging in the 3GPP has the following characteristics:
1. A paging PDCCH and a paging PDSCH are on a same carrier, to be specific, both on an anchor carrier or a non-anchor carrier;
2. paging DRX cycles are the same on all carriers; and
3. paging load imbalance between anchor and non-anchor carriers is supported.

For each carrier, a weighting factor P is configured, for the terminal device to determine a paging carrier. Specifically, the paging carrier has a smallest carrier index that satisfies the following formula:

$$floor ( UE\_ID / ( N * Ns ) ) mod W < W ( 0 ) + W ( 1 ) + … + W ( n ) .$$

Here, floor represents rounding down, N represents a total quantity of paging carriers, Ns represents a quantity of POs in one PF, W(i) represents a weight of a configured paging carrier i, and W is a sum of weights of all the paging carriers.

The 3GPP supports paging on anchor and non-anchor carriers. However, regardless of whether a network device sends a paging message or an SMS message on a single carrier or a plurality of carriers, the terminal device determines, only according to a formula predefined in a protocol, a unique carrier to receive the paging message or the SMS message.

In conclusion, to reduce energy consumption of a network device, this application provides a communication method and apparatus. A plurality of carriers are used for coordinated transmission of a paging-related message, so that a sending duration of the network device in the time domain can be reduced, and the energy consumption of the network device can be further reduced. In addition, the plurality of carriers of the network device can be simultaneously muted by using a muting mechanism in different dimensions, to reduce the energy consumption of the network device.

The paging-related message mentioned in this application may be understood as a message related to paging, for example, the paging message, the SMS message, or the PEI message mentioned above, or may be a newly added message related to paging.

It should be understood that the paging message or the SMS message may be a message indicated by DCI scrambled based on a P-RNTI, or may be a message indicated by DCI scrambled by using another identification. This is not limited in this application.

The communication method in this application may be applied to a communication system. The communication system may include but is not limited to a wireless communication system, for example, a narrowband internet of things (NB-IoT) system, an LTE system, a 5G communication system, or a communication system evolved after 5G, for example, a 6G communication system.

A scenario to which the communication system is applicable may include but is not limited to: terrestrial cellular communication, non-terrestrial network (NTN) communication, satellite communication, high altitude communication platform (HAPS) communication, vehicle-to-everything (V2X) communication, integrated access and backhaul (IAB) communication, reconfigurable intelligent surface (RIS) communication, and the like.

FIG. 3 is a diagram of an architecture of a communication system according to an embodiment of this application. As shown in FIG. 3, the communication system in this application may include a network device 310 and a terminal device 320.

There may be one or more network devices 310. The network device 310 may be a device in a wireless network. The network device 310 may be a base station, an access point, or an access network device, or may be a device that communicates with a wireless terminal by using one or more sectors on an air interface in an access network. The network device 310 may be configured to: mutually convert a received over-the-air frame and an internet protocol (IP) packet, and serve as a router between the wireless terminal and a remaining portion of the access network, where the remaining portion of the access network may include an IP network. The network device 310 may further coordinate attribute management of the air interface. For example, the network device 310 may be a satellite, an unmanned aerial vehicle, or an evolved NodeB (eNB or eNodeB) in LTE. Alternatively, the network device 310 may be a radio controller in a cloud radio access network (CRAN) scenario; a wearable device or a vehicle-mounted device; a terminal, a relay station, or an access point that functions as a base station in vehicle-to-everything (V2X), device-to-device (D2D) communication, and machine-to-machine (M2M) communication; a base station, for example, a gNB, in a 5G network; a base station in a future 6G network; or a network device in a future evolved public land mobile network (PLMN). This is not limited herein.

The network device 310 may be a RAN node that connects the terminal device 320 to the wireless network. Currently, examples of some RAN nodes are: a gNB, a transmission reception point (TRP), an evolved NodeB (eNB), a home base station (for example, a home evolved NodeB, or a home NodeB, HNB), a baseband unit (BBU), a wireless fidelity (Wi-Fi) access point (AP), an IAB, and the like.

In a network structure, the network device 310 may include a central unit (CU) node or a distributed unit (DU) node, a RAN device including a CU node and a DU node, or a RAN device including a control plane CU node (CU-CP node), a user plane CU node (CU-UP node), and a DU node.

It may be understood that the RAN node is divided into the CU and the DU from a perspective of logical functions. The CU is connected to the DU through an F1 interface. On behalf of a gNB, the CU may be connected to a core network through an NG interface. The CU and the DU may be physically separated, or may be deployed together. This is not specifically limited in embodiments of this application. One CU may be connected to one DU, or a plurality of DUs may share one CU, so that costs can be reduced and network extension is easy. The CU and the DU may be divided according to a protocol stack. In a possible manner, RRC, a service data adaptation protocol (SDAP) stack, and a packet data convergence protocol (PDCP) layer are deployed in the CU, and a radio link control (RLC) layer, a media access control (MAC) layer, and a physical layer are deployed in the DU. In this application, the foregoing protocol stack division manner is not completely limited, and there may be another division manner.

There may be one or more terminal devices 320. The terminal device 320 is a device that has a wireless transceiver function. The terminal device 320 may be a wireless terminal or a wired terminal. The wireless terminal may be a device that provides a user with voice and/or other service data connectivity, a handheld device with a wireless connection function, or another processing device connected to a wireless modem. The wireless terminal may communicate with one or more core networks through a RAN. The wireless terminal may be a mobile terminal, for example, a mobile phone (also referred to as a “cellular” phone), and a computer with a mobile terminal. For example, the wireless terminal may be a portable, pocket-sized, handheld, computer built-in, or vehicle-mounted mobile apparatus, which exchanges voice and/or data with the radio access network. For example, the wireless terminal is a device such as a personal communications service (PCS) phone, a cordless phone, a session initiation protocol (SIP) phone, a wireless local loop (WLL) station, a personal digital assistant (PDA), an uncrewed aerial vehicle, a wearable device, or a terminal in an internet of vehicles. The wireless terminal may also be referred to as a system, a subscriber unit, a subscriber station, a mobile station, a remote station, a remote terminal, an access terminal, a user terminal, a user agent, a user device, a user equipment (UE), a terminal unit, a terminal station, a remote station, a mobile device, a terminal, a wireless communication device, a terminal agent, a terminal apparatus, or the like. This is not limited herein. The wireless terminal may alternatively be a terminal device in a 6G network, a terminal device in a future evolved public land mobile network (PLMN), or the like.

This application may be applied to downlink signal transmission, may be applied to uplink signal transmission, or may be applied to D2D signal transmission. For downlink signal transmission, a sending device is the network device 310, and a corresponding receiving device is the terminal device 320. For uplink signal transmission, a sending device is the terminal device 320, and a corresponding receiving device is the network device 310. For D2D signal transmission, a sending device is the terminal device 320, and a corresponding receiving device is also the terminal device 320. The sending device may serve as a relay to forward a signal from the network device 310 to the receiving device. A signal transmission direction is not limited in this application.

Communication between the network device 310 and the terminal device 320 and communication between terminal devices 320 may be performed by using a licensed spectrum, an unlicensed spectrum, or both a licensed spectrum and an unlicensed spectrum. The communication between the network device 310 and the terminal device 320 and the communication between the terminal devices 320 may be performed by using a spectrum below 6 gigahertz (GHz), a spectrum above 6G, or both a spectrum below 6G and a spectrum above 6G. A spectrum resource used between the network device 310 and the terminal device 320 is not limited in this application.

In some embodiments, the communication system is applicable to a standalone (SA) scenario, a dual connectivity (DC) scenario, and the like.

In the SA scenario, the terminal device 320 is connected to the single network device 310. The network device 310 connected to the terminal device 320 and a core network connected to the network device 310 are of a same standard. For example, the core network is a 5G Core, the corresponding network device 310 is a 5G base station, and the 5G base station is directly connected to the 5G Core. For another example, the core network is a 6G Core, the corresponding network device 310 is a 6G base station, and the 6G base station is directly connected to the 6G Core.

In the DC scenario, the terminal device 320 is connected to network devices 310 of different standards/a same standard, and is usable for the network device 310 in a connected state. For example, a core network is a 5G Core, the corresponding network devices 310 are a 5G base station and a 6G base station, and the terminal device 320 is connected to both the 5G base station and the 6G base station, where the 5G base station is used as a master station, and the 6G base station is used as a secondary station. For another example, a core network is a 6G Core, the corresponding network devices 310 are a 5G base station and a 6G base station, and the terminal device 320 is connected to both the 6G base station and the 5G base station, where the 6G base station is used as a master station, and the 5G base station is used as a secondary station. For another example, a core network is a 6G Core, the corresponding network devices 310 are two 6G base stations, and the terminal device 320 is connected to both the two 6G base stations, in other words, both a master station and a secondary station are the 6G base stations.

It should be understood that, in this application, a solution in which a plurality of carriers are used for coordinated transmission of a paging-related message is used, especially for the terminal device 320 in an idle state and the terminal device 320 in an inactive state, there is no DC scenario, or it may be understood that the solution is only for a master station in the DC scenario. ADC scenario exists for a solution in which a muting mechanism in different dimensions is used.

In the following embodiments of this application, the network device 310 and the terminal device 320 that have the structures shown in FIG. 3 are used as an example to describe in detail, with reference to the accompanying drawings and an application scenario, the communication method provided in this application for a solution in which a plurality of carriers are used for coordinated transmission of a paging-related message.

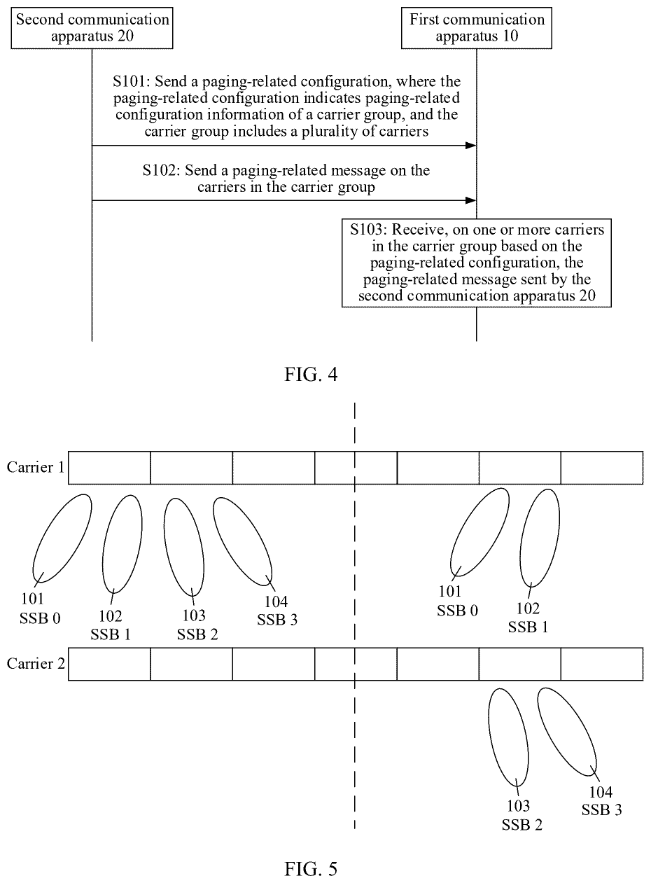

FIG. 4 is an interaction flowchart of a communication method according to an embodiment of this application. The method relates to a first communication apparatus and a second communication apparatus. The first communication apparatus may be a terminal device or an apparatus in the terminal device, and the second communication apparatus may be a network device or an apparatus in the network device. As shown in FIG. 4, the communication method provided in this application may include the following steps.

S101: The second communication apparatus sends a paging-related configuration to the first communication apparatus, where the paging-related configuration indicates paging-related configuration information of a carrier group, and the carrier group includes a plurality of carriers.

With continuous development of a wireless network, in addition to widely deployed 700 MHz, 800 MHz, 900 MHz, 1800 MHz, 2100 MHz, 2600 MHz, and 3500 MHz, deployed network bands further include 28 GHz, 39 GHz, 70 GHz, and terahertz bands.

To avoid a continuous increase of the number of antenna hardware apparatuses, integration of a network device is continuously improved, from a single module supporting a single band to a single module supporting multiple bands and a single module supporting an ultra-wideband. Correspondingly, the network device supports one or more hardware apparatuses, and each hardware apparatus supports one or more carriers. The hardware apparatus may also be referred to as a hardware module, a hardware circuit, a hardware device, or the like. Both the terms “module” and “unit” as used herein may refer to hardware, software, or hardware configured with software.

Based on this, one or more carrier groups may be configured for the second communication apparatus 20, and each carrier group includes one or more carriers.

Parameters such as a quantity of carriers and a type of the carrier in the carrier group are not limited in this application.

In some implementations, at least one of the following methods may be used for a plurality of carriers in one carrier group:
a same radio access technology (RAT), where for example, a RAT of each carrier is 5G, or a RAT of each carrier is 6G;
different RATs, where for example, a RAT of one or more carriers is 5G, and a RAT of one or more other carriers is 6G;
a same duplex mode, where for example, each carrier is a time division multiplexing (TDD) carrier, or each carrier is a frequency division multiplexing (FDD) carrier; different duplex modes, where for example, one or more carriers are TDD carriers, and one or more other carriers are FDD carriers;
a same TDD configuration;
different TDD configurations;
a same subcarrier spacing (SCS); or
different subcarrier spacings.

In NR, it is assumed that a subcarrier spacing supported in a protocol is 2\hat{ }μ*15 kHz. μ=0, 1, 2, 3, to be specific, subcarrier spacings supported in NR are respectively 15 kHz, 30 kHz, 60 kHz, and 120 kHz. It can be learned that there may be a plurality of types of subcarrier spacings. Based on this, subcarrier spacings of the plurality of carriers in the carrier group may be the same or different.

In addition, a division manner of the carriers in the carrier group is not limited in this application.

In some implementations, the second communication apparatus 20 may configure, in one carrier group, a plurality of carriers supported by a same hardware apparatus.

For example, the second communication apparatus 20 may configure, in one carrier group, one or more carriers generated by a same radio frequency (RF) module in the hardware apparatus. Alternatively, the second communication apparatus 20 may configure, in one carrier group, one or more carriers generated by a same intermediate frequency (IF) module in the hardware apparatus. Alternatively, the second communication apparatus 20 may configure, in one carrier group, one or more carriers generated by a same power amplifier (PA) in the hardware apparatus. The second communication apparatus 20 may configure, in one carrier group, one or more carriers generated by another module in the hardware apparatus.

For example, it is assumed that the second communication apparatus 20 may support a total of six bands: 700 MHz, 800 MHz, 900 MHz, 1800 MHz, 2100 MHz, and 3500 MHz. An ultra-wideband hardware apparatus may be shared for 700 MHz, 800 MHz, and 900 MHz, an ultra-wideband hardware apparatus may be shared for 1800 MHz and 2100 MHz, and a broadband hardware apparatus may be used for 3500 MHz.

In this case, the second communication apparatus 20 may configure the foregoing six bands as three carrier groups. A carrier group 1 includes three carriers on 700 MHz, 800 MHz, and 900 MHz, a carrier group 2 includes two carriers on 1800 MHz and 2100 MHz, and a carrier group 3 includes one carrier on 3500 MHz.

The second communication apparatus 20 may use one hardware apparatus, to send information and/or a signal on a plurality of carriers supported by the hardware apparatus. This helps reduce overheads of the second communication apparatus 20.

If the second communication apparatus 20 does not support an ultra-wideband solution, six hardware apparatuses need to be deployed in each sector of the second communication apparatus 20. Correspondingly, the second communication apparatus 20 may simultaneously start and shut down a plurality of hardware apparatuses, and send information and/or a signal on a plurality of carriers supported by the plurality of hardware apparatuses. This can also help reduce overheads of the second communication apparatus 20.

Based on the foregoing descriptions, when learning that the first communication apparatus 10 has a corresponding device capability, the second communication apparatus 20 may choose to send a paging-related message on a plurality of carriers in a carrier group.

The device capability may indicate that the first communication apparatus 10 supports coordinated reception of the paging-related message on the plurality of carriers in the carrier group, in other words, the first communication apparatus 10 supports simultaneous reception of the paging-related message on the plurality of carriers in the carrier group.

In addition to the foregoing indicated information, the device capability may further indicate information such as whether the plurality of carriers in the carrier group have a same RAT, a same duplex mode, a same TDD configuration, or a same subcarrier spacing. It should be noted that the solution of this application is applicable to a plurality of carriers of a same RAT in a carrier group, and is also applicable to a plurality of carriers of different RATs in a carrier group. When RATs of a plurality of carriers in a carrier group are different, carriers in the carrier group may be grouped based on a same RAT. In this way, the solution of this application is applicable to a plurality of carriers of a same RAT in a grouped carrier group.

In this way, the device capability is refined, to be specific, the first communication apparatus 10 supports simultaneous reception of a paging-related message on a plurality of carriers of various types in a carrier group.

In addition, the first communication apparatus 10 may notify the second communication apparatus 20 in advance whether the first communication apparatus 10 has a corresponding device capability, so that the second communication apparatus 20 determines to send paging-related message by using one carrier or a plurality of carriers in a carrier group. Therefore, this helps implement energy saving of the second communication apparatus 20.

The paging-related message may be messages of various types such as a paging message, an SMS message, or a PEI message.

When it is determined that a plurality of carriers are selected for sending a paging-related message, the second communication apparatus 20 may determine a carrier group for sending the paging-related message.

The carrier group may include a plurality of carriers. In some implementations, each of the plurality of carriers in the carrier group is used to send the paging-related message. Alternatively, each of some of the plurality of carriers in the carrier group is used to send the paging-related message. The some carriers include a plurality of carriers.

Parameters such as a type of the carrier group, a quantity of carriers for sending the paging-related message in the carrier group, and a type of the carrier that is in the carrier group and that is used to send the paging-related message are not limited in this application. Further, “used to send the paging-related message” may be understood as “used for paging reception or used for a PEI.

Therefore, the second communication apparatus 20 may send the paging-related configuration to the first communication apparatus 10.

The paging-related configuration may indicate the paging-related configuration information of the carrier group. A specific implementation of the paging-related configuration is not limited in this application, provided that the first communication apparatus 10 can receive the paging-related message based on the paging-related configuration.

In some implementations, the second communication apparatus 20 may broadcast a system information on a carrier (for example, an anchor carrier) in the carrier group, and the system information may include the paging-related configuration. For example, a system information block (SIB) 1 in the system information may include the paging-related configuration.

In addition to a broadcast manner, the first communication apparatus 10 may further learn of the paging-related configuration in a method predefined in a protocol. Alternatively, the two methods may be combined, to enable the first communication apparatus 10 to learn of the paging-related configuration.

S102: The second communication apparatus sends a paging-related message to the first communication apparatus on the carriers in the carrier group.

The second communication apparatus 20 sends the paging-related message to the first communication apparatus 10 on the carriers in the carrier group by using a plurality of transmit beams.

The carriers in the carrier group are of a plural quantity, namely, a plurality of carriers in the carrier group. The plurality of carriers in the carrier group may be all carriers or some carriers in the carrier group, but even the some carriers include a plurality of carriers. In other words, for each PO/PEI-O of the paging-related message, sending on one carrier is changed to simultaneously sending on a plurality of carriers in a carrier group. Directions/orientations of transmit beams on the plurality of carriers are different. It should be understood that the PO/PEI-O mentioned in this application is a PO or a PEI-O.

It can be learned from the foregoing descriptions that a total quantity of PDCCH MOs of all of the plurality of carriers in the carrier group on each PO/PEI-O is equal to a quantity of SSBs in a synchronization broadcast resource block set of a cell on which the first communication apparatus 10 camps. The quantity of SSBs in the synchronization broadcast resource block set of the cell on which the first communication apparatus 10 camps is S mentioned above.

When the paging-related message is a paging message or an SMS message, a total quantity of paging slots of all carriers for paging reception in the carrier group on each PO is equal to the quantity of SSBs in the synchronization broadcast resource block set of the cell on which the first communication apparatus 10 camps.

When the paging-related message is a PEI message, a total quantity of PEI monitoring slots of all carriers for a PEI in the carrier group on each PEI-O is equal to the quantity of SSBs in the synchronization broadcast resource block set of the cell on which the first communication apparatus 10 camps.

It can be learned that a quantity of PDCCH MOs of any one of the plurality of carriers in the carrier group on each PO/PEI-O is less than the quantity of SSBs in the synchronization broadcast resource block set of the cell on which the first communication apparatus 10 camps.

A specific value of the quantity of PDCCH MOs of any one of the plurality of carriers in the carrier group on each PO/PEI-O is not limited in this application.

In a possible implementation, PDCCH MOs of all of the plurality of carriers in the carrier group on each PO/PEI-O may be evenly allocated, so that sending durations of sending the paging-related message by the second communication apparatus 20 on the carriers in the time domain are equal or nearly so. This helps reduce energy consumption of the second communication apparatus 20.

That the sending durations are equal or nearly so in this application may be understood as that a difference between two sending durations is less than or equal to 0 and is greater than or equal to t1, and a value of t1 may be predefined. In other words, the difference between the two sending durations is small or is 0.

In a possible implementation, sending time of PDCCH MOs of all of the plurality of carriers in the carrier group on each PO/PEI-O are the same or nearly the same.

The sending time mentioned in this application is a sending start moment or a sending start time point. Correspondingly, that the sending times are the same or nearly the same may be understood as that a time interval between two sending times is within a preset range, where the preset range is less than or equal to 0 and is greater than or equal to t2, and a value of t2 may be predefined. In other words, the time interval between the two sending times is small or is 0.

For example, when a same hardware apparatus is shared for the plurality of carriers in the carrier group, the second communication apparatus 20 may ensure, by using the hardware apparatus, that the sending times of the PDCCH MOs of all the carriers on each PO/PEI-O are the same or nearly the same. Alternatively, when different hardware apparatuses are used for the plurality of carriers in the carrier group, the second communication apparatus 20 simultaneously starts and shuts down the plurality of hardware apparatuses, to ensure that the sending times of the PDCCH MOs of all the carriers on each PO/PEI-O are the same or nearly the same.

It can be further learned that the PDCCH MO of any carrier for receiving the paging-related message in the carrier group on each PO/PEI-O may correspond to one or more SSBs, and a quantity of the plurality of SSBs herein is less than S mentioned above. Each SSB corresponds to a PDCCH MO of a carrier for receiving the paging-related message in the carrier group on each PO/PEI-O.

When the paging-related message is a paging message or an SMS message, a PDCCH MO of any carrier for paging reception in the carrier group on each PO may correspond to one or more SSBs, and a quantity of the plurality of SSBs herein is less than S mentioned above. Each SSB corresponds to a PDCCH MO of a carrier for paging reception in the carrier group on each PO.

When the paging-related message is a PEI message, a PDCCH MO of any carrier for a PEI in the carrier group on each PEI-O may correspond to one or more SSBs, and a quantity of the plurality of SSBs herein is less than S mentioned above. Each SSB corresponds to a PDCCH MO of a carrier for the PEI in the carrier group on each PEI-O.

A transmit beam for the paging-related message on each carrier is the same as a transmit beam for the SSB. Correspondingly, a transmit beam for the paging-related message on any PDCCH MO of each PO/PEI-O is the same as the transmit beam for the SSB.

When the paging-related message is a paging message or an SMS message, a transmit beam for the paging-related message on any PDCCH MO of each PO is the same as the transmit beam for the SSB.

When the paging-related message is a PEI message, a transmit beam for the paging-related message on any PDCCH MO of each PEI-O is the same as the transmit beam for the SSB.

For example, an SSB 0 to an SSB 7 are configured for a cell. Therefore, there are eight consecutive PDCCH MOs on each PO/PEI-O, and the SSB 0 to the SSB 7 respectively correspond to PDCCH MOs of any carrier for receiving the paging-related message in the carrier group on each PO/PEI-O.

In addition, it can be further learned from the foregoing descriptions that a sequence of transmit beams for the paging-related message on the carriers is the same as a sequence of transmit beams for the SSBs.

S103: The first communication apparatus receives, on one or more carriers in the carrier group based on the paging-related configuration, the paging-related message sent by the second communication apparatus.

In an actual application process, the first communication apparatus 10 may select, based on the paging-related configuration, one or more carriers from the carriers that are in the carrier group and on which the second communication apparatus 20 sends the paging-related message in S102, for receiving the paging-related message.

A quantity of corresponding carriers for receiving the paging-related message by the first communication apparatus 10 is not limited in this application. In addition, a corresponding manner in which the first communication apparatus 10 receives the paging-related message is also not limited in this application.

In addition, paging-related messages sent on different PDCCH MOs of each PO/PEI-O have same content. Therefore, the first communication apparatus 10 may receive, on the one or more carriers in the carrier group in a plurality of ways, the paging-related message sent by the second communication apparatus 20.

In some implementations, the first communication apparatus 10 may select a PDCCH MO with best receiving performance on each PO/PEI-O indicated by an SSB measurement result, for receiving the paging-related message on the one or more carriers in the carrier group.

One or more receive beams used by the first communication apparatus 10 to receive a paging-related message and a transmit beam for paging-related message on the PDCCH MO with the best receiving performance on each PO/PEI-O may form one or more beam pairs. For a good degree of alignment and the beam pair, refer to the foregoing descriptions. Details are not described herein again.

In some implementations, the first communication apparatus 10 may receive the paging-related message on the one or more carriers in the carrier group in a beam polling way (in other words, by using a plurality of receive beams).

For example, it is assumed that the second communication apparatus 20 sends a plurality of rounds of the SSB 0 to the SSB 7 to the first communication apparatus 10. In each round, the second communication apparatus 20 sends the SSB 0 to the SSB 7 by using a transmit beam 101 to a transmit beam 108 respectively. For example, the second communication apparatus 20 may send the SSB 0 by using the transmit beam 101, send the SSB 1 by using the transmit beam 102, send the SSB 2 by using the transmit beam 103, send the SSB 3 by using the transmit beam 104, send the SSB 4 by using the transmit beam 105, send the SSB 5 by using the transmit beam 106, send the SSB 6 by using the transmit beam 107, and send the SSB 7 by using the transmit beam 108.

Correspondingly, the first communication apparatus 10 may measure the SSB 0 to the SSB 7 by using a receive beam 201 to a receive beam 203. For example, the first communication apparatus 10 may measure the SSB 0 to the SSB 7 by using the receive beam 201, measure the SSB 0 to the SSB 7 by using the receive beam 202, and measure the SSB 0 to the SSB 7 by using the receive beam 203, to obtain measurement results of the SSB 0 to the SSB 7.

If the measurement results of the SSB 0 to the SSB 7 indicate that the transmit beam 104 is aligned with the receive beam 202, the first communication apparatus 10 may determine the SSB 3 corresponding to the transmit beam 104. The SSB 3 corresponds to a PDCCH MO of one carrier for receiving the paging-related message in the carrier group on each PO/PEI-O. Therefore, the first communication apparatus 10 may receive the paging-related message on one carrier in the foregoing carrier group by using the receive beam 202.

If the measurement results of the SSB 0 to the SSB 7 indicate that the transmit beam 103 is aligned with the receive beam 202, the transmit beam 104 is aligned with the receive beam 202, and the transmit beam 105 is aligned with the receive beam 202, the first communication apparatus 10 may determine the SSB 2 corresponding to the transmit beam 103, the SSB 3 corresponding to the transmit beam 104, and the SSB 4 corresponding to the transmit beam 105.

When the SSB 2, the SSB 3, and the SSB 4 respectively correspond to three PDCCH MOs of one carrier for receiving the paging-related message in the carrier group on each PO/PEI-O, the first communication apparatus 10 may receive the paging-related message on one carrier in the carrier group by using the receive beam 202. Alternatively, when the SSB 2, the SSB 3, and the SSB 4 respectively correspond to PDCCH MOs of the plurality of carriers for receiving the paging-related message in the carrier group on each PO/PEI-O, the first communication apparatus 10 may receive the paging-related message on the plurality of carriers in the carrier group by using the receive beam 202.

If the measurement results of the SSB 0 to the SSB 7 indicate that the transmit beam 104 is aligned with the receive beam 202, and the transmit beam 105 is aligned with the receive beam 203, the first communication apparatus 10 may determine the SSB 3 corresponding to the transmit beam 104 and the SSB 4 corresponding to the transmit beam 105.

When the SSB 3 and the SSB 4 respectively correspond to two PDCCH MOs of one carrier for receiving the paging-related message in the carrier group on each PO/PEI-O, the first communication apparatus 10 may receive the paging-related message on one carrier in the carrier group by using the receive beam 202 and the receive beam 203. Alternatively, when the SSB 3 and the SSB 4 respectively correspond to PDCCH MOs of the plurality of carriers for receiving the paging-related message in the carrier group on each PO/PEI-O, the first communication apparatus 10 may receive the paging-related message on the plurality of carriers in the carrier group by using the receive beam 202 and the receive beam 203.

In addition, the first communication apparatus 10 may further receive the paging-related message on the one or more carriers in the carrier group by using the receive beam 201, the receive beam 202, and the receive beam 203.

In conclusion, the second communication apparatus 20 sends the paging-related message on the plurality of carriers in the carrier group in a coordinated manner. Correspondingly, the first communication apparatus 10 receives the paging-related message on the one or more carriers in the carrier group based on the paging-related configuration.

In an actual network, more than one SSB may be sent in one paging slot or one PEI monitoring slot. For example, in NR, two SSBs can be sent in one paging slot or one PEI monitoring slot. For ease of description, in FIG. 5 and the following accompanying drawings, one grid is one slot, the slot may be one paging slot or one PEI monitoring slot, and two SSBs may be sent in each slot. In addition, FIG. 5 is merely an example. One grid may alternatively be one non-slot, and one or two SSBs may be sent in each non-slot. In addition, in FIG. 5, a related technology is shown on a left side of a dashed line. The solution of this application is shown on a right side of the dashed line. Correspondingly, the related technology is described by using NR as an example. It should be understood that a time-domain unit of a grid in FIG. 5 and the following figures may be a slot, or may be a non-slot. This is not specifically limited in this application.

As shown in FIG. 5, it is assumed that a carrier group includes two carriers (a carrier 1 and a carrier 2), and there are four transmit beams with different directions for SSBs. A transmit beam 101 is used to send an SSB 0, a transmit beam 102 is used to send an SSB 1, a transmit beam 103 is used to send an SSB 2, and a transmit beam 104 is used to send an SSB 3.

In the related technology, for each PO/PEI-O, the second communication apparatus 20 needs to send, in a polling manner, a paging-related message on four consecutive PDCCH MOs of one carrier by using different beams. For example, on each PO, in two consecutive paging slots of the carrier 1, the four consecutive SSBs (the SSB 0 to the SSB 3) may be respectively sent by using the transmit beams (101 to 104).

Alternatively, on each PEI-O, in two consecutive PEI monitoring slots of the carrier 1, the four consecutive SSBs (the SSB 0 to the SSB 3) may be respectively sent by using the transmit beams (101 to 104).

In this application, for each PO/PEI-O, the second communication apparatus 20 may send, by using different beams in a polling manner, the paging-related message in two consecutive paging slots or PEI monitoring slots that are with same sequence numbers and that are on the carrier 1 and the carrier 2 in the carrier group.

Sending times of the paging slots or PEI monitoring slots of the carriers are the same or nearly the same. For example, on each PO/PEI-O, in one paging slot of the carrier 1, two SSBs (the SSB 0 and the SSB 1) may be sent by using transmit beams (101 and 102), and in one paging slot of the carrier 2, two SSBs (the SSB 2 and the SSB 3) may be sent by using transmit beams (103 and 104). A sending time of the paging slot of the carrier 1 is the same, or nearly the same, as a sending time of the paging slot of the carrier 2.

Alternatively, on each PEI-O, in one PEI monitoring slot of the carrier 1, two SSBs (the SSB 0 and the SSB 1) may be sent by using transmit beams (101 and 102), and in one PEI monitoring slot of the carrier 2, two SSBs (the SSB 2 and the SSB 3) may be sent by using transmit beams (103 and 104).

A sending time of the PEI monitoring slot of the carrier 1 is the same, or nearly the same, as a sending time of the PEI monitoring slot of the carrier 2.

On each PO/PEI-O, sending the four SSBs occupies two grids of the carrier 1 in the related technology, and sending the four SSBs separately occupies one grid of the carrier 1 and one grid of the carrier 2 in this application. Based on cooperative work of the carrier 1 and the carrier 2, a sending duration of the second communication apparatus 20 in the time domain in this application is shorter than a sending duration of the second communication apparatus 20 in the time domain in the related technology.

It should be understood that the foregoing is merely an example.

According to the communication method provided in this application, the second communication apparatus sends the paging-related configuration to the first communication apparatus, so that the first communication apparatus learns, based on the paging-related configuration, of the plurality of carriers that are in the carrier group and that are used to receive the paging-related message. The second communication apparatus sends the paging-related message on the plurality of carriers in the carrier group in a coordinated manner. Correspondingly, the first communication apparatus receives the paging-related message on the one or more carriers in the carrier group based on the paging-related configuration. In this application, coordinated sending on the plurality of carriers in the carrier group is implemented. From a perspective of the second communication apparatus, a sending duration of the second communication apparatus in the time domain is reduced, and a muting duration of the second communication apparatus is increased. This helps reduce energy consumption of the second communication apparatus.

For example, when one ultra-wideband hardware apparatus is shared for a plurality of carriers in a carrier group, the second communication apparatus may support coordinated sending of a paging-related message on the plurality of carriers in the carrier group, and the first communication apparatus may support coordinated reception of the paging-related message on one or more carriers in the carrier group. Therefore, a sending duration of the paging-related message in the time domain is effectively reduced, and a muting duration of the hardware apparatus is increased. This effectively reduces network energy consumption.

Based on the descriptions of the foregoing embodiment, the paging-related configuration may be related to the type of the paging-related message.

When the paging-related message is a paging message or an SMS message, for each PO of the paging message or the SMS message, the second communication apparatus 20 may simultaneously send the paging message or SMS message on a plurality of carriers for paging reception in the carrier group, and directions/orientations of transmit beams on the plurality of carriers are different. Correspondingly, the paging-related configuration may indicate configuration information that is of the carrier group and that is for paging reception. In this way, the first communication apparatus 10 can learn, based on the paging-related configuration, of all the carriers on which the first communication apparatus 10 can receive the SMS message and the paging message.

In some implementations, the paging-related configuration may include a carrier group paging control channel configuration and a carrier group paging search space configuration.

The carrier group paging control channel configuration may include a configuration that is of M carriers for paging reception in the carrier group and that is used for determining a PF and a PO, for example, include information such as a quantity of PFs included in one DRX cycle, a quantity of POs corresponding to one PF, and a 1^{st} PDCCH MO of the PO. Optionally, the DRX cycle may further be included. For example, the carrier group paging control channel configuration may indicate a PCCH-config of the carrier group.

An example PCCH-config of the carrier group is as follows:

| | |
|---|---|
| PCCH-Config ::= | SEQUENCE { |

| | |
|---|---|
| defaultPagingCycle | PagingCycle, |
| nAndPagingFrameOffset | CHOICE { |
| oneT | NULL, |
| halfT | INTEGER (0..1), |
| quarterT | INTEGER (0..3), |
| oneEighthT | INTEGER (0..7), |
| oneSixteenthT | INTEGER (0..15) |

},

| | |
|---|---|
| ns | ENUMERATED {four, two, one}, |
| firstPDCCH-MonitoringOccasionOfPO | CHOICE { |

```
    sCS15KHZoneT
SEQUENCE (SIZE (1..maxPO-perPF)) OF INTEGER (0..139),
    sCS30KHZoneT-SCS15KHZhalfT
SEQUENCE (SIZE (1..maxPO-perPF)) OF INTEGER (0..279),
    sCS60KHZoneT-SCS30KHZhalfT-SCS15KHZquarterT
SEQUENCE (SIZE (1..maxPO-perPF)) OF INTEGER (0..559),
    sCS120KHZoneT-SCS60KHZhalfT-SCS30KHZquarterT-
SCS15KHZoneEighthT SEQUENCE (SIZE (1..maxPO-perPF)) OF INTEGER (0..1119),
    sCS120KHZhalfT-SCS60KHZquarterT-SCS30KHZoneEighthT-
SCS15KHZoneSixteenthT SEQUENCE (SIZE (1..maxPO-perPF)) OF INTEGER (0..2239),
    sCS480KHZoneT-SCS120KHZquarterT-SCS60KHZoneEighthT-
SCS30KHZoneSixteenthT SEQUENCE (SIZE (1..maxPO-perPF)) OF INTEGER (0..4479),
    sCS480KHZhalfT-SCS120KHZoneEighthT-SCS60KHZoneSixteenthT
SEQUENCE (SIZE (1..maxPO-perPF)) OF INTEGER (0..8959),
    sCS480KHZquarterT-SCS120KHZoneSixteenthT
SEQUENCE (SIZE (1..maxPO-perPF)) OF INTEGER (0..17919)
```

| | | |
|---|---|---|
| } | OPTIONAL, | -- Need R |

```
  ...,
  [[
```

| | |
|---|---|
| nrofPDCCH-MonitoringOccasionPerSSB-InPO -r16 | INTEGER (2..4) |

```
OPTIONAL -- Cond SharedSpectrum2
  ]],
  [[
```

| | |
|---|---|
| ranPagingInIdlePO -r17 | ENUMERATED {true} |

OPTIONAL, -- Need R
firstPDCCH-MonitoringOccasionOfPO-v1710 CHOICE {

| | |
|---|---|
| sCS480KHZoneEighthT | SEQUENCE (SIZE (1..maxPO-perPF)) |

OF INTEGER (0..35839),

| | |
|---|---|
| sCS480KHZoneSixteenthT | SEQUENCE (SIZE (1..maxPO-perPF)) OF |

```
INTEGER (0..71679)
  }
OPTIONAL -- Need R
    ]]
  }
```

In this example, defaultPagingCycle represents a default paging cycle; nAndPagingFrameOffset is used to determine a paging frame offset (PF_offset) and a quantity of paging frames (PFs) in the paging cycle; ns represents a quantity of paging occasions (PO) in each paging frame (PF); firstPDCCH-MonitoringOccasionOfPO represents a 1^{st} PDCCH monitoring opportunity of each paging occasion (PO) in each paging frame (PF); nrofPDCCH-MonitoringOccasionPerSSB-InPO represents a quantity of PDCCH-Os corresponding to each SSB on each paging occasion (PO); and ranPagingInIdlePO represents that a network supports sending of RAN paging on a PO corresponding to is determined by the first communication apparatus 10 in an idle state, where i_s is determined based on a UE_ID and the ns, and the UE_ID is an identification of the terminal device.

M is an integer greater than 1 and less than or equal to a total quantity of all the carriers for paging reception in the carrier group.

In a possible implementation, the carrier group paging control channel configuration may further indicate some carriers or all the carriers that are in the carrier group and to which the carrier group paging control channel configuration is applicable. Therefore, the first communication apparatus 10 can quickly select, from the carrier group based on the carrier group paging control channel configuration, the carrier for paging reception.

The carrier group paging search space configuration, namely, a configuration of a search space of a PDCCH, for paging reception, of the carrier group, may indicate a specific search space or search spaces in which the first communication apparatus 10 searches for the PDCCH, for paging reception, of the carrier group. The carrier group paging search space configuration may include a configuration of search spaces of PDCCHs, for paging reception, of N carriers for paging reception in the carrier group, for example, include one or more of the following information: a time domain periodicity and an offset of the search space, a quantity of slots in which the search space is continuously monitored in each period, a start symbol for monitoring in each slot, a quantity of PDCCH candidates indicated by the search space, a type of the search space, a type of DCI on which blind monitoring needs to be performed, an identification of a control-resource set (CORESET) corresponding to the search space, a quantity of symbols, a frequency domain resource, an interleaving manner, and a mapping type of a resource element group REG. N is an integer greater than 1 and less than or equal to the total quantity of all the carriers for paging reception in the carrier group. In addition, values of M and N may be the same or different.

In a possible implementation, the carrier group paging search space configuration may further indicate that a carrier group paging search space is configured as a search space of a PDCCH, for paging reception, of some specific carriers or all the carriers in the carrier group.

In a possible implementation, the M carriers indicated by the carrier group paging control channel configuration and the N carriers indicated by the carrier group paging search space configuration are partially the same or completely the same. Herein, there are a plurality of carriers that are partially the same. In other words, a quantity of carriers in an intersection set of the M carriers and the N carriers is greater than 1. The foregoing same carriers are all carriers on which the first communication apparatus 10 can receive an SMS message and a paging message. Therefore, the carrier group paging control channel configuration and/or the carrier group paging search space configuration may indicate all the carriers on which the first communication apparatus 10 can receive an SMS message and a paging message.

Based on this, in a feasible implementation of S103, the first communication apparatus 10 may receive an SMS message or a paging message on one or more same carriers in the M carriers and the N carriers based on the carrier group paging control channel configuration and the carrier group paging search space configuration.

In other words, the second communication apparatus 20 may send an SMS message or a paging message on the plurality of carriers in the intersection set of the M carriers and the N carriers. Correspondingly, the first communication apparatus 10 may receive the SMS message or the paging message on the one or more carriers that are used for sending the SMS message or the paging message and that are in the intersection set of the M carriers and the N carriers.

Before the first communication apparatus 10 receives the SMS message or the paging message, in addition to learning of all the carriers on which the first communication apparatus 10 can receive the SMS message and the paging message, the first communication apparatus 10 further needs to learn of an association relationship between a transmit beam for receiving the SMS message or the paging message on the one or more carriers in the carrier group and a transmit beam for an SSB.

For the one or more carriers for paging reception in the carrier group, the association relationship may indicate information such as a quantity of paging slots of each carrier on each PO, an SSB that is associated and in quasi-co-location with a PDSCH of a paging slot of each carrier on each PO (in other words, a transmit beam for an SMS message or a paging message in a paging slot of each carrier on each PO is a transmit beam for a specific SSB or SSBs), a quantity of transmit beams for the SMS message or the paging message on all the carriers for paging reception, and directions of the transmit beams for the SMS message or the paging message on all the carriers for paging reception.

It should be understood that all the carriers for paging reception are all the carriers in the intersection set of the M carriers and the N carriers.

The quantity of transmit beams for the SMS message or the paging message on all the carriers for paging reception and the directions of the transmit beams for the SMS message or the paging message on all the carriers for paging reception are generally known before the first communication apparatus 10 receives the SMS message or the paging message. In some implementations, the first communication apparatus 10 may determine a quantity of paging slots and beam information of the paging slot that are of each of the one or more carriers in the carrier group on each PO based on the paging-related configuration. The quantity of paging slots of each carrier on each PO may indicate a quantity of consecutive PDCCH MOs of each carrier on each PO. The beam information of the paging slot of each carrier on each PO may indicate a specific SSB or SSBs that are associated and in quasi-co-location with a PDSCH of the paging slot of each carrier on each PO. Therefore, the first communication apparatus 10 may receive the paging-related message in the paging slot of the one or more carriers in the carrier group on each PO based on the quantity of paging slots and the beam information of the paging slot that are of each of the one or more carriers in the carrier group on each PO.

In addition, the association relationship between the transmit beam for the SMS message or the paging message on each carrier in the carrier group and the transmit beam for the SSB may be represented by using a quantity of paging slots and beam information of the paging slot that are of each carrier for paging reception in the carrier group on each PO.

In a feasible implementation, the quantity of paging slots and the beam information of the paging slot that are of each carrier for paging reception in the carrier group on each PO may be predefined in a protocol.

In this way, the first communication apparatus 10 may determine the quantity of paging slots and the beam information of the paging slot that are of each of the one or more carriers in the carrier group on each PO based on the paging-related configuration, and the quantity of paging slots and the beam information of the paging slot that are of each carrier for paging reception in the carrier group on each PO and that are predefined in the protocol.

In another feasible implementation, the quantity of paging slots and the beam information of the paging slot that are of each carrier for paging reception in the carrier group on each PO may be indicated by the second communication apparatus 20. For example, the paging-related configuration may further include association indication information, and the association indication information is used to determine the quantity of paging slots and the beam information of the paging slot that are of each carrier for paging reception in the carrier group on each PO. For example, the carrier group paging search space configuration may include the association indication information. Therefore, the first communication apparatus 10 may determine the quantity of paging slots and the beam information of the paging slot that are of each of the one or more carriers in the carrier group on each PO based on the association indication information.

In conclusion, the association relationship between the transmit beam for the SMS message or the paging message on each carrier in the carrier group and the transmit beam for the SSB, to be specific, the quantity of paging slots and the beam information of the paging slot that are of each carrier for paging reception in the carrier group on each PO, may be obtained by using a formula predefined in the protocol, or may be obtained by using the configured association indication information.

Simply speaking, the quantity of paging slots and the beam information of the paging slot that are of each carrier for paging reception in the carrier group on each PO and that are predefined in the protocol or indicated by the second communication apparatus 20 are referred to as a set 1 for short. The quantity of paging slots and the beam information of the paging slot that are of each of the one or more carriers for paging reception in the carrier group on each PO and that are obtained by the first communication apparatus 10 are referred to as a set 2 for short. In this way, the set 1 includes the set 2, and the set 2 is a subset or a universal set of the set 1.

Based on the foregoing descriptions, the quantity of paging slots and the beam information of the paging slot that are of each carrier for paging reception in the carrier group on each PO may be implemented in a plurality of ways.

In some implementations, the quantity of paging slots and the beam information of the paging slot that are of each carrier for paging reception in the carrier group on each PO indicate any one of the following solutions:

Solution 1: Based on a sending sequence of the SSBs in the synchronization broadcast resource block set and an association method of the time domain first and then the frequency domain, a PDSCH of the paging slot of each carrier on each PO is separately associated with and in quasi-co-location with one or more SSBs, and a quantity of the plurality of SSBs is less than S mentioned above.

It can be learned that in the solution 1, the plurality of SSBs are sequentially allocated to the plurality of carriers in the time-domain-first manner, and the quantity of the plurality of SSBs is equal to S mentioned above.

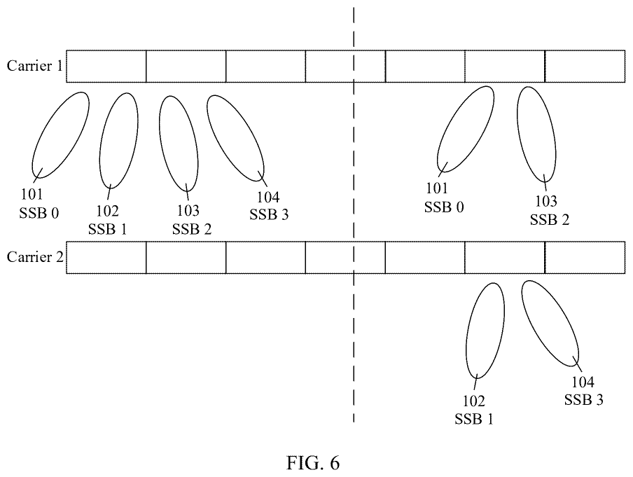

For ease of description, refer to the explanations of the paging slot or the PEI monitoring slot and the SSB in FIG. 5. In FIG. 6 to FIG. 11, one grid is one slot, the slot may be a paging slot or a PEI monitoring slot, and two SSBs may be sent in one slot. In addition, FIG. 6 is merely an example. One grid may alternatively be one non-slot, and one or two SSBs may be sent in each non-slot. In addition, in FIG. 6 to FIG. 11, an NR solution is shown on a left side of a dashed line. The solution of this application is shown on a right side of the dashed line. Correspondingly, the related technology is described by using NR as an example.

As shown in FIG. 5, the carrier group includes the two carriers (the carrier 1 and the carrier 2), and there are the four transmit beams with the different directions for the SSBs. The transmit beam 101 to the transmit beam 104 are sequentially used to send the SSB 0 to the SSB 3.

In NR, transmit beams for the SSBs (the SSB 0 to the SSB 3) that are associated and in quasi-co-location with the carrier 1 are a 1^{st} transmit beam, a 2^{nd} transmit beam, a 3^{rd} transmit beam, and a 4^{th} transmit beam, namely, the transmit beams 101 to 104.

In this application, on each PO, in the time-domain-first manner, transmit beams for SSBs (the SSB 0 and the SSB 1) that are associated and in quasi-co-location with the carrier 1 are a 1^{st} transmit beam and a 2^{nd} transmit beam, namely, transmit beams 101 and 102. Transmit beams for SSBs (the SSB 2 and the SSB 3) that are associated and in quasi-co-location with the carrier 2 are a 3^{rd} transmit beam and a 4^{th} transmit beam, namely, transmit beams 103 and 104. A sending time of a paging slot of the carrier 1 is the same, or nearly the same, as a sending time of a paging slot of the carrier 2.

Clearly, on each PO, sending the four SSBs occupies two grids of the carrier 1 in the related technology, and sending the four SSBs separately occupies one grid of the carrier 1 and one grid of the carrier 2 in this application. Based on cooperative work of the carrier 1 and the carrier 2, a sending duration of the second communication apparatus 20 in the time domain in this application is shorter than a sending duration of the second communication apparatus 20 in the time domain in the related technology.

Solution 2: Based on a sending sequence of the SSBs in the synchronization broadcast resource block set and an association method of the frequency domain first and then the time domain, a PDSCH of the paging slot of each carrier on each PO is separately associated and in quasi-co-location with one or more SSBs, and a quantity of the plurality of SSBs is less than S mentioned above.

In the solution 2, the plurality of SSBs are sequentially allocated to the plurality of carriers in the frequency-domain-first manner, and the quantity of the plurality of SSBs is equal to S mentioned above.

As shown in FIG. 6, a carrier group includes two carriers (a carrier 1 and a carrier 2), and there are four transmit beams with different directions for SSBs. A transmit beam 101 to a transmit beam 104 are sequentially used to send an SSB 0 to an SSB 3.

In NR, transmit beams for the SSBs (the SSB 0 to the SSB 3) that are associated and in quasi-co-location with the carrier 1 are a 1^{st} transmit beam, a 2^{nd} transmit beam, a 3^{rd} transmit beam, and a 4^{th} transmit beam, namely, the transmit beams 101 to 104.

In this application, in the frequency-domain-first manner, transmit beams for SSBs (the SSB 0 and the SSB 2) that are associated and in quasi-co-location with the carrier 1 are the 1st transmit beam and the 3^{rd} transmit beam, namely, transmit beams 101 and 103. Transmit beams for SSBs (the SSB 1 and the SSB 3) that are associated and in quasi-co-location with the carrier 2 are the 2^{nd} transmit beam and the 4^{th} transmit beam, namely, transmit beams 102 and 104.

A sending time of a paging slot of the carrier 1 is the same, or nearly the same, as a sending time of a paging slot of the carrier 2.

Clearly, on each PO, sending the four SSBs occupies two grids of the carrier 1 in the related technology, and sending the four SSBs separately occupies one grid of the carrier 1 and one grid of the carrier 2 in this application. Based on cooperative work of the carrier 1 and the carrier 2, the carrier 1 and the carrier 2 cooperate with each other, and a sending duration of the second communication apparatus 20 in the time domain in this application is shorter than a sending duration of the second communication apparatus 20 in the time domain in the related technology.

In conclusion, the solution 1 and the solution 2 are applicable to various scenarios, and in particular, are applicable to a scenario in which subcarrier spacings of all the carriers for paging reception in the carrier group are the same. This can ensure that the paging slots of each carrier for paging reception in the carrier group on each PO are evenly allocated, so that the sending duration of the second communication apparatus 20 in the time domain is reduced, and the energy consumption of the second communication apparatus 20 is reduced.

Solution 3: The quantity of paging slots and the beam information of the paging slot that are of each carrier for paging reception in the carrier group on each PO include an SSB sequence number range of each carrier.

The SSB sequence number range of each carrier is a sequence number of an SSB that is associated and in quasi-co-location with a PDSCH of one or more paging slots of each carrier on each PO and that is in a sending sequence of the SSBs in the synchronization broadcast resource block set.

In the solution 3, a plurality of SSBs are allocated to the plurality of carriers in a manner of indicating a sequence number of an SSB in the plurality of SSBs, and a quantity of the plurality of SSBs is equal to S mentioned above.

In some implementations, an SSB sequence number range of an i^{th} carrier in the carrier group is greater than or equal to 1+(i−1)*ceil(S/m) and less than or equal to i*ceil(S/m).

Here, i is an integer greater than or equal to 1 and less than or equal to the total quantity of all the carriers for paging reception in the carrier group, S is the foregoing mentioned S, ceil represents rounding up, and m represents a quantity of SSBs sent in each paging slot.

When S=4 and m=2, based on the foregoing expression, SSBs that are associated and in quasi-co-location with the carrier 1 are a 1^{st} SSB and a 2^{nd} SSB, and SSBs that are associated and in quasi-co-location with the carrier 2 are a 3^{rd} SSB and a 4^{th} SSB. In other words, transmit beams for the SSBs that are associated and in quasi-co-location with the carrier 1 are a 1^{st} transmit beam and a 2^{nd} transmit beam. Transmit beams for the SSBs that are associated and in quasi-co-location with the carrier 2 are a 3^{rd} transmit beam and a 4^{th} transmit beam, as shown in FIG. 5.

Solution 4: The quantity of paging slots and the beam information of the paging slot that are of each carrier for paging reception in the carrier group on each PO include an SSB index set of each carrier.

The SSB index set of each carrier is an index of an SSB that is associated and in quasi-co-location with a PDSCH of one or more paging slots of each carrier on each PO.

In some implementations, the SSB index set of each carrier may be included in the carrier group paging search space configuration.

In the solution 4, a plurality of SSBs are allocated to the plurality of carriers in an SSB index indication manner.

An example configuration is as follows:

| | |
|---|---|
| PDCCH-ConfigCommon ::= | SEQUENCE { |
| controlResourceSetZero | ControlResourceSetZero |

commonControlResourceSet
SEQUENCE(SIZE(1..maxNoOfCarrierWithinGroup)) OF ControlResourceSet

| | |
|---|---|
| searchSpaceZero | SearchSpaceZero |
| commonSearchSpaceList | SEQUENCE (SIZE(1..4)) OF |

SearchSpace

| | |
|---|---|
| pagingSearchSpace | SEQUENCE (SIZE(1..maxNoOfCarrierWithinGroup)) |

OF SearchSpaceID

In this example, controlResourceSetZero represents a control-resource set 0, commonControlResourceSet represents a common control-resource set, searchSpaceZero represents a search space 0, commonSearchSpaceList represents a common search space list, and pagingSearchSpace represents a paging search space. For multi-carrier coordinated paging reception in the carrier group, a paging search space and a common control-resource set on each carrier need to be configured.

Configurations that are of the paging search space and the common control-resource set on each carrier in the carrier group and that are represented by pagingSearchSpace are as follows:

| | |
|---|---|
| SearchSpace ::= | SEQUENCE { |
| searchSpaceId | SearchSpaceId, |
| controlResourceSetId | ControlResourceSetId |
| beamForPaging | SEQUENCE (SIZE(1..MaxNoOfSSB- |

Index)) OF SSB-Index

In this example, searchSpaceId represents a search space identification, controlResourceSetId represents a control-resource set identification, and beamForPaging represents an index of an SSB that is in same QCL with paging on each carrier, namely, a paging beam on each carrier.

In conclusion, the solution 3 and the solution 4 are applicable to various scenarios, and clearly indicate the quantity of paging slots and the beam information of the paging slot that are of each carrier for paging reception in the carrier group on each PO.

In addition, in the solution 3 and the solution 4, the indicated quantity of paging slots of each carrier for paging reception in the carrier group on each PO may be evenly allocated, to ensure that sending durations of the paging slots of the carriers for paging reception in the carrier group on each PO are equal or nearly so in the time domain, so that the sending duration of the second communication apparatus 20 in the time domain is reduced, and the energy consumption of the second communication apparatus 20 is reduced.

Solution 5: Based on a sending sequence of the SSBs in the synchronization broadcast resource block set and an association method of the time domain first and then the frequency domain, a ratio of quantities of SSBs that are associated and in quasi-co-location with PDSCHs of the paging slots of the carriers on each PO is the same as a reciprocal of a ratio of slot lengths of the carriers, and a PDSCH of a paging slot of a carrier with a smallest slot length on each PO is associated and in quasi-co-location with a remaining SSB in a plurality of SSBs.

Specifically, in the time-domain-first manner, the plurality of SSBs are allocated to the carriers in an equal proportion based on the reciprocal of the ratio of the slot lengths of the carriers. A quantity of the plurality of SSBs is equal to S mentioned above. After the proportional allocation, if there is a remaining SSB, the remaining SSB is preferentially allocated to a carrier with a smaller slot length. Therefore, it can be ensured that sending durations of the paging slots of the carriers on each PO are equal or nearly so in the time domain.

In the solution 5, the plurality of SSBs are allocated to the plurality of carriers in a manner of time domain first and a smaller slot length first, and the quantity of the plurality of SSBs is equal to S mentioned above.

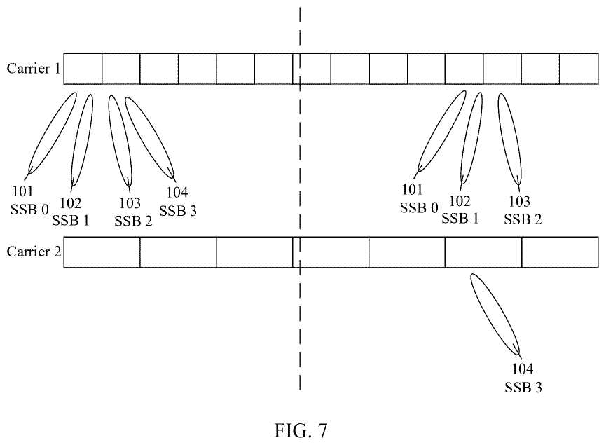

As shown in FIG. 7, a carrier group includes two carriers (a carrier 1 and a carrier 2), and there are four transmit beams with different directions for SSBs. A transmit beam 101 to a transmit beam 104 are sequentially used to send an SSB 0 to an SSB 3.

In NR, transmit beams for the SSBs (the SSB 0 to the SSB 3) that are associated and in quasi-co-location with the carrier 1 are a 1^{st} transmit beam, a 2^{nd} transmit beam, a 3^{rd} transmit beam, and a 4^{th} transmit beam, namely, the transmit beams 101 to 104.

In this application, a slot length of the carrier 1 is ½ of a slot length of the carrier 2. In this case, SSBs that are associated and in quasi-co-location with the carrier 1 is twice an SSB that is associated and in quasi-co-location with the carrier 2, in other words, two SSBs are associated and in quasi-co-location with the carrier 1, and one SSB is associated and in quasi-co-location with the carrier 2. There are four SSBs, and the slot length of the carrier 1 is smaller. Therefore, one remaining SSB is allocated to the carrier 1. It can be learned that three SSBs are associated and in quasi-co-location with the carrier 1, and one SSB is associated and in quasi-co-location with the carrier 2.

In the time-domain-first manner, transmit beams for three SSBs (the SSB 0 to the SSB 2) associated and in quasi-co-location with the carrier 1 are a 1^{st} transmit beam, a 2^{nd} transmit beam, and a 3^{rd} transmit beam, namely, transmit beams 101 to 103; and a transmit beam for one SSB (the SSB 3) that is associated and in quasi-co-location with the carrier 2 is a 4^{th} transmit beam, namely, the transmit beam 104. A sending time of a paging slot of the carrier 1 is the same, or nearly the same, as a sending time of a paging slot of the carrier 2.

Clearly, on each PO, sending the four SSBs occupies two grids of the carrier 1 in the related technology, and sending the four SSBs separately occupies two grids of the carrier 1 and one grid of the carrier 2 in this application. Based on cooperative work of the carrier 1 and the carrier 2, a sending duration of the second communication apparatus 20 in the time domain in this application is equal to a sending duration of the second communication apparatus 20 in the time domain in the related technology.

It should be understood that the foregoing is merely an example. In an actual application process, when there are a large quantity of SSBs, the solution 5 is used. The sending duration of the second communication apparatus 20 in the time domain is greater than the sending duration of the second communication apparatus 20 in the time domain in the related technology.

Solution 6: Based on a sending sequence of the SSBs in the synchronization broadcast resource block set and an association method of the frequency domain first and then the time domain, a ratio of quantities of SSBs that are associated and in quasi-co-location with PDSCHs of the paging slots of the carriers on each PO is the same as a reciprocal of a ratio of slot lengths of the carriers, and a PDSCH of a paging slot of a carrier with a smallest slot length on each PO is associated and in quasi-co-location with a remaining SSB.

Specifically, in the frequency-domain-first manner, a plurality of SSBs are allocated to the carriers in an equal proportion based on the reciprocal of the ratio of the slot lengths of the carriers. If there is a remaining SSB, the remaining SSB is preferentially allocated to a carrier with a smaller slot length. Therefore, it can be ensured that sending durations of the paging slots of the carriers on each PO are equal or nearly so in the time domain.

In the solution 6, the plurality of SSBs are allocated to the plurality of carriers in a manner of frequency domain first and a smaller slot length first, and a quantity of the plurality of SSBs is equal to S mentioned above.

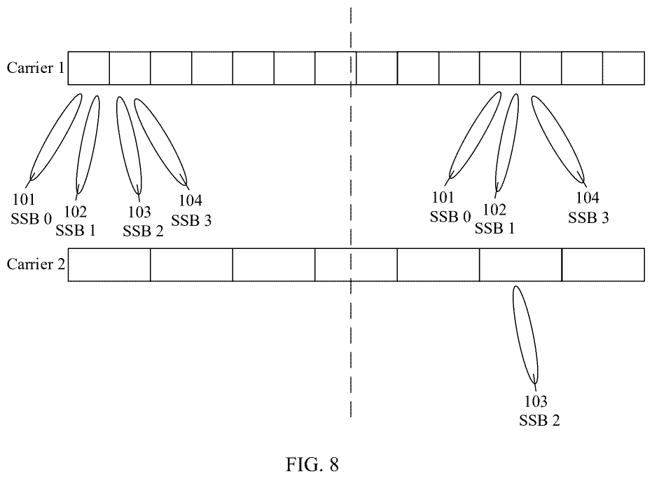

As shown in FIG. 8, a carrier group includes two carriers (a carrier 1 and a carrier 2), and there are four transmit beams with different directions for SSBs. A transmit beam 101 to a transmit beam 104 are sequentially used to send an SSB 0 to an SSB 3.

In NR, transmit beams for the SSBs (the SSB 0 to the SSB 3) that are associated and in quasi-co-location with the carrier 1 are a 1^{st} transmit beam, a 2^{nd} transmit beam, a 3^{rd} transmit beam, and a 4^{th} transmit beam (101 to 104).

In this application, a slot length of the carrier 1 is ½ of a slot length of the carrier 2. In this case, SSBs that are associated and in quasi-co-location with the carrier 1 is twice an SSB that is associated and in quasi-co-location with the carrier 2, in other words, two SSBs are associated and in quasi-co-location with the carrier 1, and one SSB is associated and in quasi-co-location with the carrier 2. There are four SSBs, and the slot length of the carrier 1 is smaller. Therefore, one remaining SSB is allocated to the carrier 1. It can be learned that three SSBs are associated and in quasi-co-location with the carrier 1, and one SSB is associated and in quasi-co-location with the carrier 2.

In the frequency-domain-first manner, transmit beams for three SSBs (the SSB 0, the SSB 1, and the SSB 3) associated and in quasi-co-location with the carrier 1 are a 1^{st} transmit beam, a 2^{nd} transmit beam, and a 4^{th} transmit beam (101, 102, and 104); and a transmit beam for one SSB (the SSB 2) that is associated and in quasi-co-location with the carrier 2 is a 3^{rd} transmit beam (103). A sending time of a paging slot of the carrier 1 is the same, or nearly the same, as a sending time of a paging slot of the carrier 2.

Clearly, on each PO, sending the four SSBs occupies two grids of the carrier 1 in the related technology, and sending the four SSBs separately occupies two grids of the carrier 1 and one grid of the carrier 2 in this application. Based on cooperative work of the carrier 1 and the carrier 2, a sending duration of the second communication apparatus 20 in the time domain in this application is shorter than a sending duration of the second communication apparatus 20 in the time domain in the related technology.

It should be understood that the foregoing is merely an example. In an actual application process, when there are a large quantity of SSBs, the solution 6 is used. The sending duration of the second communication apparatus 20 in the time domain is greater than the sending duration of the second communication apparatus 20 in the time domain in the related technology.

Solution 7: Based on a sending sequence of the SSBs in the synchronization broadcast resource block set and an association method of the time domain first and then the frequency domain, a ratio of quantities of SSBs that are associated and in quasi-co-location with PDSCHs of the paging slots of the carriers on each PO is the same as a reciprocal of a ratio of slot lengths of the carriers, and a PDSCH of a paging slot of a carrier with a small sequence number on each PO is associated and in quasi-co-location with a remaining SSB.

Specifically, in the time-domain-first manner, a plurality of SSBs are allocated to the carriers in an equal proportion based on the reciprocal of the ratio of the slot lengths of the carriers. A quantity of the plurality of SSBs is equal to S mentioned above. After the proportional allocation, if there is a remaining SSB, the remaining SSB is preferentially allocated to a carrier with a smaller sequence number.

In the solution 7, the plurality of SSBs are allocated to the plurality of carriers in a manner of time domain first and a smaller slot length first and a smaller sequence number first, and a quantity of the plurality of SSBs is equal to S mentioned above.

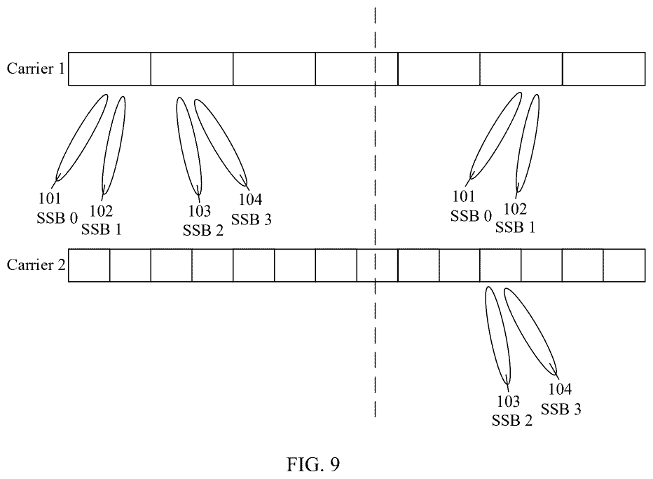

As shown in FIG. 9, a carrier group includes two carriers (a carrier 1 and a carrier 2), and there are four transmit beams with different directions for SSBs. A transmit beam 101 to a transmit beam 104 are sequentially used to send an SSB 0 to an SSB 3.

In NR, transmit beams for the SSBs (the SSB 0 to the SSB 3) that are associated and in quasi-co-location with the carrier 1 are a 1^{st} transmit beam, a 2^{nd} transmit beam, a 3^{rd} transmit beam, and a 4^{th} transmit beam (101 to 104).

In this application, a slot length of the carrier 1 is twice a slot length of the carrier 2. In this case, an SSB that is associated and in quasi-co-location with the carrier 1 is ½ of SSBs that are associated and in quasi-co-location with the carrier 2, in other words, one SSB is associated and in quasi-co-location with the carrier 1, and two SSBs are associated and in quasi-co-location with the carrier 2. The carrier 1 is a carrier with a smaller sequence number. Therefore, one remaining SSB is allocated to the carrier 1. It can be learned that two SSBs are associated and in quasi-co-location with the carrier 1, and two SSBs are associated and in quasi-co-location with the carrier 2.

In the time-domain-first manner, transmit beams for two SSBs (the SSB 0 and the SSB 1) that are associated and in quasi-co-location with the carrier 1 are a 1^{st} transmit beam and a 2^{nd} transmit beam (101 and 102), and transmit beams for two SSBs (the SSB 2 and the SSB 3) that are associated and in quasi-co-location with the carrier 2 are a 3^{rd} transmit beam and a 4^{th} transmit beam (103 and 104).

A sending time of a paging slot of the carrier 1 is the same, or nearly the same, as a sending time of a paging slot of the carrier 2.

Clearly, on each PO, sending the four SSBs occupies two grids of the carrier 1 in the related technology, and sending the four SSBs separately occupies one grid of the carrier 1 and one grid of the carrier 2 in this application. Based on cooperative work of the carrier 1 and the carrier 2, a sending duration of the second communication apparatus 20 in the time domain in this application is shorter than a sending duration of the second communication apparatus 20 in the time domain in the related technology.

Solution 8: Based on a sending sequence of the SSBs in the synchronization broadcast resource block set and an association method of the frequency domain first and then the time domain, a ratio of quantities of SSBs that are associated and in quasi-co-location with PDSCHs of the paging slots of the carriers on each PO is the same as a reciprocal of a ratio of slot lengths of the carriers, and a PDSCH of a paging slot of a carrier with a small sequence number on each PO is associated and in quasi-co-location with a remaining SSB.

Specifically, in the frequency-domain-first manner, a plurality of SSBs are allocated to the carriers in an equal proportion based on the reciprocal of the ratio of the slot lengths of the carriers. If there is a remaining SSB, the remaining SSB is preferentially allocated to a carrier with a smaller sequence number.

In the solution 8, the plurality of SSBs are allocated to the plurality of carriers in a manner of frequency domain first and a smaller slot length first and a smaller sequence number first.

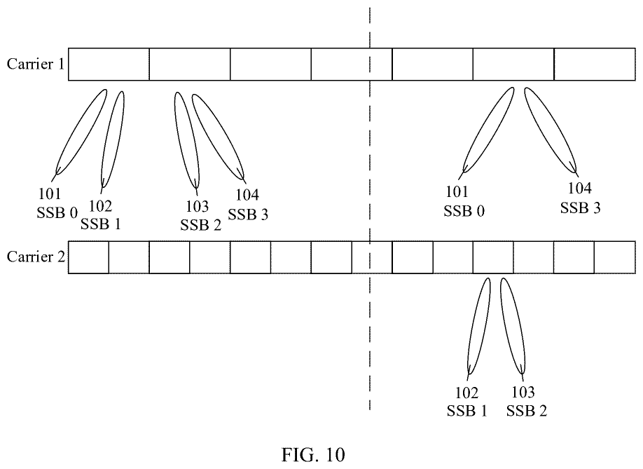

As shown in FIG. 10, a carrier group includes two carriers (a carrier 1 and a carrier 2), and there are four transmit beams with different directions for SSBs. A transmit beam 101 to a transmit beam 104 are sequentially used to send an SSB 0 to an SSB 3.

In NR, transmit beams for the SSBs (the SSB 0 to the SSB 3) that are associated and in quasi-co-location with the carrier 1 are a 1^{st} transmit beam, a 2^{nd} transmit beam, a 3^{rd} transmit beam, and a 4^{th} transmit beam (101 to 104).

In this application, a slot length of the carrier 1 is twice a slot length of the carrier 2. In this case, an SSB that is associated and in quasi-co-location with the carrier 1 is ½ of SSBs that are associated and in quasi-co-location with the carrier 2, in other words, one SSB is associated and in quasi-co-location with the carrier 1, and two SSBs are associated and in quasi-co-location with the carrier 2. The carrier 1 is a carrier with a smaller sequence number. Therefore, one remaining SSB is allocated to the carrier 1. It can be learned that two SSBs are associated and in quasi-co-location with the carrier 1, and two SSBs are associated and in quasi-co-location with the carrier 2.

In the frequency-domain-first manner, transmit beams for two SSBs (the SSB 0 and the SSB 3) that are associated and in quasi-co-location with the carrier 1 are a 1^{st} transmit beam and a 4^{th} transmit beam (101 and 104), and transmit beams for two SSBs (the SSB 1 and the SSB 2) that are associated and in quasi-co-location with the carrier 2 are a 2^{nd} transmit beam and a 3^{rd} transmit beam (102 and 103). A sending time of a paging slot of the carrier 1 is the same, or nearly the same, as a sending time of a paging slot of the carrier 2.

Clearly, sending the four SSBs occupies two grids of the carrier 1 in the related technology, and sending the four SSBs separately occupies one grid of the carrier 1 and one grid of the carrier 2 in this application. Based on cooperative work of the carrier 1 and the carrier 2, a sending duration of the second communication apparatus 20 in the time domain in this application is shorter than a sending duration of the second communication apparatus 20 in the time domain in the related technology.

In the solution 7 and the solution 8, a remaining SSB may be allocated to a carrier with a smaller sequence number or a predefined carrier. This is not limited in this application.

In the solution 5, the solution 6, the solution 7, and the solution 8, the impact of different subcarrier spacings of the plurality of carriers for paging reception in the carrier group on the sending duration of the second communication apparatus 20 in the time domain is considered. There is a reciprocal relationship between a subcarrier spacing and a symbol duration, in other words, a smaller subcarrier spacing indicates a longer symbol duration and a longer corresponding slot duration. It is assumed that quantities of symbols in all paging slots or all PEI monitoring slots are the same. For example, the subcarrier spacing is 15 kHz, and a slot duration corresponding to 15 kHz is X. In this case, a slot duration corresponding to 30 kHz is X/2, a slot duration corresponding to 60 kHz is X/4, and a slot duration corresponding to 120 kHz is X/8.

Based on this, in the solution 5, the solution 6, the solution 7, and the solution 8, it can be ensured that the paging slots of the plurality of carriers in the carrier group are evenly allocated on each PO, and a phenomenon that a paging slot of a carrier with a smaller subcarrier spacing on each PO is longer and a paging slot of a carrier with a smaller subcarrier spacing on each PO is shorter does not occur. In this way, the sending duration of the second communication apparatus 20 in the time domain is not extremely long, and the energy consumption of the second communication apparatus 20 can be reduced.

In conclusion, the solution 5, the solution 6, the solution 7, and the solution 8 are applicable to various scenarios, and are particularly applicable to a scenario in which the carriers for paging reception in the carrier group have different subcarrier spacings.

It should be understood that, in addition to the foregoing solutions, this application may further include another solution.

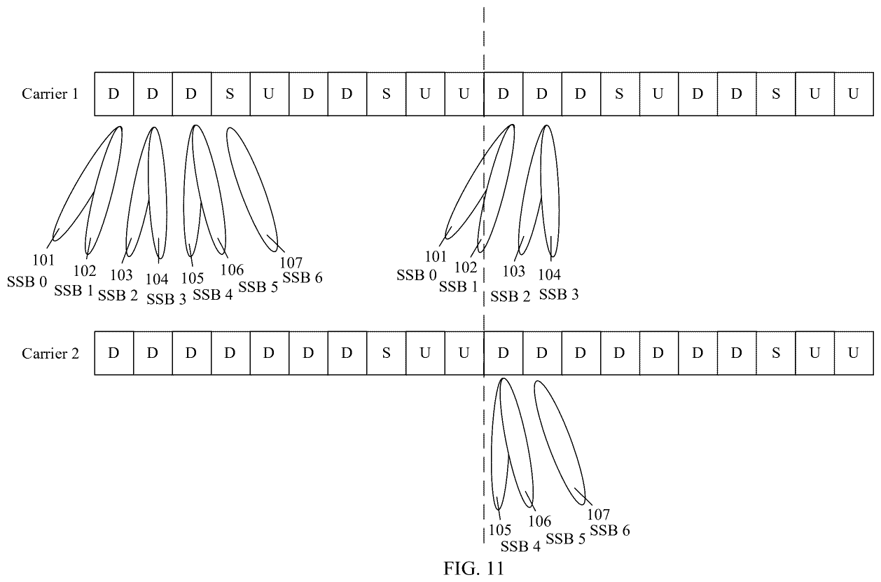

For example, for scenarios in which TDD configurations are different, as shown in FIG. 11, a carrier group includes two carriers (a carrier 1 and a carrier 2), and there are seven transmit beams with different directions for SSBs. A transmit beam 101 to a transmit beam 107 are sequentially used to send an SSB 0 to an SSB 6.

A TDD configuration of the carrier 1 is 7:3, namely, DDDSUDDSUU. A TDD configuration of the carrier 2 is 8:2, namely, DDDDDDDSUU.

Here, D represents a downlink slot, U represents an uplink slot, and S represents a hybrid slot. Specifically, S may include a downlink symbol, an uplink symbol, and some gap symbols, where the GAP symbol is used for uplink-downlink conversion.

If subcarrier spacings of the carrier 1 and the carrier 2 are the same, there are four SSBs that are associated and in quasi-co-location with “DDDS” in “DDDSUDDSUU” of the carrier 1, where “S” in “DDDS” represents a downlink symbol in “S”; and there are three SSBs that are associated and in quasi-co-location with “DDD” in “DDDDDDDSUU” of the carrier 2.

In the related technology, transmit beams for the SSBs (the SSB 0 to the SSB 6) that are associated and in quasi-co-location with the carrier 1 are a 1^{st} transmit beam, a 2^{nd} transmit beam, a 3^{rd} transmit beam, and a 4^{th} transmit beam (101 to 107).

In this application, in a time-domain-first manner, transmit beams for four SSBs (the SSB 0 to the SSB 3) that are associated and in quasi-co-location with the carrier 1 are a 1st transmit beam, a 2^{nd} transmit beam, a 3^{rd} transmit beam, and a 4^{th} transmit beam (101 to 104); and transmit beams for three SSBs (the SSB 4 to the SSB 6) that are associated and in quasi-co-location with the carrier 2 are a 5^{th} transmit beam, a 6^{th} transmit beam, and a 7^{th} transmit beam (105 to 107). A sending time of a paging slot of the carrier 1 is the same, or nearly the same, as a sending time of a paging slot of the carrier 2.

Clearly, on each PO, sending the four SSBs occupies four grids of the carrier 1 in the related technology, and sending the four SSBs respectively occupies two grids of the carrier 1 and two grids of the carrier 2 in this application. Based on cooperative work of the carrier 1 and the carrier 2, a sending duration of the second communication apparatus 20 in the time domain in this application is shorter than a sending duration of the second communication apparatus 20 in the time domain in the related technology.

It should be understood that for the plurality of carriers for paging reception in the carrier group, there may be various scenarios, for example, duplex modes are different, TDD configurations are different and a frequency-domain-first manner is used, subcarrier spacings of carriers having different TDD configurations are different, and subcarrier spacings of a TDD carrier and an FDD carrier are different.

When the paging-related message is a PEI message, for each PEI-O of the PEI message, the second communication apparatus 20 may simultaneously send the PEI message on a plurality of carriers for a PEI in the carrier group, and directions/orientations of transmit beams on the plurality of carriers are different. Correspondingly, the paging-related configuration may indicate configuration information that is of the carrier group and that is for the PEI. In this way, the first communication apparatus 10 can learn, based on the paging-related configuration, of all the carriers on which the first communication apparatus 10 can receive the PEI message.

In some implementations, the paging-related configuration may include a carrier group paging early indication configuration and a carrier group paging early indication search space configuration.

The carrier group paging early indication configuration may include a PEI-related configuration of P carriers for the PEI in the carrier group, for example, include one or more of the following information: a payload size of PEI DCI, an offset of a start frame of a PEI-O reference frame relative to a PF start frame, and a total quantity of subgroups of each PO. P is an integer greater than 1 and less than or equal to a total quantity of all the carriers for the PEI in the carrier group. For example, the carrier group paging early indication configuration may indicate a PEI-config of the carrier group.

In a possible implementation, the carrier group paging early indication configuration may further indicate some carriers or all the carriers for the PEI that are in the carrier group and to which the carrier group paging early indication configuration is applicable. In this way, the first communication apparatus 10 can quickly select, from the carrier group based on the carrier group paging early indication configuration, the carrier for the PEI.

The carrier group paging early indication search space configuration, namely, a configuration of a search space of a PDCCH, for the PEI, of the carrier group, may indicate a specific search space or some search spaces in which the first communication apparatus 10 searches for the PDCCH, for the PEI, in the carrier group. The carrier group paging early indication search space configuration may include a configuration of search spaces of PDCCHs, for the PEI, of Q carriers for the PEI in the carrier group, for example, include one or more of the following information: a time domain periodicity and an offset of the search space, a quantity of slots in which the search space is continuously monitored in each period, a start symbol for monitoring in each slot, a quantity of PDCCH candidates indicated by the search space, a type of the search space, a type of DCI on which blind monitoring needs to be performed, an identification of a control-resource set (CORESET) corresponding to the search space, a quantity of symbols, a frequency domain resource, an interleaving method, and a mapping type of a REG.

Here, Q is an integer greater than 1 and less than or equal to the total quantity of all the carriers for the PEI in the carrier group. In addition, values of P and Q may be the same or different.

In a possible implementation, the carrier group paging early indication search space configuration may further indicate that a carrier group paging early indication search space is configured as a search space of a PDCCH, for the PEI, of some carriers or all the carriers in the carrier group.

In a possible implementation, the P carriers indicated by the carrier group paging early indication configuration and the Q carriers indicated by the carrier group paging early indication search space configuration are partially the same or completely the same. Here, there are a plurality of carriers that are partially the same. In other words, a quantity of carriers in an intersection set of the P carriers and the Q carriers is greater than 1.

The foregoing same carriers are all carriers on which the first communication apparatus 10 can receive the PEI message.

Therefore, the carrier group paging early indication configuration and/or the carrier group paging early indication search space configuration may indicate all of the carriers on which the first communication apparatus 10 can receive the PEI message.

Based on this, in a feasible implementation of S103, the first communication apparatus 10 may receive the PEI message on one or more same carriers in the P carriers and the Q carriers based on the carrier group paging early indication configuration and the carrier group paging early indication search space configuration.

In other words, the second communication apparatus 20 may send the PEI message on the plurality of carriers in the intersection set of the P carriers and the Q carriers. Correspondingly, the first communication apparatus 10 may receive the PEI message on the one or more carriers that are used for sending the PEI message and that are in the intersection set of the P carriers and the Q carriers.

Before the first communication apparatus 10 receives the PEI message, in addition to learning of all the carriers on which the first communication apparatus 10 can receive the PEI message, the first communication apparatus 10 further needs to learn of an association relationship between a transmit beam for receiving the PEI message on the one or more carriers in the carrier group and a transmit beam for an SSB.

For the one or more carriers for the PEI in the carrier group, the association relationship may indicate information such as a quantity of PEI monitoring slots of each carrier on each PEI-O, an SSB that is associated and in quasi-co-location with a PDCCH of a PEI monitoring slot of each carrier on each PEI-O (in other words, a transmit beam for a PEI message in a PEI monitoring slot of each carrier on each PEI-O is a specific SSB or SSBs), a quantity of transmit beams for the PEI message on all the carriers for the PEI, and directions of the transmit beams for the PEI message on all the carriers for the PEI.

It should be understood that all the carriers for the PEI are all the carriers in the intersection set of the P carriers and the Q carriers.

The quantity of transmit beams for the PEI message on all the carriers for the PEI and the directions of the transmit beams for the PEI message on all of the carriers for the PEI are generally known before the first communication apparatus 10 receives the PEI message.

In some implementations, the first communication apparatus 10 may determine a quantity of PEI monitoring slots and beam information of the PEI monitoring slot that are of each of the one or more carriers in the carrier group on each PEI-O based on the paging-related configuration. The quantity of PEI monitoring slots of each carrier on each PEI-O indicates a quantity of consecutive PDCCH MOs of each carrier on each PEI-O. The beam information of the PEI monitoring slot of each carrier on each PEI-O indicates a specific SSB or SSBs that are associated and in quasi-co-location with a PDCCH of the PEI monitoring slot of each carrier on each PEI-O.

Therefore, the first communication apparatus 10 may receive the PEI message in the PEI monitoring slot of the one or more carriers in the carrier group on each PEI-O based on the quantity of PEI monitoring slots and the beam information of the PEI monitoring slot that are of each of the one or more carriers in the carrier group on each PEI-O.

In addition, the association relationship between the transmit beam for the PEI message on each carrier in the carrier group and the transmit beam for the SSB may be represented by using a quantity of PEI monitoring slots and beam information of the PEI monitoring slot that are of each carrier for the PEI in the carrier group on each PEI-O.

In a feasible implementation, the quantity of PEI monitoring slots and the beam information of the PEI monitoring slot that are of each carrier for the PEI in the carrier group on each PEI-O may be predefined in a protocol.

In this way, the first communication apparatus 10 may determine the quantity of PEI monitoring slots and the beam information of the PEI monitoring slot that are of each of the one or more carriers in the carrier group on each PEI-O based on the paging-related configuration, and the quantity of PEI monitoring slots and the beam information of the PEI monitoring slot that are of each carrier for the PEI in the carrier group on each PEI-O and that are predefined in the protocol.

In another feasible implementation, the quantity of PEI monitoring slots and the beam information of the PEI monitoring slot that are of each carrier for the PEI in the carrier group on each PEI-O may be indicated by the second communication apparatus 20.

For example, the paging-related configuration further includes association indication information, and the association indication information is used to determine the quantity of PEI monitoring slots and the beam information of the PEI monitoring slot that are of each carrier for the PEI in the carrier group on each PEI-O. For example, the carrier group paging early indication search space configuration may include the association indication information.

Therefore, the first communication apparatus 10 may determine the quantity of PEI monitoring slots and the beam information of the PEI monitoring slot that are of each of the one or more carriers in the carrier group on each PEI-O based on the association indication information.

In conclusion, the association relationship between the transmit beam for the PEI message on each carrier in the carrier group and the transmit beam for the SSB, to be specific, the quantity of PEI monitoring slots and the beam information of the PEI monitoring slot that are of each carrier for the PEI in the carrier group on each PEI-O may be obtained by using a formula predefined in the protocol, or may be obtained by using the configured association indication information.

Simply speaking, the quantity of PEI monitoring slots and the beam information of the PEI monitoring slot that are of each carrier for the PEI in the carrier group on each PEI-O and that are predefined in the protocol or indicated by the second communication apparatus 20 are referred to as a set 1 for short. The quantity of PEI monitoring slots and the beam information of the PEI monitoring slot that are of each of the one or more carriers for the PEI in the carrier group on each PEI-O and that are obtained by the first communication apparatus 10 are referred to as a set 2 for short. In this way, the set 1 includes the set 2, and the set 2 is a subset or a universal set of the set 1.

Based on the foregoing descriptions, the quantity of PEI monitoring slots and the beam information of the PEI monitoring slot that are of each carrier for the PEI in the carrier group on each PEI-O may be implemented in a plurality of ways.

In some implementations, the quantity of PEI monitoring slots and the beam information of the PEI monitoring slot that are of each carrier for the PEI in the carrier group on each PEI-O indicate any one of the following solutions:

Solution 1: Based on a sending sequence of the SSBs in the synchronization broadcast resource block set and an association method of the time domain first and then the frequency domain, a PDCCH of the PEI monitoring slot of each carrier on each PEI-O is separately associated and in quasi-co-location with one or more SSBs, and a quantity of the plurality of SSBs is less than S mentioned above.

Solution 2: Based on a sending sequence of the SSBs in the synchronization broadcast resource block set and an association method of the frequency domain first and then the time domain, a PDCCH of the PEI monitoring slot of each carrier on each PEI-O is separately associated and in quasi-co-location with one or more SSBs, and a quantity of the plurality of SSBs is less than S mentioned above.

Solution 3: The quantity of PEI monitoring slots and the beam information of the PEI monitoring slot that are of each carrier for the PEI in the carrier group on each PEI-O include an SSB sequence number range of each carrier.

The SSB sequence number range of each carrier is a sequence number of an SSB that is associated and in quasi-co-location with a PDCCH of one or more PEI monitoring slots of each carrier on each PEI-O and that is in a sending sequence of the SSBs in the synchronization broadcast resource block set.

In some implementations, an SSB sequence number range of an i^{th} carrier in the carrier group is greater than or equal to 1+(i−1)*ceil(S/m) and less than or equal to i*ceil(S/m).

Here, i is an integer greater than or equal to 1 and less than or equal to the total quantity of all the carriers for the PEI in the carrier group, S is the foregoing mentioned S, ceil represents rounding up, and m represents a quantity of SSBs sent in each PEI monitoring slot.

Solution 4: The quantity of PEI monitoring slots and the beam information of each carrier for the PEI in the carrier group on each PEI-O are an SSB index set of each carrier. The SSB index set of each carrier is an index of an SSB that is associated and in quasi-co-location with a PDCCH of one or more PEI monitoring slots of each carrier on each PEI-O.

The SSB index set of each carrier may be included in the carrier group paging early indication search space configuration.

Solution 5: Based on a sending sequence of the SSBs in the synchronization broadcast resource block set and an association method of the time domain first and then the frequency domain, a ratio of quantities of SSBs that are associated and in quasi-co-location with PDCCHs of the PEI monitoring slots of the carriers on the PEI-O is the same as a reciprocal of a ratio of slot lengths of the carriers, and a PDCCH of a PEI monitoring slot of a carrier with a smallest slot length on the PEI-O is associated and in quasi-co-location with a remaining SSB.

Solution 6: Based on a sending sequence of the SSBs in the synchronization broadcast resource block set and an association method of the frequency domain first and then the time domain, a ratio of quantities of SSBs that are associated and in quasi-co-location with PDCCHs of the PEI monitoring slots of the carriers on the PEI-O is the same as a reciprocal of a ratio of slot lengths of the carriers, and a PDCCH of a PEI monitoring slot of a carrier with a smallest slot length on the PEI-O is associated and in quasi-co-location with a remaining SSB.

Solution 7: Based on a sending sequence of the SSBs in the synchronization broadcast resource block set and an association method of the time domain first and then the frequency domain, a ratio of quantities of SSBs that are associated and in quasi-co-location with PDCCHs of the PEI monitoring slots of the carriers on the PEI-O is the same as a reciprocal of a ratio of slot lengths of the carriers, and a PDCCH of a PEI monitoring slot of a carrier with a small sequence number on the PEI-O is associated and in quasi-co-location with a remaining SSB.

Solution 8: Based on a sending sequence of the SSBs in the synchronization broadcast resource block set and an association method of the frequency domain first and then the time domain, a ratio of quantities of SSBs that are associated and in quasi-co-location with PDCCHs of the PEI monitoring slots of the carriers on the PEI-O is the same as a reciprocal of a ratio of slot lengths of the carriers, and a PDCCH of a PEI monitoring slot of a carrier with a small sequence number on the PEI-O is associated and in quasi-co-location with a remaining SSB.

The foregoing solutions are similar to the foregoing implementations of the solutions indicated by the quantity of paging slots and the beam information of the paging slot that are of each carrier for paging reception in the carrier group on each PO. Details are not described herein again in this application. In addition to the foregoing solutions, this application may further include another solution.

Based on the descriptions of the foregoing embodiment, in addition to the configuration mentioned above, the paging-related configuration may further include a carrier group configuration. The carrier group configuration may indicate that a carrier group includes a plurality of carriers, in other words, indicate the carriers included in the carrier group. In addition, the carrier group configuration may further indicate a carrier group to which a carrier of a cell on which the first communication apparatus 10 camps belongs.

The second communication apparatus 20 may broadcast, to the first communication apparatus 10 in a plurality of implementations, a system information carrying the carrier group configuration.

In a feasible implementation, the second communication apparatus 20 may send a system information to the first communication apparatus 10 on each carrier in the carrier group, where the system information includes the carrier group configuration, and the carrier group configuration includes an identification of the carrier group to which each carrier belongs. Therefore, the first communication apparatus 10 can determine, based on the identification of the carrier group, specific carriers belonging to the same carrier group. The identification of the carrier group is used to uniquely determine the carrier group. The carrier group may be identified by using an ID, a sequence number, or the like.

For example, for each carrier in the carrier group, the second communication apparatus 20 may include, in the broadcast system information, a sequence number of the carrier group to which each carrier belongs.

In another feasible implementation, the second communication apparatus 20 may send a system information to the first communication apparatus 10 on the one or more carriers in the carrier group, where the system information includes the carrier group configuration, and the carrier group configuration includes related configuration information of each carrier in the carrier group to which the carrier corresponding to the system information belongs. Therefore, notification is performed at a granularity of a carrier group, so that the first communication apparatus 10 may determine, based on the related configuration information of each carrier, specific carriers belonging to the same carrier group. The related configuration information of each carrier may include but is not limited to at least one of a frequency (such as an ARFCN), a bandwidth, or a cell identification (ID).

For example, for a carrier (for example, an anchor carrier) in the carrier group, the system information broadcast by the second communication apparatus 20 may indicate the related configuration information of each carrier in the carrier group.

In another feasible implementation, the second communication apparatus 20 may send a system information set to the first communication apparatus 10 on the one or more carriers in the carrier group, where the system information set includes a system information of each carrier in the carrier group to which a carrier for receiving the system information set belongs. Therefore, notification is performed at a granularity of a carrier group, so that the first communication apparatus 10 may determine, based on all system information received on one carrier, specific carriers belonging to the same carrier group.

For example, for a carrier (for example, an anchor carrier) in a carrier group, the second communication apparatus 20 may broadcast, on the carrier, system information of all carriers in the carrier group. In other words, in addition to a system information of the carrier, a system information of another carrier in the carrier group is further sent on the carrier. Therefore, the first communication apparatus 10 may obtain, by obtaining the system information sent on the carrier, the carriers included in the carrier group.

In another feasible implementation, the second communication apparatus 20 may send a system information to the first communication apparatus 10 on one carrier in the carrier group, where the system information includes a carrier group configuration, and the carrier group configuration includes related configuration information of each carrier in all carrier groups. Therefore, the first communication apparatus 10 may determine, based on the related configuration information of each carrier in all of the carrier groups, specific carriers belonging to a same carrier group.

It should be understood that in addition to the foregoing implementations, this application may further include other implementations.

Based on the descriptions of the foregoing embodiment, the first communication apparatus 10 may support simultaneous reception of a paging-related message on the plurality of carriers in the carrier group, in other words, a paging mode of the first communication apparatus 10 may be a multi-carrier coordinated paging mode. Correspondingly, the multi-carrier coordinated paging mode means that the paging-related message is received on the plurality of carriers in the carrier group in a coordinated manner.

The first communication apparatus 10 may further support reception of the paging-related message on one carrier, in other words, the paging mode of the first communication apparatus 10 may be a single-carrier paging mode. A corresponding single-carrier paging mode means that the paging-related message is received on a single carrier.

For the first communication apparatus 10 that supports the two paging modes, in addition to indicating that the first communication apparatus 10 supports coordinated reception of a paging-related message on a plurality of carriers in a carrier group, a device capability may further indicate one or more of the following: The first communication apparatus 10 supports reception of a paging-related message on a single carrier; the first communication apparatus 10 supports both coordinated reception of a paging-related message on a plurality of carriers in a carrier group and reception of a paging-related message on a single carrier; or the first communication apparatus 10 supports switching between coordinated reception of a paging-related message on a plurality of carriers in a carrier group and reception of a paging-related message on a single carrier.

Based on this, for the first communication apparatus, the first communication apparatus may support only the multi-carrier coordinated paging mode, may support only the single-carrier paging mode, or may support the multi-carrier coordinated paging mode and the single-carrier paging mode.

The first communication apparatus 10 considers that different first communication apparatuses may have different device capabilities, and the second communication apparatus 20 may send the paging-related message to the first communication apparatus 10 in the following manner:

In some implementations, the first communication apparatus 10 may synchronize the device capability of the first communication apparatus 10 to the second communication apparatus 20. The second communication apparatus 20 selects a paging mode of the first communication apparatus 10 based on the device capability of the first communication apparatus 10. The second communication apparatus 20 sends the paging-related message to the first communication apparatus 10 based on the selected paging mode of the first communication apparatus 10. Therefore, the first communication apparatus 10 can successfully receive the paging-related message.

In some implementations, the second communication apparatus 20 may notify the first communication apparatus 10 of the paging mode to be used. The second communication apparatus 20 sends the paging-related message to the first communication apparatus 10 based on the notified paging mode. Therefore, the first communication apparatus 10 can successfully receive the paging-related message based on the notified paging mode.

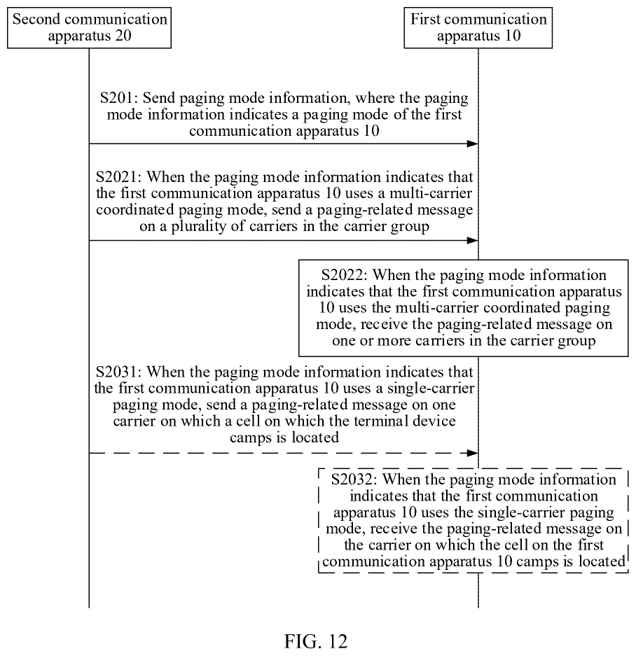

For ease of description, FIG. 12 is used as an example to illustrate the foregoing methods.

In some implementations, the foregoing two methods may be alternatively combined. The first communication apparatus 10 may synchronize the device capability of the first communication apparatus 10 to the second communication apparatus 20. The second communication apparatus 20 notifies, based on the device capability of the first communication apparatus 10, the first communication apparatus 10 of a paging mode to be used. The second communication apparatus 20 sends a paging-related message to the first communication apparatus 10 based on the notified paging mode. Therefore, the first communication apparatus 10 can successfully receive the paging-related message based on the notified paging mode.

For the foregoing method in which the second communication apparatus 20 notifies the first communication apparatus 10 of the paging mode, in some implementations, after the first communication apparatus 10 receives the notified paging mode, the first communication apparatus 10 may determine, based on the device capability of the first communication apparatus 10, whether the notified paging mode is supported.

If the first communication apparatus 10 does not support the notified paging mode, the first communication apparatus 10 may feed back, to the second communication apparatus 20, that the first communication apparatus 10 does not support the notified paging mode. In this way, the second communication apparatus 20 may change the notified paging mode, and send the paging-related message to the first communication apparatus 10 based on a changed paging mode.

If the first communication apparatus 10 supports the notified paging mode, the first communication apparatus 10 may also feed back, to the second communication apparatus 20, that the first communication apparatus 10 supports the notified paging mode. In this way, the second communication apparatus 20 may send the paging-related message to the first communication apparatus 10 based on the notified paging mode.

The following describes the foregoing implementation in detail with reference to FIG. 12.

FIG. 12 is an interaction flowchart of a communication method according to an embodiment of this application. As shown in FIG. 12, the communication method provided in this application may include the following steps.

S201: A second communication apparatus sends paging mode information to a first communication apparatus, where the paging mode information indicates a paging mode of the first communication apparatus.

The paging mode of the first communication apparatus 10 may be a multi-carrier coordinated paging mode or a single-carrier paging mode.

Before the second communication apparatus 20 sends a paging-related message to the first communication apparatus 10, the second communication apparatus 20 may send the paging mode information to the first communication apparatus 10, so that the first communication apparatus 10 can successfully receive the paging-related message based on the corresponding paging mode.

A manner in which the second communication apparatus 20 transmits the paging mode information is not limited in this application.

In some implementations, the second communication apparatus 20 may broadcast a system information to the first communication apparatus 10, where the system information may indicate the paging mode information. It should be understood that the system information herein and a system information carrying a paging-related configuration may be a same system information or different system informations.

In an implementation, the system information may carry a paging-related configuration of the multi-carrier coordinated paging mode or a paging-related configuration of the single-carrier paging mode. Therefore, the first communication apparatus 10 learns of a corresponding paging mode based on a specific configuration.

When the system information carries the paging-related configuration of the carrier group mentioned above, the first communication apparatus 10 may learn that the paging mode is the multi-carrier coordinated paging mode.

When the system information carries a paging-related configuration of a carrier, for example, a single-carrier PCCH-config for paging reception or a PEI, or a single-carrier PDCCH search space config for paging reception or a PEI, the first communication apparatus 10 may learn that the paging mode is the single-carrier paging mode. For the foregoing paging-related configuration of the carrier, refer to a configuration of receiving a paging-related message on a single carrier in the related technology. Details are not described herein again.

In an implementation, the system information may carry a newly added identification, and the identification indicates the paging mode of the first communication apparatus 10. Therefore, the first communication apparatus 10 learns of the corresponding paging mode based on the identification.

In conclusion, the second communication apparatus 20 may notify the first communication apparatus 10 of the paging mode in an implicit indication manner or an identification indication manner.

It should be understood that S201 is an optional step. In other words, the second communication apparatus 20 may not perform S201. Before the second communication apparatus 20 performs S2021 or S2031, the first communication apparatus 10 may send a device capability of the first communication apparatus 10 to the second communication apparatus 20. The second communication apparatus 20 performs S2021 or S2031 based on the device capability of the first communication apparatus 10.

After S201 is performed, the second communication apparatus 20 may implement S2021 or S2031 in a plurality of ways.

In some implementations, the second communication apparatus 20 may perform S2021 or S2031 based on the paging mode indicated by the paging mode information in S201. For ease of description, the foregoing manner is used as an example in FIG. 12.

In some implementations, after the first communication apparatus 10 receives the paging mode information in S201, the first communication apparatus 10 may determine, based on the device capability of the first communication apparatus 10, whether the paging mode indicated by the paging mode information is supported.

If the first communication apparatus 10 supports the paging mode indicated by the paging mode information, the first communication apparatus 10 may send a feedback message 1 to the second communication apparatus 20. The feedback message 1 indicates that the first communication apparatus 10 supports the paging mode indicated by the paging mode information. After receiving the feedback message 1, the second communication apparatus 20 performs S2021 or S2031 based on the paging mode indicated by the paging mode information. The foregoing content is not shown in FIG. 12.

If the first communication apparatus 10 does not support the paging mode indicated by the paging mode information, the first communication apparatus 10 may send a feedback message 2 to the second communication apparatus 20. The feedback message 2 indicates that the first communication apparatus 10 does not support the paging mode indicated by the paging mode information. After receiving the feedback message 2, the second communication apparatus 20 may change the paging mode indicated by the paging mode information, and send a paging-related message to the first communication apparatus 10 based on a changed paging mode. The foregoing content is not shown in FIG. 12.

S2021: When the paging mode information indicates that the first communication apparatus uses the multi-carrier coordinated paging mode, the second communication apparatus sends a paging-related message to the first communication apparatus on a plurality of carriers in the carrier group.

S2022: When the paging mode information indicates that the first communication apparatus uses the multi-carrier coordinated paging mode, the first communication apparatus receives the paging-related message on one or more carriers in the carrier group.

S2021 and S2022 are respectively similar to the implementations of S102 and S103 in the embodiment in FIG. 4. Details are not described herein again.

S2031: When the paging mode information indicates that the first communication apparatus uses the single-carrier paging mode, the second communication apparatus sends a paging-related message to the first communication apparatus on one carrier on which a cell, on which the first communication apparatus camps, is located.

S2032: When the paging mode information indicates that the first communication apparatus uses the single-carrier paging mode, the first communication apparatus receives the paging-related message on the carrier on which the cell, on which the first communication apparatus camps, is located.

The carrier on which the cell on which the first communication apparatus 10 camps is located may be any carrier, for example, an anchor carrier, in the carrier group.

The second communication apparatus 20 sends a paging-related message on the carrier on which the cell on which the first communication apparatus 10 camps is located. Correspondingly, the first communication apparatus 10 receives the paging-related message on the carrier on which the cell on which the first communication apparatus 10 camps is located.

In conclusion, the second communication apparatus 20 may adjust the paging mode of the first communication apparatus 10, in other words, switch between the multi-carrier coordinated paging mode and the single-carrier paging mode, based on various factors such as a network side status, network side load, a quantity of first communication apparatuses 10, and complexity of a network condition.

For example, when a network side is in a normal sending mode, the second communication apparatus 20 may select the single-carrier paging mode. When the network side is in an energy-saving mode, the second communication apparatus 20 may select the multi-carrier coordinated paging mode.

For another example, when the load of the network side is medium or high, the second communication apparatus 20 may select the single-carrier paging mode. When the load of the network side is low, the second communication apparatus 20 may select the multi-carrier coordinated paging mode.

It should be understood that, in addition to the foregoing manner of indicating the paging mode of the first communication apparatus 10, the second communication apparatus 20 may further add, in the system information, an identification for switching the paging mode of the first communication apparatus 10, so that the first communication apparatus 10 and the second communication apparatus 20 switch corresponding paging modes.

For example, if the first communication apparatus 10 uses the single-carrier paging mode, when the first communication apparatus 10 receives the identification for switching the paging mode of the first communication apparatus 10, both the first communication apparatus 10 and the second communication apparatus 20 use the multi-carrier coordinated paging mode.

Alternatively, if the first communication apparatus 10 uses the multi-carrier coordinated paging mode, when the first communication apparatus 10 receives the identification for switching the paging mode of the first communication apparatus 10, both the first communication apparatus 10 and the second communication apparatus 20 use the single-carrier paging mode.

In conclusion, the first communication apparatus 10 supports the two different paging modes, and supports switching between the paging modes. Correspondingly, the second communication apparatus 20 may dynamically adjust, based on various factors, the paging mode for sending the paging-related message. Based on the foregoing descriptions, to reduce energy consumption of the second communication apparatus 20, the second communication apparatus 20 may send the paging-related message on the plurality of carriers in the carrier group in a coordinated manner, to reduce a sending duration of the second communication apparatus 20 in the time domain, so that the second communication apparatus 20 can be in a sleep mode for a longer duration, so as to reduce the energy consumption of the second communication apparatus 20. In addition, the second communication apparatus 20 may further set muting mechanisms in different dimensions, and simultaneously mute the plurality of carriers in the carrier group, to reduce signaling overheads and reduce the energy consumption of the second communication apparatus 20.

In the following embodiments of this application, the network device 310 and the terminal device 320 that have the structures shown in FIG. 3 are used as an example to describe in detail, with reference to the accompanying drawings and an application scenario, the communication method provided in this application for a solution in which muting mechanisms in different dimensions are used.

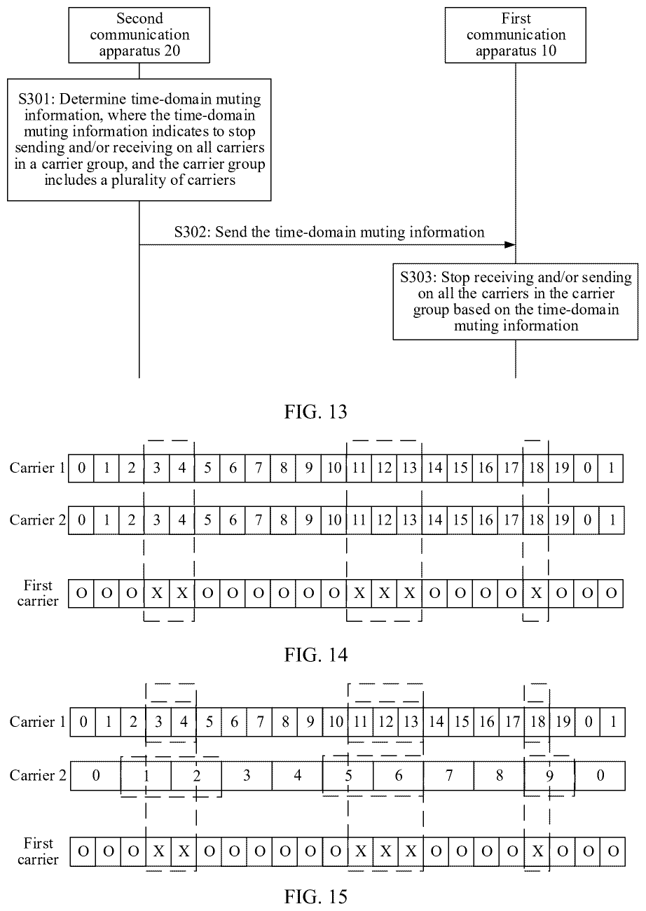

FIG. 13 is an interaction flowchart of a communication method according to an embodiment of this application. The method relates to a first communication apparatus and a second communication apparatus. The first communication apparatus may be a terminal device or an apparatus in the terminal device, and the second communication apparatus may be a network device or an apparatus in the network device. As shown in FIG. 13, the communication method provided in this application may include the following steps.

S301: The second communication apparatus determines time-domain muting information, where the time-domain muting information indicates to stop sending and/or receiving on all carriers in a carrier group, and the carrier group includes a plurality of carriers.

S302: The second communication apparatus sends the time-domain muting information to the first communication apparatus.

S303: The first communication apparatus stops the receiving and/or sending on all the carriers in the carrier group based on the time-domain muting information.

To reduce network side energy consumption, when no data is carried on all the carriers in the carrier group in a specific duration, the second communication apparatus 20 may turn off some components, such as a PA, a radio frequency component, and an intermediate frequency component. Based on this, the second communication apparatus 20 may determine the time-domain muting information. The specific duration may be set based on various factors such as a network side status, network side load, a quantity of first communication apparatuses 10, and complexity of a network condition. The time-domain muting information may indicate that sending and/or receiving are/is to be stopped on all the carriers in the carrier group. Correspondingly, if the second communication apparatus 20 stops sending, the first communication apparatus 10 stops receiving. If the second communication apparatus 20 stops receiving, the first communication apparatus 10 stops sending.

Therefore, the second communication apparatus 20 can simultaneously indicate, by using the time-domain muting information, to mute all the carriers in the carrier group, without separately indicating to mute each carrier in the carrier group.

The time-domain muting information may be indicated by using one piece of signaling, and all the carriers in the carrier group are muted in the time domain. In this way, indication signaling overheads are reduced.

In the time domain, a time-domain unit in communication may be a radio frame, a subframe, a slot, a symbol, or the like.

One radio frame includes a plurality of subframes.

One subframe includes one or more slots. For example, one subframe is 1 millisecond, and a time length of the slot varies with a subcarrier spacing. If the subcarrier spacing is 15 kHz, one subframe is one slot. If the subcarrier spacing is 30 kHz, one subframe is two slots.

One slot includes a plurality of symbols. For example, in NR, one slot may include 14 symbols (with normal cyclic prefixes (CPs)) or 12 symbols (with extended cyclic prefixes).

There may be three types of slots: a downlink slot (D), an uplink slot (U), and a hybrid slot (S).

One slot may include three types of symbols: a downlink symbol (D), an uplink symbol (U), and a flexible symbol (F). The flexible symbol may be used as an uplink symbol, or may be used as a downlink symbol.

Based on this, an indication level of the time-domain muting information may be any one of the following: a symbol level, a slot level, a subframe level, or a level of a plurality of consecutive slots.

Correspondingly, content of the time-domain muting information may vary when indication levels of the time-domain muting information are different.

Therefore, the second communication apparatus 20 supports time-domain muting at different granularities, to flexibly implement energy saving of the second communication apparatus 20. Certainly, time-domain muting at another granularity is not limited in this application.

In addition, parameters such as a quantity of the plurality of carriers and a type of the carrier in the carrier group are not limited in this application.

In some implementations, at least one of the following methods may be used for a plurality of carriers in one carrier group: a same RAT, different RATs, a same duplex mode, different duplex modes, a same TDD configuration, different TDD configurations, a same subcarrier spacing, or different subcarrier spacings.

In some implementations, a same hardware apparatus is used for all of the carriers in the carrier group. For a specific implementation, refer to the foregoing descriptions. Details are not described herein again.

When learning that the first communication apparatus 10 has the foregoing device capability, the second communication apparatus 20 may send the time-domain muting information to the first communication apparatus 10. Correspondingly, the first communication apparatus 10 may stop the receiving and/or sending on all the carriers in the carrier group based on the time-domain muting information.

The device capability may indicate that the first communication apparatus 10 supports simultaneous muting of a plurality of carriers in the carrier group, in other words, the first communication apparatus 10 can simultaneously stop receiving and/or sending on the plurality of carriers in the carrier group.

In addition to the foregoing indicated information, the device capability may further indicate indication levels of the plurality of carriers in the carrier group. Therefore, the device capability is refined, to be specific, the first communication apparatus 10 supports muting of the plurality of carriers in the carrier group at various indication levels.

In addition to the foregoing indicated information, the device capability may further indicate information such as whether the plurality of carriers in the carrier group have a same RAT, a same duplex mode, a same TDD configuration, or a same subcarrier spacing. It should be noted that when RATs of the plurality of carriers in the carrier group are different, the carriers in the carrier group may be grouped based on a same RAT. In this way, the solution of this application is applicable to a plurality of carriers of a same RAT in the carrier group.

Therefore, the device capability is refined, to be specific, such that the first communication apparatus 10 supports muting of a plurality of carriers of various types in the carrier group.

In addition, the first communication apparatus 10 may notify the second communication apparatus 20 in advance whether the first communication apparatus 10 has a corresponding device capability, so that the second communication apparatus 20 determines to use the time-domain muting information to indicate to mute the plurality of carriers in the carrier group. Alternatively, it is predefined in a protocol that the first communication apparatus 10 needs to support a corresponding device capability. Therefore, signaling overheads of the second communication apparatus 20 are reduced.

According to the communication method provided in this application, the second communication apparatus determines the time-domain muting information, where the time-domain muting information indicates to stop sending and/or receiving on all the carriers in the carrier group, and the carrier group includes the plurality of carriers. The second communication apparatus sends the time-domain muting information to the first communication apparatus. Correspondingly, the first communication apparatus stops the receiving and/or sending on all the carriers in the carrier group based on the time-domain muting information. In this application, when no data is carried on all the carriers in the carrier group in a specific duration, all the carriers in the carrier group are simultaneously muted in the time domain. From a perspective of the second communication apparatus, the indication signaling overheads are reduced, so that the second communication apparatus can be in a sleep mode for a longer duration. This helps reduce energy consumption of the second communication apparatus.

For example, when one ultra-wideband hardware apparatus is shared for the plurality of carriers in the carrier group, the second communication apparatus may support time-domain muting of all the carriers in the carrier group, and the first communication apparatus may support time-domain muting of all the carriers in the carrier group. Therefore, the time-domain muting indication of the carrier group helps implement time-domain energy saving of the second communication apparatus, and effectively reduces the signaling overheads.

In addition, time-domain muting of all the carriers in the carrier group is usually applicable to the first communication apparatus 10 that receives a paging message or an SMS message, namely, the first communication apparatus 10 that performs normal transmission of data, for example, the first communication apparatus 10 in a connected state.

Based on the descriptions of the foregoing embodiment, the time-domain muting information is applicable to all the carriers in the carrier group, and is independent of parameters such as RATs, duplex modes, TDD configurations, or subcarrier spacings of the carriers.

The following describes in detail a specific implementation in which the second communication apparatus 20 sends the time-domain muting information to the first communication apparatus 10 with reference to the parameters such as the RATs, the duplex modes, the TDD configurations, or the subcarrier spacings of the carriers in the carrier group.

Scenario 1: The carriers in the carrier group have a same RAT.

The second communication apparatus 20 may send the time-domain muting information to the first communication apparatus 10 on one carrier in the carrier group. The carrier in the carrier group may be any carrier, for example, an anchor carrier, in the carrier group.

Scenario 2: The carriers in the carrier group have different RATs.

In a feasible implementation, the second communication apparatus 20 may send the time-domain muting information to the first communication apparatus 10 on one carrier in the carrier group. The carrier in the carrier group may be any carrier, for example, an anchor carrier, in the carrier group.

In another feasible implementation, the second communication apparatus 20 may group the carriers in the carrier group based on the different RATs. Therefore, the second communication apparatus 20 may send the time-domain muting information to the first communication apparatus 10 on one of the carriers that are in the carrier group and for which each RAT is used.

Scenario 3: The carriers in the carrier group have a same subcarrier spacing.

The second communication apparatus 20 may send the time-domain muting information to the first communication apparatus 10 on a first carrier, where the time-domain muting information indicates to stop sending and/or receiving in a slot that is of each carrier in the carrier group and that is at a same position as a first time-domain unit of the first carrier. A subcarrier spacing of the first carrier is the same as that of the carrier in the carrier group, and the first time-domain unit is one or more time-domain units on which sending and/or receiving are/is stopped. The time-domain unit of the first time-domain unit may be any one of a subframe, a slot, a symbol, or the like.

As shown in FIG. 14, on the first carrier, O represents normal transmission, and X represents time-domain muting. The subcarrier spacing of the first carrier, a subcarrier spacing of a carrier 1, and a subcarrier spacing of a carrier 2 are equal. For the carrier 1 and the carrier 2, slots that are at the same positions as Xs on the first carrier include slots 3, slots 4, slots 11, slots 12, slots 13, and slots 18.

Therefore, the first communication apparatus 10 stops receiving and/or sending in the slots 3, the slots 4, the slots 11, the slots 12, the slots 13, and the slots 18 on the carrier 1 and the carrier 2.

Scenario 4: The carriers in the carrier group have different subcarrier spacings.

The second communication apparatus 20 may send the time-domain muting information to the first communication apparatus 10 on a first carrier, where the time-domain muting information indicates to stop sending and/or receiving in a slot that is of each carrier in the carrier group and that overlaps a position of a first time-domain unit on the first carrier.

A subcarrier spacing of the first carrier is the same as that of the carrier in the carrier group, and the first time-domain unit is one or more time-domain units on which sending and/or receiving are/is stopped. The time-domain unit of the first time-domain unit may be any one of a subframe, a slot, a symbol, or the like.

In a possible implementation, a slot that is of any carrier in the carrier group and that overlaps the position of the first time-domain unit on the first carrier may include a slot that is at the same position as the first time-domain unit, or a slot that overlaps the position of the first time-domain unit.

In a feasible implementation, a subcarrier spacing of the first carrier may be the same as a smallest value of the subcarrier spacings of the carriers in the carrier group.

As shown in FIG. 15, on the first carrier, O represents normal transmission, and X represents time-domain muting. A subcarrier spacing of a carrier 1 is less than a subcarrier spacing of a carrier 2. The subcarrier spacing of the first carrier is equal to the subcarrier spacing of the carrier 1.

For the carrier 1, slots that are at the same positions as Xs on the first carrier include a slot 3, a slot 4, a slot 11, a slot 12, a slot 13, and a slot 18. For the carrier 2, slots that overlap the positions of the Xs on the first carrier include a slot 1, a slot 2, a slot 5, a slot 6, and a slot 9. Therefore, the first communication apparatus 10 stops receiving and/or sending in the slot 3, the slot 4, the slot 11, the slot 12, the slot 13, and the slot 18 on the carrier 1, and stops receiving and/or sending in the slot 1, the slot 2, the slot 5, the slot 6, and the slot 9 on the carrier 2.

In another feasible implementation, a subcarrier spacing of the first carrier may be the same as a largest value of the subcarrier spacings of the carriers in the carrier group.

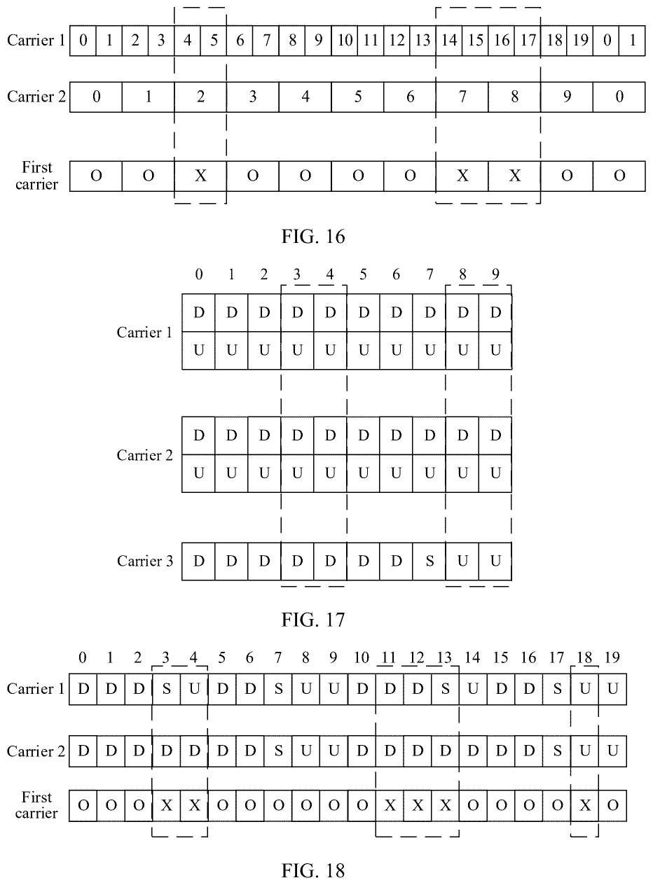

As shown in FIG. 16, on the first carrier, O represents normal transmission, and X represents time-domain muting.

A subcarrier spacing of a carrier 1 is less than a subcarrier spacing of a carrier 2. The subcarrier spacing of the first carrier is equal to the subcarrier spacing of the carrier 2.

For the carrier 1, slots that overlap positions of Xs on the first carrier include a slot 4, a slot 5, a slot 14, a slot 15, a slot 16, and a slot 17. For the carrier 2, slots that are at the same positions as the Xs on the first carrier include a slot 2, a slot 7, and a slot 8. Therefore, the first communication apparatus 10 stops receiving and/or sending in the slot 4, the slot 5, the slot 14, the slot 15, the slot 16, and the slot 17 on the carrier 1, and stops receiving and/or sending in the slot 2, the slot 7, and the slot 8 on the carrier 2.

It should be understood that, in addition to the largest value or the smallest value of the subcarrier spacings of the carriers in the carrier group, the subcarrier spacing of the first carrier may be alternatively implemented in another manner. This is not limited in this application.

Scenario 5: The carriers in the carrier group have a same duplex mode.

When a same TDD mode is used for the plurality of carriers in the carrier group, each carrier in the carrier group is a TDD carrier. Correspondingly, the time-domain muting information indicates that on each carrier in the carrier group, a downlink slot D may indicate that the second communication apparatus 20 stops sending, and the first communication apparatus 10 stops receiving. An uplink slot U may indicate that the second communication apparatus 20 stops receiving, and the first communication apparatus 10 stops sending. A downlink symbol in a hybrid slot S may indicate that the second communication apparatus 20 stops sending, and the first communication apparatus 10 stops receiving. An uplink symbol in the hybrid slot S may indicate that the second communication apparatus 20 stops receiving, and the first communication apparatus 10 stops sending.

When a same FDD mode is used for the plurality of carriers in the carrier group, each carrier in the carrier group is an FDD carrier. Correspondingly, the time-domain muting information indicates that a second time-domain unit of a downlink carrier in the carrier group may indicate that the second communication apparatus 20 stops sending, and the first communication apparatus 10 stops receiving, and/or a third time-domain unit of an uplink carrier may indicate that the second communication apparatus 20 stops receiving, and the first communication apparatus 10 stops sending.

The second time-domain unit or the third time-domain unit is one or more time-domain units on which sending and/or receiving are/is stopped. For a specific implementation of the second time-domain unit or the third time-domain unit, refer to the descriptions of the first time-domain unit. Details are not described herein again.

Scenario 6: The carriers in the carrier group have different duplex modes.

When different duplex modes, namely, a TDD mode and an FDD mode, are used for the plurality of carriers in the carrier group, the plurality of carriers in the carrier group include a TDD carrier and an FDD carrier. Correspondingly, the time-domain muting information indicates that a downlink slot D of the TDD carrier in the carrier group may indicate that the second communication apparatus 20 stops sending, and the first communication apparatus 10 stops receiving. An uplink slot U may indicate that the second communication apparatus 20 stops receiving, and the first communication apparatus 10 stops sending. A downlink symbol in a hybrid slot S may indicate that the second communication apparatus 20 stops sending, and the first communication apparatus 10 stops receiving. An uplink symbol in the hybrid slot S may indicate that the second communication apparatus 20 stops receiving, and the first communication apparatus 10 stops sending. Sending and/or receiving are/is stopped in a fourth time-domain unit of the FDD carrier in the carrier group.

The fourth time-domain unit is one or more time-domain units on which sending and receiving are/is stopped. For a specific implementation of the fourth time-domain unit, refer to the descriptions of the first time-domain unit. Details are not described herein again.

Therefore, the second communication apparatus 20 may send the time-domain muting information to the first communication apparatus 10 on a first carrier, where the time-domain muting information indicates to stop sending and/or receiving in a slot that is of each carrier in the carrier group and that overlaps a position of a first time-domain unit on the first carrier. A subcarrier spacing of the first carrier is the same as that of the carrier in the carrier group, and the first time-domain unit is one or more time-domain units on which sending and/or receiving are/is stopped. The time-domain unit of the first time-domain unit may be any one of a subframe, a slot, a symbol, or the like.

In addition, a slot that is of any carrier in the carrier group and that overlaps the position of the first time-domain unit on the first carrier may include a slot that is at the same position as the first time-domain unit, or a slot that overlaps the position of the first time-domain unit.

As shown in FIG. 17, on the first carrier, O represents normal transmission, and X represents time-domain muting.

When different duplex modes are used for the carriers in the carrier group, a carrier 1 and a carrier 2 are both DDDDDDDDDD and UUUUUUUUUU, and a carrier 3 is DDDDDDDSUU.

For the carrier 1 and the carrier 2, slots that are at the same positions as Xs on the first carrier include 3^{rd}, 4^{th}, 8^{th}, and 9^{th} downlink slots Ds in “DDDDDDDDD” and uplink slots Us.

For the carrier 3, slots that are at the same positions as the Xs on the first carrier include a 4^{th} downlink slot D, a 5^{th} downlink slot D, a 9^{th} uplink slot U, and a 10^{th} uplink slot U in “DDDDDDDSUU”.

Therefore, the first communication apparatus 10 stops receiving in the 3^{rd}, 4^{th}, 8^{th}, and 9^{th} downlink slots Ds and stops sending in the 3^{rd}, 4^{th}, 8^{th} and 9^{th} uplink slots Us on the carrier 1 and the carrier 2, and stops receiving in the 3^{rd} and 4^{th} downlink slots Ds and stops sending in the 8^{th} and 9^{th} uplink slots Us on the carrier 3.

In addition to the foregoing scenarios, different TDD configurations may alternatively be used for the plurality of the carriers in the carrier group.

As shown in FIG. 18, on the first carrier, O represents normal transmission, and X represents time-domain muting.

When different TDD configurations are used for a carrier 1 and a carrier 2 in the carrier group, the TDD configuration of the carrier 1 is 7:3, namely, DDDSUDDSUU, and the TDD configuration of the carrier 2 is 8:2, namely, DDDDDDDSUU.

For the carrier 1, slots that are at the same positions as Xs on the first carrier include uplink symbols and downlink symbols in a 3^{rd} hybrid slot S and a 13^{th} hybrid slot S, a 4^{th} uplink slot U and an 18^{th} uplink slot U, and an 11^{th} downlink slot D and a 12^{th} downlink slot D in “DDDSUDDSUU”.

For the carrier 2, slots that are at the same positions as Xs on the first carrier include 3^{rd}, 4^{th}, 11^{th}, 12^{th}, and 13^{th} downlink slots Ds, and an 18^{th} uplink slot U in “DDDDDDDSUU”.

Therefore, the first communication apparatus 10 stops receiving in the 11^{th} and 12^{th} downlink slots Ds and on downlink symbols in the 3^{rd} and 13^{th} hybrid slots Ss, and stops sending in the 4^{th} and 18^{th} uplink slots Us and on uplink symbols in the 3^{rd} and 13^{th} hybrid slots Ss on the carrier 1. The first communication apparatus 10 stops sending in the 3^{rd}, 4^{th}, 11^{th}, 12^{th}, and 13^{th} downlink slots D, and stops sending in the 18^{th} uplink slot U on the carrier 2.

It should be understood that the scenario in which all of the carriers in the carrier group are muted in the time domain is applicable to any one or any combination of the following scenarios for the plurality of carriers: duplex modes are different, TDD configurations are different and a frequency-domain-first manner is used, subcarrier spacings of carriers having different TDD configurations are different, and subcarrier spacings of a TDD carrier and an FDD carrier are different.

For example, this application further provides a communication apparatus.

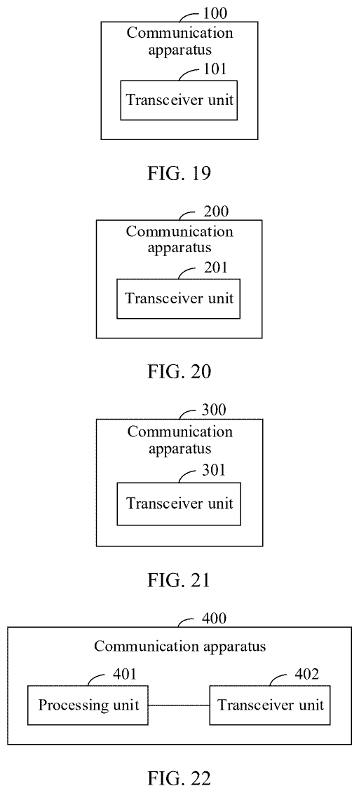

FIG. 19 is a diagram of a structure of a communication apparatus according to an embodiment of this application.

As shown in FIG. 19, a communication apparatus 100 may exist independently, or may be integrated into another device, and may communicate with the second communication apparatus mentioned above, to implement an operation corresponding to the first communication apparatus in any one of the foregoing method embodiments.

The communication apparatus 100 may include a transceiver unit 101. The transceiver unit 101 may implement a corresponding communication function. The transceiver unit 101 may also be referred to as a communication interface or a communication unit.

Optionally, the communication apparatus 100 may further include a processing unit and/or a storage unit. The processing unit is configured to process data. The storage unit may be configured to store instructions and/or data. The processing unit may read the instructions and/or the data in the storage unit, to enable the communication apparatus 100 to implement the foregoing method embodiments.

The communication apparatus 100 may be configured to perform the action performed by the first communication apparatus in the foregoing method embodiments. The communication apparatus 100 may be the first communication apparatus or a component that may be disposed in the first communication apparatus. The transceiver unit 101 is configured to perform the receiving-related operation of the first communication apparatus in the foregoing method embodiments.

Optionally, the transceiver unit 101 may include a sending unit and a receiving unit. The sending unit is configured to perform the sending operation in the foregoing method embodiments. The receiving unit is configured to perform the receiving operation in the foregoing method embodiments.

It should be noted that the communication apparatus 100 may include the sending unit, but does not include the receiving unit, or the communication apparatus 100 may include the receiving unit, but does not include the sending unit. Specifically, this may depend on whether the foregoing solution performed by the communication apparatus 100 includes a sending action and a receiving action.

In an example, the communication apparatus 100 is configured to perform the action performed by the first communication apparatus in the foregoing embodiment shown in FIG. 4.

The communication apparatus 100 may include a transceiver unit 101.

The transceiver unit 101 is configured to receive a paging-related configuration sent by the second communication apparatus, where the paging-related configuration indicates paging-related configuration information of a carrier group, and the carrier group includes a plurality of carriers; and is further configured to receive, on one or more carriers in the carrier group based on the paging-related configuration, a paging-related message sent by the second communication apparatus.

It should be understood that the foregoing corresponding processes performed by the units are described in detail in the foregoing method embodiments. For brevity, details are not described herein again.

The processing unit in the foregoing embodiments may be implemented by at least one processor or a processor-related circuit. The transceiver unit 101 may be implemented by a transceiver or a transceiver-related circuit. The transceiver unit 101 may also be referred to as a communication unit or a communication interface. The storage unit may be implemented by at least one memory.

For example, this application further provides a communication apparatus.

FIG. 20 is a diagram of a structure of a communication apparatus according to an embodiment of this application.

As shown in FIG. 20, the communication apparatus 200 may exist independently, or may be integrated into another device, and may communicate with the first communication apparatus mentioned above, to implement an operation corresponding to the second communication apparatus in any one of the foregoing method embodiments.

The communication apparatus 200 may include a transceiver unit 201. The communication apparatus 200 may further include a processing unit. The transceiver unit 201 may implement a corresponding communication function, and the processing unit is configured to process data. The transceiver unit 201 may also be referred to as a communication interface or a communication unit.

Optionally, the communication apparatus 200 may further include a storage unit. The storage unit may be configured to store instructions and/or data. The processing unit may read the instructions and/or data in the storage unit, to enable the communication apparatus 200 to implement the foregoing method embodiments.

The communication apparatus 200 may be configured to perform the action performed by the second communication apparatus in the foregoing method embodiments. The communication apparatus 200 may be the second communication apparatus or a component that may be disposed in the second communication apparatus. The transceiver unit 201 is configured to perform a receiving-related operation of the second communication apparatus in the foregoing method embodiments, and the processing unit is configured to perform a processing-related operation of the second communication apparatus in the foregoing method embodiments.

Optionally, the transceiver unit 201 may include a sending unit and a receiving unit. The sending unit is configured to perform the sending operation in the foregoing method embodiments. The receiving unit is configured to perform the receiving operation in the foregoing method embodiments.

The communication apparatus 200 may include the sending unit, but does not include the receiving unit, or the communication apparatus 200 may include the receiving unit, but does not include the sending unit. Specifically, this may depend on whether the foregoing solution performed by the communication apparatus 200 includes a sending action and a receiving action.

In an example, the communication apparatus 200 is configured to perform the action performed by the second communication apparatus in the foregoing embodiment shown in FIG. 4.

The communication apparatus 200 may include a transceiver unit 201.

The transceiver unit 201 is configured to send a paging-related configuration to the first communication apparatus, where the paging-related configuration indicates paging-related configuration information of a carrier group, and the carrier group includes a plurality of carriers.

The transceiver unit 201 is further configured to send a paging-related message to the first communication apparatus on the plurality of carriers in the carrier group.

It should be understood that the foregoing corresponding processes performed by the units are described in detail in the foregoing method embodiments. For brevity, details are not described herein again.

The processing unit in the foregoing embodiments may be implemented by at least one processor or a processor-related circuit. The transceiver unit 201 may be implemented by a transceiver or a transceiver-related circuit. The transceiver unit may also be referred to as a communication unit or a communication interface. The storage unit may be implemented by at least one memory.

For example, this application further provides a communication apparatus.

FIG. 21 is a diagram of a structure of a communication apparatus according to an embodiment of this application.

As shown in FIG. 21, the communication apparatus 300 may exist independently, or may be integrated into another device, and may communicate with the second communication apparatus mentioned above, to implement an operation corresponding to the first communication apparatus in any one of the foregoing method embodiments.

The communication apparatus 300 may include a transceiver unit 301. The transceiver unit 301 may implement a corresponding communication function. The transceiver unit 301 may also be referred to as a communication interface or a communication unit.

Optionally, the communication apparatus 300 may further include a processing unit and/or a storage unit. The processing unit is configured to process data. The storage unit may be configured to store instructions and/or data. The processing unit may read the instructions and/or the data in the storage unit, to enable the communication apparatus 300 to implement the foregoing method embodiments.

The communication apparatus 300 may be configured to perform the action performed by the first communication apparatus in the foregoing method embodiments. The communication apparatus 300 may be the first communication apparatus or a component that may be disposed in the first communication apparatus. The transceiver unit 301 is configured to perform the receiving-related operation of the first communication apparatus in the foregoing method embodiments.

Optionally, the transceiver unit 301 may include a sending unit and a receiving unit. The sending unit is configured to perform the sending operation in the foregoing method embodiments. The receiving unit is configured to perform the receiving operation in the foregoing method embodiments.

The communication apparatus 300 may include the sending unit, but does not include the receiving unit, or the communication apparatus 100 may include the receiving unit, but does not include the sending unit. Specifically, this may depend on whether the foregoing solution performed by the communication apparatus 300 includes a sending action and a receiving action.

In an example, the communication apparatus 300 is configured to perform the action performed by the first communication apparatus in the foregoing embodiment shown in FIG. 13.

The communication apparatus 300 may include a transceiver unit 301.

The transceiver unit 301 is configured to receive time-domain muting information sent by the second communication apparatus, where the time-domain muting information indicates to stop sending and/or receiving on all carriers in a carrier group, and the carrier group includes a plurality of carriers.

The transceiver unit 301 is further configured to stop the receiving and/or sending on all the carriers in the carrier group based on the time-domain muting information.

It should be understood that the foregoing corresponding processes performed by the units are described in detail in the foregoing method embodiments. For brevity, details are not described herein again.

The processing unit in the foregoing embodiments may be implemented by at least one processor or a processor-related circuit. The transceiver unit 301 may be implemented by a transceiver or a transceiver-related circuit. The transceiver unit 301 may also be referred to as a communication unit or a communication interface. The storage unit may be implemented by at least one memory.

For example, this application further provides a communication apparatus.

FIG. 22 is a diagram of a structure of a communication apparatus according to an embodiment of this application.

As shown in FIG. 22, the communication apparatus 400 may exist independently, or may be integrated into another device, and may communicate with the first communication apparatus mentioned above, to implement an operation corresponding to the second communication apparatus in any one of the foregoing method embodiments.

The communication apparatus 400 may include a processing unit 401 and a transceiver unit 402. The transceiver unit 402 may implement a corresponding communication function, and the processing unit 401 is configured to process data. The transceiver unit 402 may also be referred to as a communication interface or a communication unit.

Optionally, the communication apparatus 400 may further include a storage unit. The storage unit may be configured to store instructions and/or data. The processing unit may read the instructions and/or data in the storage unit, to enable the communication apparatus 400 to implement the foregoing method embodiments.

The communication apparatus 400 may be configured to perform the action performed by the second communication apparatus in the foregoing method embodiments. The communication apparatus 400 may be the second communication apparatus or a component that may be disposed in the second communication apparatus. The transceiver unit 402 is configured to perform the receiving-related operation of the second communication apparatus in the foregoing method embodiments, and the processing unit 401 is configured to perform the processing-related operation of the second communication apparatus in the foregoing method embodiments.

Optionally, the transceiver unit 402 may include a sending unit and a receiving unit. The sending unit is configured to perform the sending operation in the foregoing method embodiments. The receiving unit is configured to perform the receiving operation in the foregoing method embodiments.

The communication apparatus 400 may include the sending unit, but does not include the receiving unit, or the communication apparatus 400 may include the receiving unit, but does not include the sending unit. Specifically, this may depend on whether the foregoing solution performed by the communication apparatus 400 includes a sending action and a receiving action.

In an example, the communication apparatus 400 is configured to perform the action performed by the second communication apparatus in the foregoing embodiment shown in FIG. 13.

The communication apparatus 400 may include a processing unit 401 and a transceiver unit 402.

The processing unit 401 is configured to determine time-domain muting information, where the time-domain muting information indicates to stop sending and/or receiving on all carriers in a carrier group, and the carrier group includes a plurality of carriers.

The transceiver unit 402 is configured to send the time-domain muting information to the first communication apparatus.

It should be understood that the foregoing corresponding processes performed by the units are described in detail in the foregoing method embodiments. For brevity, details are not described herein again.

The processing unit in the foregoing embodiments may be implemented by at least one processor or a processor-related circuit. The transceiver unit 401 may be implemented by a transceiver or a transceiver-related circuit. The transceiver unit may also be referred to as a communication unit or a communication interface. The storage unit may be implemented by at least one memory.

For example, this application further provides a communication apparatus.

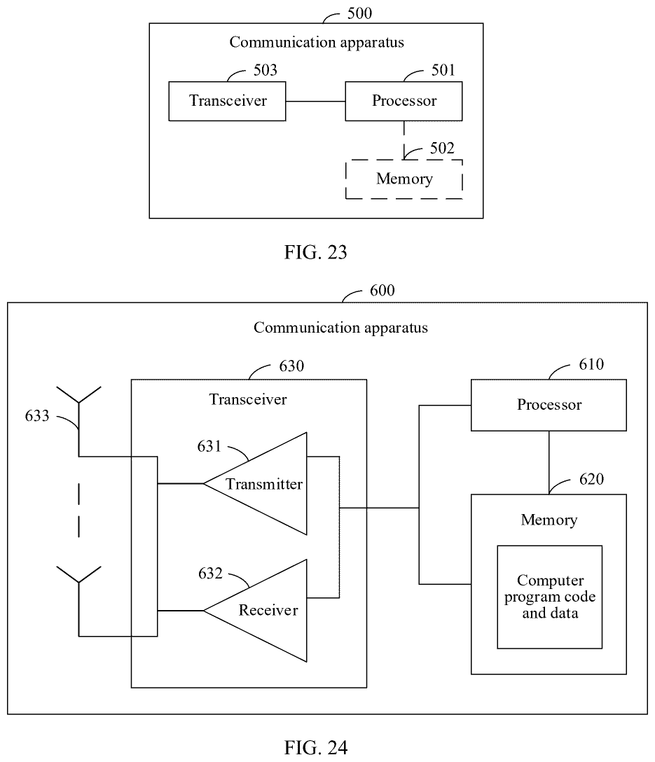

FIG. 23 is a diagram of a hardware structure of a communication apparatus according to an embodiment of this application.

The communication apparatus 500 includes a processor 501. The processor 501 is coupled to a memory 502. The memory 502 is configured to store a computer program or instructions and/or data. The processor 501 is configured to execute the computer program or instructions and/or data stored in the memory 502, to perform the method in the foregoing method embodiments.

Optionally, the communication apparatus 500 includes one or more processors 501.

Optionally, as shown in FIG. 23, the communication apparatus 500 may further include the memory 502.

Optionally, the communication apparatus 500 may include one or more memories 502.

Optionally, the memory 502 and the processor 501 may be integrated together, or separately disposed.

As shown in FIG. 23, the communication apparatus 500 may further include a transceiver 503. The transceiver 503 is configured to receive and/or send a signal. For example, the processor 501 is configured to control the transceiver 503 to receive and/or send the signal.

In a solution, the communication apparatus 500 is configured to implement the operation performed by the first communication apparatus in the foregoing method embodiments.

For example, the processor 501 is configured to implement the processing-related operation performed by the first communication apparatus in the foregoing method embodiments, and the transceiver 503 is configured to implement the receiving/sending-related operation performed by the first communication apparatus in the foregoing method embodiments.

In another solution, the communication apparatus 500 is configured to implement the operation performed by the second communication apparatus in the foregoing method embodiments.

For example, the processor 501 is configured to implement the processing-related operation performed by the second communication apparatus in the foregoing method embodiments, and the transceiver 503 is configured to implement the receiving/sending-related operation performed by the second communication apparatus in the foregoing method embodiments.

In the communication apparatus shown in FIG. 23, a component that is in the transceiver 503 and that is configured to receive power may be considered as a receiving unit, and a component that is in the transceiver 503 and that is configured to implement a sending function may be considered as a sending unit. In other words, the transceiver 503 may include a receiver and a transmitter. The transceiver 503 may also be referred to as a transceiver machine, a transceiver unit, a transceiver circuit, or the like. The receiver may also be referred to as a receiver machine, a receiving unit, a receiver, a receiver circuit, or the like. The transmitter may also be referred to as a transmitter machine, a transmitter, a transmitting unit, a transmitter circuit, or the like. The processor 501 has a processing function, and the processor 501 may be referred to as a processing unit. The memory 502 is configured to store computer program code and data, and the memory 502 may also be referred to as a storage unit.

For example, this application further provides a communication apparatus.

The communication apparatus 600 may be a first communication apparatus or a second communication apparatus, or may be a chip of the first communication apparatus or the second communication apparatus. The communication apparatus 600 may be configured to perform the operation performed by the first communication apparatus or the second communication apparatus in the foregoing method embodiments.

FIG. 24 is a diagram of a hardware structure of a communication apparatus according to an embodiment of this application.

As shown in FIG. 24, the communication apparatus 600 includes a part 610, a part 620, and a part 630. The part 610 is mainly configured to: perform baseband processing, control a base station, and the like. The part 610 is usually a control center of the base station, may be usually referred to as a processor or a processing unit, and is configured to control a first communication apparatus or a second communication apparatus to perform a processing operation on a side of the first communication apparatus or the second communication apparatus in the foregoing method embodiments. The part 620 is mainly configured to store computer program code and data, and may be usually referred to as a memory or a storage unit. The part 630 is mainly configured to receive and send a radio frequency signal, and perform conversion between the radio frequency signal and a baseband signal. The part 630 may be usually referred to as a transceiver unit, a transceiver, a transceiver circuit, a transceiver machine, or the like. The transceiver unit in the part 630 may also be referred to as a transceiver, a transceiver machine, or the like, and includes an antenna 633 and a radio frequency circuit (not shown in the figure). The radio frequency circuit is mainly configured to perform radio frequency processing. Optionally, in the part 630, a component configured to implement a receiving function may be considered as a receiver, and a component configured to implement a sending function may be considered as a transmitter. In other words, the part 630 includes a receiver 632 and a transmitter 631. The receiver may also be referred to as a receiving unit, a receiver machine, a receiver circuit, or the like, and the transmitter may be referred to as a transmitting unit, a sending unit, a transmitter machine, a transmitter circuit, or the like.

The part 610 and the part 620 may include one or more boards, and each board may include one or more processors and one or more memories. The processor is configured to read and execute a program in the memory, to implement a baseband processing function and control the base station. If there are a plurality of boards, the boards may be interconnected with each other to enhance a processing capability. In an optional implementation, a plurality of boards may share one or more processors, a plurality of boards share one or more memories, or a plurality of boards share one or more processors at the same time.

In an implementation, the transceiver unit in the part 630 is configured to perform the receiving/sending-related process performed by the first communication apparatus or the second communication apparatus in the embodiment shown in FIG. 4 or FIG. 13. The processor in the part 610 is configured to perform the processing-related process performed by the first communication apparatus or the second communication apparatus in the embodiment shown in FIG. 4 or FIG. 13.

FIG. 24 is merely an example rather than a limitation. The first communication apparatus or the second communication apparatus that includes the processor, the memory, and the transceiver may not depend on the structure shown in FIG. 24.

When the communication apparatus 600 is a chip, the chip includes a transceiver, a memory, and a processor. The transceiver may be an input/output circuit or a communication interface. The processor is a processor, a microprocessor, or an integrated circuit integrated on the chip. A sending operation of the first communication apparatus or the second communication apparatus in the foregoing method embodiments may be understood as an output of the chip, and a receiving operation of the first communication apparatus or the second communication apparatus in the foregoing method embodiments may be understood as an input of the chip.

For example, this application further provides a non-transitory computer-readable storage medium, and the computer-readable storage medium stores computer instructions for implementing the method performed by the first communication apparatus or the method performed by the second communication apparatus in the foregoing method embodiments.

For example, when a computer program is executed by a computer, the computer is enabled to implement the method performed by the first communication apparatus or the method performed by the second communication apparatus in the foregoing method embodiments.

For example, this application further provides a computer program product including instructions. When the instructions are executed by a computer, the computer is enabled to implement the method performed by the first communication apparatus or the method performed by the second communication apparatus in the foregoing method embodiments.

For example, this application further provides a communication system. The communication system includes a first communication apparatus and a second communication apparatus. The first communication apparatus is configured to perform the process performed by the first communication apparatus in the foregoing embodiments. The second communication apparatus is configured to perform the process performed by the second communication apparatus in the foregoing embodiments.

For example, this application further provides a chip apparatus, including a processor, configured to invoke a computer program or computer instructions stored in a memory, so that the processor performs the reference signal processing method in the foregoing embodiments.

In a possible implementation, an input of the chip apparatus corresponds to the receiving operation in the embodiment shown in FIG. 4 or FIG. 13, and an output of the chip apparatus corresponds to the sending operation in the embodiment shown in FIG. 4 or FIG. 13.

Optionally, the processor is coupled to the memory through an interface.

Optionally, the chip apparatus further includes the memory, and the memory stores the computer program or the computer instructions.

The processor mentioned anywhere above may be a general-purpose central processing unit, a microprocessor, a baseband processor, an application-specific integrated circuit (ASIC), or one or more integrated circuits configured to control program execution of the reference signal processing method in the foregoing embodiments. The memory mentioned anywhere above may be a read-only memory (ROM), another type of static storage device that can store static information and instructions, a random access memory (RAM), or the like.

Persons skilled in the art may clearly understand that, for convenience and brevity of description, for explanations and beneficial effect of related content in any one of the communication apparatuses provided above, refer to the corresponding method embodiments provided above. Details are not described herein again.

In this application, the first communication apparatus or the second communication apparatus may include a hardware layer, an operating system layer running on the hardware layer, and an application layer running on the operating system layer. The hardware layer may include hardware such as a central processing unit (CPU), a memory management unit (MMU), and a memory (also referred to as a main memory). An operating system at the operating system layer may be any one or more computer operating systems that implement service processing by using a process, for example, a Linux operating system, a Unix operating system, an Android operating system, an iOS operating system, or a Windows operating system. The application layer may include applications such as a browser, an address book, word processing software, and instant messaging software.

Persons skilled in the art may clearly understand that, for the purpose of convenient and brief description, for a detailed working process of the foregoing system, apparatus, and unit, refer to a corresponding process in the foregoing method embodiments, and details are not described herein again.

In the several embodiments provided in this application, it should be understood that the disclosed system, apparatus, and method may be implemented in other ways. For example, the described apparatus embodiments are merely examples. For example, division into the units is merely logical function division, and may be divided differently in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, in other words, may be located in one place, or may be distributed on a plurality of network units. Some or all of the units may be selected depending on actual requirements to achieve the objectives of the solutions in embodiments.

In addition, functional units in embodiments of this application may be integrated into one processing unit, each of the units may exist independently physically, or two or more units may be integrated into one unit. The integrated unit may be implemented in a form of hardware, or may be implemented in a form of a software functional unit.

When the integrated unit is implemented in the form of the software functional unit and sold or used as an independent product, the integrated unit may be stored in a computer-readable storage medium. Based on such an understanding, a part that essentially contributes to the technical solutions of this application or all or some of the technical solutions may be implemented in a form of a software product. The computer software product is stored in a storage medium, and includes several instructions for enabling a computer device (which may be a personal computer, a server, a network device, or the like) to perform all or some processes of the methods in embodiments of this application. The foregoing storage medium includes any medium that can store program code, such as a USB flash drive, a removable hard disk, a read-only memory, a random access memory, a magnetic disk, or an optical disc.

In conclusion, the foregoing embodiments are merely intended for describing the technical solutions of this application, but not for limiting this application. Although this application is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of embodiments of this application.

What is claimed is:

1. A communication method, comprising:
receiving, by a first communication apparatus, a paging-related configuration sent by a second communication apparatus, wherein the paging-related configuration indicates paging-related configuration information of a carrier group comprising a plurality of carriers; and
receiving, by the first communication apparatus on one or more carriers in the carrier group based on the paging-related configuration, a paging-related message sent by the second communication apparatus.

2. The method according to claim 1, wherein the paging-related configuration comprises a carrier group paging control channel configuration and a carrier group paging search space configuration, wherein the carrier group paging control channel configuration comprises a configuration of M carriers for paging reception in the carrier group and is used for determining a paging frame and a paging occasion, the carrier group paging search space configuration comprises a search space configuration of a physical downlink control channel, for paging reception, of N carriers for paging reception in the carrier group, where M and N are integers greater than 1 and less than or equal to a total quantity of all carriers for paging reception in the carrier group; and
receiving the paging-related message comprises:
receiving, by the first communication apparatus, an SMS message or a paging message on one or more same carriers in the M carriers and the N carriers based on the carrier group paging control channel configuration and the carrier group paging search space configuration.

3. The method according to claim 1, wherein the receiving of the paging-related message comprises:
determining, by the first communication apparatus based on the paging-related configuration, a quantity of paging slots and beam information of the paging slot that are of each of the one or more carriers in the carrier group on each paging occasion; and
receiving, by the first communication apparatus, the paging-related message on the one or more carriers in the carrier group based on the quantity of paging slots and the beam information of the paging slot that are of each of the one or more carriers.

4. The method according to claim 3, wherein the quantity of paging slots and the beam information of the paging slot that are of each of the one or more carriers are predefined in a protocol; or
the paging-related configuration comprises association indication information, and the quantity of paging slots and the beam information are determined based on the association indication information.

5. The method according to claim 1, wherein the paging-related configuration comprises a carrier group paging early indication configuration and a carrier group paging early indication search space configuration, wherein the carrier group paging early indication configuration comprises a paging early indication-related configuration of P carriers for a paging early indication in the carrier group, and the carrier group paging early indication search space configuration comprises a search space configuration of a physical downlink control channel, for a paging early indication of Q carriers for the paging early indication in the carrier group, and P and Q are integers greater than 1 and less than or equal to a total quantity of all carriers for the paging early indication in the carrier group; and
the receiving, by the first communication apparatus, of the paging-related message comprises:
receiving, by the first communication apparatus based on the carrier group paging early indication configuration and the carrier group paging early indication search space configuration, a paging early indication message on one or more same carriers in the P carriers and the Q carriers.

6. The method according to claim 1, wherein the receiving by the first communication apparatus of the paging-related message comprises:
determining, by the first communication apparatus, based on the paging-related configuration, a quantity of paging early indication monitoring slots and beam information of the paging early indication monitoring slot that are of each of the one or more carriers in the carrier group on each paging early indication occasion; and
receiving, by the first communication apparatus, the paging-related message on the one or more carriers in the carrier group based on the quantity of paging early indication monitoring slots and the beam information of the paging early indication monitoring slot.

7. The method according to claim 6, wherein the quantity of paging early indication monitoring slots and the beam information are predefined in a protocol; or
the paging-related configuration further comprises association indication information, and the quantity of paging early indication monitoring slots and the beam information are determined based on the association indication information.

8. The method according to claim 1, wherein the method further comprises:
receiving, by the first communication apparatus, paging mode information sent by the second communication apparatus, wherein the paging mode information indicates a paging mode of the first communication apparatus; and
when the paging mode information indicates that the first communication apparatus uses a multi-carrier coordinated paging mode, receiving, by the first communication apparatus, the paging-related message on the one or more carriers in the carrier group; or
when the paging mode information indicates that the first communication apparatus uses a single-carrier paging mode, receiving, by the first communication apparatus, the paging-related message on a carrier on which a cell, on which the first communication apparatus camps, is located.

9. The method according to claim 8, wherein the receiving, by the first communication apparatus, of the paging mode information sent by the second communication apparatus comprises:
receiving, by the first communication apparatus, system information sent by the second communication apparatus, wherein the system information comprises the paging mode information.

10. The method according to claim 9, wherein the system information further comprises the paging-related configuration.

11. A communication method, comprising:
sending, by a second communication apparatus, a paging-related configuration to a first communication apparatus, wherein the paging-related configuration indicates paging-related configuration information of a carrier group comprising a plurality of carriers; and
sending, by the second communication apparatus, a paging-related message to the first communication apparatus on the carriers in the carrier group.

12. The method according to claim 11, wherein the paging-related configuration comprises a carrier group paging control channel configuration and a carrier group paging search space configuration, wherein the carrier group paging control channel configuration comprises a configuration of M carriers for paging reception in the carrier group and is used for determining a paging frame and a paging occasion, the carrier group paging search space configuration comprises a search space configuration of a physical downlink control channel, for paging reception, of N carriers for paging reception in the carrier group, where M and N are integers greater than 1 and less than or equal to a total quantity of all carriers for paging reception in the carrier group; and
sending the paging-related message comprises:
sending, by the second communication apparatus, an SMS message or a paging message on a same carrier in the M carriers and the N carriers in the carrier group.

13. The method according to claim 11, wherein the paging-related configuration further comprises association indication information used to determine a quantity of paging slots and beam information of the paging slot that are of each carrier for paging reception in the carrier group on each paging occasion.

14. The method according to claim 11, wherein the paging-related configuration comprises a carrier group paging early indication configuration and a carrier group paging early indication search space configuration, wherein the carrier group paging early indication configuration comprises a paging early indication-related configuration of P carriers for a paging early indication in the carrier group, and the carrier group paging early indication search space configuration comprises a search space configuration of a physical downlink control channel, for a paging early indication of Q carriers for the paging early indication in the carrier group, and P and Q are integers greater than 1 and less than or equal to a total quantity of all carriers for the paging early indication in the carrier group; and
the sending, by the second communication apparatus, of the paging-related message comprises:
sending, by the second communication apparatus, a paging early indication message on a same carrier in the P carriers and the Q carriers in the carrier group.

15. The method according to claim 11, wherein the paging-related configuration further comprises association indication information used to determine a quantity of paging early indication monitoring slots and beam information of the paging early indication monitoring slot that are of each carrier for the paging early indication in the carrier group on each paging early indication occasion.

16. The method according to claim 11, wherein the method further comprises:
sending, by the second communication apparatus, paging mode information to the first communication apparatus, wherein the paging mode information indicates a paging mode of the first communication apparatus; and
when the paging mode information indicates that the first communication apparatus uses a multi-carrier coordinated paging mode, sending, by the second communication apparatus, the paging-related message on the plurality of carriers in the carrier group; or
when the paging mode information indicates that the first communication apparatus uses a single-carrier paging mode, sending, by the second communication apparatus, the paging-related message on one carrier on which a cell, on which the first communication apparatus camps, is located.

17. The method according to claim 16, wherein the sending, by the second communication apparatus, of the paging mode information to the first communication apparatus comprises:
sending, by the second communication apparatus, system information to the first communication apparatus, wherein the system information comprises the paging mode information.

18. The method according to claim 17, wherein the system information further comprises the paging-related configuration.

19. A first communication apparatus, comprising:
a communication unit, configured to receive a paging-related configuration sent by a second communication apparatus, wherein the paging-related configuration indicates paging-related configuration information of a carrier group comprising a plurality of carriers; and
a communication unit, configured to receive a paging-related message sent by the second communication apparatus on one or more carriers in the carrier group based on the paging-related configuration.

20. The first communication apparatus according to claim 1, wherein the paging-related configuration comprises a carrier group paging control channel configuration and a carrier group paging search space configuration, wherein the carrier group paging control channel configuration comprises a configuration of M carriers for paging reception in the carrier group and is used for determining a paging frame and a paging occasion, the carrier group paging search space configuration comprises a search space configuration of a physical downlink control channel, for paging reception, of N carriers for paging reception in the carrier group, where M and N are integers greater than 1 and less than or equal to a total quantity of all carriers for paging reception in the carrier group; and
the receiving of the paging-related message comprises:
receiving, by the first communication apparatus, an SMS message or a paging message on one or more same carriers in the M carriers and the N carriers based on the carrier group paging control channel configuration and the carrier group paging search space configuration.
